SEQUENCE LISTING (1 sequence)

SEQ ID NO: 1 - protein, 7 aa, Artificial Sequence
  Synthetic
YEVDGWK

(19) United States
(12) Patent Application Publication
(10) Pub. No.: US 2012/0232225 A1
(43) Pub. Date: Sep. 13, 2012

(54) SYNTHESIS AND ISOLATION OF DENDRIMER SYSTEMS

(75) Inventors: James R. Baker, JR., Ann Arbor, MI (US); Mark M. Banaszak Holl, Ann Arbor, MI (US); Douglas Gurnett Mullen, Ann Arbor, MI (US); Bradford G. Orr, Ann Arbor, MI (US); Ankur Desai, Ann Arbor, MI (US); Leonard M. Sander, Ann Arbor, MI (US); Jack Neel Waddell, Hot Springs, AR (US)

(73) Assignee: THE REGENTS OF THE UNIVERSITY OF MICHIGAN, Ann Arbor, MI (US)

(21) Appl. No.: 13/392,421

(22) PCT Filed: Jul. 23, 2010
(86) PCT No.: PCT/US10/43109

§ 371 Date: May 8, 2012

Related U.S. Application Data
(60) Provisional application No. 61/237,172, filed on Aug. 26, 2009.

(51) Int. Cl. C08G 63/91

(52) U.S. Cl. 525/418

(57) ABSTRACT

The present invention relates to novel methods of synthesis and isolation of dendrimer systems. In particular, the present invention is directed to novel dendrimer conjugates with defined and limited numbers of ligand conjugates and high levels of structural uniformity, methods of synthesizing the same, compositions comprising the conjugates, as well systems and methods utilizing the conjugates (e.g., in diagnostic and/or therapeutic settings (e.g., for the delivery of therapeutics, imaging, and/or targeting agents (e.g., in disease (e.g., cancer) diagnosis and/or therapy, pain therapy, etc.)).

### CROSS REFERENCE TO RELATED APPLICATION

This Application claims priority to U.S. Provisional Patent Application Ser. No. 61/237,172, filed Aug. 26, 2009, hereby incorporated by reference in its entirety.

### STATEMENT REGARDING FEDERALLY SPONSORED RESEARCH OR DEVELOPMENT

This invention was made with government support under Grant No. R01 CA119409 awarded by the National Institutes of Health. The government has certain rights in the invention.

### FIELD OF THE INVENTION

The present invention relates to novel methods of synthesis and isolation of dendrimer systems. In particular, the present invention is directed to novel dendrimer conjugates of defined numbers of ligand conjugates, methods of synthesizing the same, compositions comprising the conjugates, as well as systems and methods utilizing the conjugates (e.g., in diagnostic and/or therapeutic settings (e.g., for the delivery of therapeutics, imaging, and/or targeting agents (e.g., in disease (e.g., cancer) diagnosis and/or therapy, pain therapy, etc.)).

### BACKGROUND OF THE INVENTION

Cancer remains the number two cause of mortality in the United States, resulting in over 500,000 deaths per year. Despite advances in detection and treatment, cancer mortality remains high. New compositions and methods for the imaging and treatment (e.g., therapeutic) of cancer may help to reduce the rate of mortality associated with cancer.

Severe, chronic pain is observed a variety of subjects. For example, there exist large numbers of individuals with severe pain associated with arthritis, autoimmune disease, injury, cancer, and a host of other conditions.

There exists a need for compositions, methods and systems for delivering agents (e.g., diagnostic and/or therapeutic (e.g., cancer therapeutics, pain relief agents) to subjects that provide effective therapy (e.g., disease treatment, symptom relief, etc.) with reduced or eliminated side effects, even when administered in high doses. Functionalized dendrimers, such as PAMAM dendrimers conjugated to functional ligands relevant to cancer therapy and/or pain alleviation, have been developed for such purposes. However, current conjugation strategies used to attach ligands to the surfaces of nanoparticles (e.g., dendrimers, PAMAM dendrimer branches) generate a stochastic distribution of products, including products with suboptimal numbers of ligands and/or suboptimal ratios of ligands when more than one ligand type is utilized. This stochastic distribution results in low structural uniformity of the dendrimer system, thereby negatively affecting properties such as therapeutic potency, pharmacokinetics, or effectiveness for multivalent targeting.

Improved methods of synthesis and isolation of dendrimers resulting in increased structural uniformity are needed.

### SUMMARY

Functionalized nanoparticles (e.g., dendrimers) often contain moieties (including but not limited to ligands, functional ligands, conjugates, therapeutic agents, targeting agents, imaging agents, fluorophores) that are conjugated to the periphery. Such moieties may for example be conjugated to one or more dendrimer branch termini. Conjugation strategies used during the synthesis of functionalized dendrimers generate a stochastic distribution of products with differing numbers of ligands attached per dendrimer molecule, thereby creating a population of dendrimers with a wide distribution in the numbers of ligands attached. The low structural uniformity of such dendrimer populations negatively affects properties such as therapeutic potency, pharmacokinetics, or effectiveness for multivalent targeting. Difficulties in quantifying and resolving such populations to yield samples with sufficient structural uniformity have been, prior to the present invention, impossible to overcome. Methods, systems, and compositions of the present invention allow precise quantification and resolution of the numbers of attached ligands per dendrimer to yield dendrimer subpopulations of high structural uniformity.

In particular, experiments conducted during the course of developing embodiments for the present invention successfully employed a semi-preparative HPLC to isolate dendrimer with 0-8 Azide Ligands. Peak fitting analysis on analytical HPLC traces determined the sample purity to be 80% or higher. The number of ligands per dendrimer, quantified by ¹H NMR, were in good agreement with the number quantified by HPLC and peak fitting. Significantly, for dendrimer compounds with 0-4 Ligands, over 8 mg of material was produced. This approach overcomes batch reproducibility challenges in dendrimer-based systems.

Accordingly, the present invention relates to novel methods of synthesis of dendrimer systems with high structural uniformity. In particular, certain embodiments of the present invention encompass novel dendrimer compositions, methods of synthesizing and/or isolating the same, as well as systems and methods utilizing the compositions (e.g., in diagnostic and/or therapeutic settings (e.g., for the delivery of therapeutics, imaging, and/or targeting agents (e.g., in disease (e.g., cancer) diagnosis and/or therapy, pain therapy, etc.)). Accordingly, in some embodiments, dendrimer conjugates of the present invention may further comprise one or more components for targeting, imaging, sensing, and/or providing a therapeutic or diagnostic material (e.g., for monitoring response to therapy. Furthermore, the novel synthesis methods of certain embodiments of the present invention provide significant advantages with regard to yielding samples or subpopulations of dendrimer compositions with high structural uniformity.

In some embodiments, methods and systems of the present invention involve use of high performance liquid chromatography (high pressure liquid chromatography, HPLC). In some embodiments, methods and systems of the present invention involve use of reverse phase (reversed phase, reverse-phase, reversed-phase, RP) HPLC. One of ordinary skill in the art is familiar with a range of media, solvents, buffers, and conditions compatible with HPLC and RP-HPLC. In some embodiments, HPLC media comprise silica which has been treated with RMe₂SiCl, where R is a straight chain alkyl group. The number of carbons in the straight chain alkyl group can vary (e.g., 2, 3, 4, 5, 6, 7, 8, greater than 8). In some embodiments, silica C5 media is used. A variety of solvent systems are compatible with the methods of the present invention. In some embodiments, a gradient of water:acetonitrile is used for elution. In some embodiments, a gradient of water:isopropanol is used for elution. One of ordinary skill in the art is well aware that alteration of gradient proportions may affect elution conditions and/or resolution. In some embodiments, a gradient beginning with 100:0 (v/v) water:acetonitrile and ending with 20:80 (v/v) water:acetonitrile is used for elution. In some embodiments, a gradient beginning with 100:0 (v/v) water:isopropanol and ending with 60:40 (v/v) water:isopropanol is used for elution. In some embodiments, additional agents are added to the solvent system. In some embodiments, trifluoroacetic acid (TFA) is added to the solvent system.

In some embodiments, chromatographic traces are analyzed and/or quantified using peak fitting analysis. In some embodiments, software is used for peak fitting analysis (e.g., graphing software, image analysis software, data analysis software). In some embodiments, the Igor Pro software package is used. Functional forms applied to peaks may include but are not limited to Gaussian, double exponential, polynomial, Lorentzian, linear, exponential, power law, sine, lognormal, Hill equation, sigmoid, or a combination thereof. In some embodiments, a Gaussian curve with an exponential decay tail is applied. Fitting peaks may be constrained or not constrained. In some embodiments, peak analysis further comprises mathematical modeling.

Methods and systems of the present invention provide a plurality (a sample, a population, a subpopulation) of dendrimer compositions with high structural uniformity. The level of structural uniformity may be 80% or higher within the dendrimer composition population (e.g., sample, subpopulation), where “structural uniformity” as used herein refers to the number of ligand conjugations within a dendrimer device (e.g., dendrimer system, ligand-conjugated dendrimer). In some embodiments, the level of structural uniformity may be 80-90%, 90-95%, 95-99%, 99% or higher.

In certain embodiments, the present invention provides a composition comprising a plurality of dendrimer molecules, wherein each dendrimer molecule is conjugated to at least one type of ligand, and wherein the structural uniformity of the number of ligand conjugates within the plurality of dendrimer molecules is 80% or higher. In some embodiments, the dendrimer molecules are PAMAM dendrimers. In some embodiments, at least one ligand type comprises an aromatic group. In some embodiments, at least one ligand type is capable of click chemistry. In some embodiments, at least one ligand type is selected from the group consisting of (3-(4-)2-azidoethoxy)phenyl)propanoic acid) and (3-(4-(prop-2-ynyloxy)phenyl)propanoic acid.

Examples of dendrimers include, but are not limited to, a polyamideamine (PAMAM) dendrimer, a polypropylamine (POPAM) dendrimer, and a PAMAM-POPAM dendrimer. In some embodiments, the dendrimer is a Baker-Huang PAMAM dendrimer (see, e.g., U.S. Provisional Patent Application Ser. No. 61/251,244; herein incorporated by reference in its entirety). The type of dendrimer used is not limited by the generation number of the dendrimer. Dendrimer molecules may be generation 0, generation 1, generation 2, generation 3, generation 4, generation 5, generation 6, generation 7, or higher than generation 7. In some embodiments, half-generation dendrimers may be used. In certain embodiments, a generation 5 amine-terminated PAMAM dendrimer is used as starting material. In some embodiments, the dendrimer is at least partially acetylated.

Dendrimers are not limited by their method of synthesis. The dendrimer may be synthesized by divergent synthesis methods or convergent synthesis methods. In certain embodiments of the present invention, dendrimer molecules may be modified. Modifications may include but are not limited to the addition of amine-blocking groups (e.g., acetyl groups), ligands, functional groups, conjugates, and/or linkers not originally present on the dendrimer. Modification may be partial or complete. In some embodiments, all of the termini of the dendrimer molecules are modified. In some embodiments, not all of the dendrimer molecules are modified. In preferred embodiments, methods and systems of the present invention permit identification and isolation of subpopulations of dendrimers with known numbers of ligand attachments (e.g., conjugations) per dendrimer molecule, thereby yielding samples or subpopulations of dendrimer compositions with high structural uniformity.

In certain embodiments, reactants are purified prior to inclusion in additional reactions, prior to analysis, and/or prior to final use. Purification methods include but are not limited to dialysis and precipitation. As non-limiting examples, purification may occur by dialysis against water, or dialysis against buffer, or dialysis against isotonic saline solution, or against any sequential combination of dialysis solutions (e.g., buffer and then water, isotonic saline solution and then water). As further non-limiting examples, purification may occur by precipitation in organic solvents such as diethyl ether, hexane, cyclohexane, ethyl acetate, acetone, chloroform, dichloromethane, tetrahydrofuran, or any combination solution of aforementioned solvents, or any combination solution of aforementioned solvents and more polar solvents such as dioxane, ethanol, methanol, N,N-dimethylformamide, dimethylsulfoxide, N,N-dimethylacetamide, 2-pyrrolidinone, and 1-methyl-2-pyrrolidinone.

The present invention is not limited to particular ligand types (e.g., functional groups) (e.g., for conjugation with dendrimers). Examples of ligand types (e.g., functional groups) include but are not limited to therapeutic agents, targeting agents, trigger agents, and imaging agents.

In some embodiments, dendrimers are conjugated with a ligand comprising an alkyne group. In some embodiments, dendrimers are conjugated with a ligand comprising an aromatic group. In some embodiments, dendrimers are conjugated with a ligand selected from the group consisting of (3-(4-)2-azidoethoxy)phenyl)propanoic acid) and (3-(4-(prop-2-ynyloxy)phenyl)propanoic acid. In some embodiments, dendrimer ligands, linkers, and/or conjugates are capable of participating in click chemistry reactions.

Methods, systems, and compositions of the present invention are not limited by the number of different ligand types used. There may be 1, 2, 3, 4, 5, 6, 7, 8, 9, 10 or more different types of ligands attached to a dendrimer molecule. While methods, systems, and compositions of the present invention provide subpopulations or samples of dendrimers (e.g., a plurality of dendrimers) with high structural uniformity, such dendrimer compositions are not limited by the total number of ligands (conjugates, linkers, therapeutic agents, targeting agents, trigger agents, imaging agents) present per molecule of dendrimer. The total number of ligands present per molecule of dendrimer may be 0, 1, 2, 3, 4, 5, 6, 7, 8, 9, 10, 10-20, 20-50, 50 or more.

In some embodiments, conjugation between a ligand and a functional group or between functional groups is accomplished through use of a 1,3-dipolar cycloaddition reaction (“click chemistry”). ‘Click chemistry’ involves, for example, the coupling of two different moieties (e.g., a therapeutic agent and a functional group) (e.g., a first functional group and a second functional group) via a 1,3-dipolar cycloaddition reaction between an alkyne moiety (or equivalent thereof) on the surface of the first moeity and an azide moiety (or equivalent thereof) (or any active end group such as, for example, a primary amine end group, a hydroxyl end group, a carboxylic acid end group, a thiol end group, etc.) on the second moiety. ‘Click’ chemistry is an attractive coupling method because, for example, it can be performed with a wide variety of solvent conditions including aqueous environments. For example, the stable triazole ring that results from coupling the alkyne with the azide is frequently achieved at quantitative yields and is considered to be biologically inert (see, e.g., Rostovtsev, V. V.; et al., Angewandte Chemie-International Edition 2002, 41, (14), 2596; Wu, P.; et al., Angewandte Chemie-International Edition 2004, 43, (30), 3928-3932; each herein incorporated by reference in their entireties).

In some embodiments, the ligand(s) (e.g., functional group(s)) is attached with the dendrimer via a linker. The present invention is not limited to a particular type or kind of linker. In some embodiments, the linker comprises a spacer comprising between 1 and 8 straight or branched carbon chains. In some embodiments, the straight or branched carbon chains are unsubstituted. In some embodiments, the straight or branched carbon chains are substituted with alkyls.

In certain embodiments, the present invention provides methods for preparing a plurality of dendrimers comprising: a) conjugation of at least one ligand type to a dendrimer to yield a population of ligand-conjugated dendrimers; b) separation of the population of ligand-conjugated dendrimers with reverse phase HPLC to result in subpopulations of ligand-conjugated dendrimers indicated by a chromatographic trace; and c) application of peak fitting analysis to the chromatographic trace to identify subpopulations of ligand-conjugated dendrimers wherein the structural uniformity of ligand conjugates per molecule of dendrimer within said subpopulation is approximately 80% or more (e.g., 70-73%, 73-75%, 75-80%, 80-81%, 81-85%, 85-90%, 90-97%, 99.99% or higher). In some embodiments, the plurality of dendrimers comprises PAMAM dendrimers. In some embodiments, at least one ligand type comprises an aromatic group. In some embodiments, at least one ligand type is capable of click chemistry. In some embodiments, at least one ligand type is selected from the group consisting of (3-(4-)2-azidoethoxy)phenyl)propanoic acid) and (3-(4-(prop-2-ynyloxy)phenyl)propanoic acid. In some embodiments, at least one ligand type is a type such as a therapeutic agent, a targeting agent, a trigger agent, and an imaging agent. In some embodiments, the method further comprises blocking NH₂-terminal branches of said plurality of dendrimers with a blocking agent. In some embodiments, the blocking agent comprises an acetyl group. In some embodiments, reverse phase HPLC is performed using silica gel ranging from C3 to C8. In some embodiments, reverse phase HPLC is performed using C5 silica gel media. In some embodiments, reverse phase HPLC is conducted using a mobile phase for elution of said ligand-conjugated dendrimers, wherein the mobile phase comprises a linear gradient beginning with 100:0 (v/v) water:acetonitrile and ending with 20:80 (v/v) water:acetonitrile. In some embodiments, the gradient is applied at a flow rate of 1 ml/min. In some embodiments, the peak fitting analysis is performed using a Gaussian fit with an exponential decay tail.

In certain embodiments, the present invention provides a dendrimer product made by the process comprising: a) conjugation of at least one ligand type to a dendrimer to yield a population of ligand-conjugated dendrimers; b) separation of the population of ligand-conjugated dendrimers with reverse phase HPLC to result in subpopulations of ligand-conjugated dendrimers indicated by a chromatographic trace; and c) application of peak fitting analysis to the chromatographic trace to identify subpopulations of ligand-conjugated dendrimers wherein the structural uniformity of ligand conjugates per molecule of dendrimer within said subpopulation is approximately 80% or more (e.g., 70-73%, 73-75%, 75-80%, 80-81%, 81-85%, 85-90%, 90-97%, 99.99% or higher). In some embodiments, the dendrimer molecules are PAMAM dendrimers. In some embodiments, at least one ligand type comprises an aromatic group. In some embodiments, at least one ligand type is capable of click chemistry. In some embodiments, at least one ligand type is a type such as (3-(4-)2-azidoethoxy)phenyl)propanoic acid) and (3-(4-(prop-2-ynyloxy)phenyl)propanoic acid. In some embodiments, the product further comprises conjugates such as therapeutic agents, targeting agents, trigger agents, and imaging agents. In some embodiments, the product further comprises nanomaterials selected from the group consisting of gold nanoparticles, iron oxide nanoparticles, polymers, silica, albumin, quantum dots, and carbon nanotubes. In some embodiments, terminal branches of the dendrimer molecules comprise a blocking agent. In some embodiments, the blocking agent comprises an acetyl group.

Certain embodiments of the present invention provide a composition comprising ten or more (e.g., 10, 10-50, 50-100, 100-1000, 10⁴-10⁵, 10⁵-10⁶, 10⁶-10⁷, 10⁷-10¹⁶, 10¹⁶-10¹⁰⁰, 10¹⁰⁰ or more, etc.) dendrimer molecules having one or more ligands, wherein approximately 80% or more (e.g., 70-73%, 73-75%, 75-80%, 80-81%, 81-85%, 85-90%, 90-97%, 99.99% or higher) of the dendrimer molecules having one or more ligands are structurally uniform. In some embodiments, 85% or more of the dendrimer molecules having one or more ligands are structurally uniform. In some embodiments, 90% or more of the dendrimer molecules having one or more ligands are structurally uniform. In some embodiments, 95% or more of the dendrimer molecules having one or more ligands are structurally uniform. In some embodiments, 98% or more of the dendrimer molecules having one or more ligands are structurally uniform. In some embodiments, 99.999% or more of the dendrimer molecules having one or more ligands are structurally uniform. In some embodiments, dendrimer molecules are PAMAM dendrimers. In some embodiments, one or more ligands comprise an aromatic group. In some embodiments, one or more ligands are capable of click chemistry. In some embodiments, one or more ligands are ligands such as (3-(4-)2-azidoethoxy)phenyl)propanoic acid) and (3-(4-(prop-2-ynyloxy)phenyl)propanoic acid. In some embodiments, the composition further comprises conjugates such as therapeutic agents, targeting agents, trigger agents, and imaging agents. In some embodiments, the composition further comprises nanomaterials such as gold nanoparticles, iron oxide nanoparticles, polymers, silica, albumin, quantum dots, and carbon nanotubes. In some embodiments, terminal branches of the ten or more dendrimer molecules comprise a blocking agent. In some embodiments, the blocking agent comprises an acetyl group.

In certain embodiments, the present invention provides a method of preparing dendrimer molecules having one or more ligands, comprising: a) conjugating a plurality of dendrimer molecules with one or more ligand molecules so as to yield a population of dendrimer molecules conjugated with one or more ligand molecules; and b) using reverse phase HPLC to separate the population of dendrimer molecules conjugated with one or more ligand molecules into subpopulations of dendrimer molecules conjugated with one or more ligand molecules, wherein approximately 80% or more (e.g., 70-73%, 73-75%, 75-80%, 80-81%, 81-85%, 85-90%, 90-97%, 99.99% or higher) of the dendrimer molecules conjugated with one or more ligand molecules within each subpopulation are structually uniform. In some embodiments, the method further comprises quantitatively determining the number of ligand conjugations per dendrimer molecule. In some embodiments, the quantitative determination is performed by peak analysis. In some embodiments, the dendrimer molecules are PAMAM dendrimers. In some embodiments, the ligands comprise an aromatic group. In some embodiments, the ligands are capable of click chemistry. In some embodiments, the ligands are ligands such as (3-(4-)2-azidoethoxy)phenyl)propanoic acid) and (3-(4-(prop-2-ynyloxy)phenyl)propanoic acid. In some embodiments, the method further comprises conjugation of nanomaterials selected from the group consisting of gold nanoparticles, iron oxide nanoparticles, polymers, silica, albumin, quantum dots, and carbon nanotubes. In some embodiments, terminal branches of the dendrimer molecules comprise a blocking agent. In some embodiments, the blocking agent comprises an acetyl group.

Certain embodiments of the present invention provide a product made by the process comprising: a) conjugating a plurality of dendrimer molecules with one or more ligand molecules so as to yield a population of dendrimer molecules conjugated with one or more ligand molecules; and b) using reverse phase HPLC to separate the population of dendrimer molecules conjugated with one or more ligand molecules into subpopulations of dendrimer molecules conjugated with one or more ligand molecules, wherein approximately 80% or more (e.g., 70-73%, 73-75%, 75-80%, 80-81%, 81-85%, 85-90%, 90-97%, 99.99% or higher) of the dendrimer molecules conjugated with one or more ligand molecules within each subpopulation are structurally uniform. In some embodiments, the plurality of dendrimer molecules comprises PAMAM dendrimers. In some embodiments, one or more ligand molecules comprise an aromatic group. In some embodiments, one or more ligand molecules are capable of click chemistry. In some embodiments, one or more ligands are ligands such as (3-(4-)2-azidoethoxy)phenyl)propanoic acid) and (3-(4-(prop-2-ynyloxy)phenyl)propanoic acid. In some embodiments, the product further comprises ligands such as therapeutic agents, targeting agents, trigger agents, and imaging agents. In some embodiments, the product further comprises nanomaterials selected from the group consisting of gold nanoparticles, iron oxide nanoparticles, polymers, silica, albumin, quantum dots, and carbon nanotubes. In some embodiments, terminal branches of the dendrimer molecules comprise a blocking agent. In some embodiments, the blocking agent comprises an acetyl group.

Examples of therapeutic agents include, but are not limited to, a chemotherapeutic agent, an anti-oncogenic agent, an anti-angiogenic agent, a tumor suppressor agent, an anti-microbial agent, an expression construct comprising a nucleic acid encoding a therapeutic protein, a pain relief agent, a pain relief agent antagonist, an agent designed to treat an inflammatory disorder, an agent designed to treat an autoimmune disorder, an agent designed to treat inflammatory bowel disease, and an agent designed to treat inflammatory pelvic disease. In some embodiments, the agent designed to treat an inflammatory disorder includes, but is not limited to, an antirheumatic drug, a biologicals agent, a nonsteroidal anti-inflammatory drug, an analgesic, an immunomodulator, a glucocorticoid, a TNF-α inhibitor, an IL-1 inhibitor, and a metalloprotease inhibitor. In some embodiments, the antirheumatic drug includes, but is not limited to, leflunomide, methotrexate, sulfasalazine, and hydroxychloroquine. Examples of biologicals agents include, but are not limited to, rituximab, finfliximab, etanercept, adalimumab, and golimumab. In some embodiments, the nonsteroidal anti-inflammatory drug includes, but is not limited to, ibuprofen, celecoxib, ketoprofen, naproxen, piroxicam, and diclofenac. In some embodiments, the analgesic includes, but is not limited to, acetaminophen, and tramadol. In some embodiments, the immunomodulator includes but is not limited to anakinra, and abatacept. In some embodiments, the glucocorticoid includes, but is not limited to, prednisone, and methylprednisone. In some embodiments, the TNF-α inhibitor includes but is not limited to adalimumab, certolizumab pegol, etanercept, golimumab, and infliximab. In some embodiments, the autoimmune disorder and/or inflammatory disorder includes, but is not limited to, arthritis, psoriasis, lupus erythematosus, Crohn's disease, and sarcoidosis. In some embodiments, examples of arthritis include, but are not limited to, osteoarthritis, rheumatoid arthritis, septic arthritis, gout and pseudo-gout, juvenile idiopathic arthritis, psoriatic arthritis, Still's disease, and ankylosing spondylitis.

Ligands suitable for use in certain method embodiments of the present invention are not limited to a particular type or kind of targeting agent. In some embodiments, the targeting agent is configured to target the composition to cells experiencing inflammation (e.g., arthritic cells). In some embodiments, the targeting agent is configured to target the composition to cancer cells. In some embodiments, the targeting agent comprises folic acid. In some embodiments, the targeting agent binds a receptor selected from the group consisting of CFTR, EGFR, estrogen receptor, FGR2, folate receptor, IL-2 receptor, VEGFR. In some embodiments, the targeting agent comprises an antibody that binds to a polypeptide selected from the group consisting of p53, Mucl, a mutated version of p53 that is present in breast cancer, HER-2, T and Tn haptens in glycoproteins of human breast carcinoma, and MSA breast carcinoma glycoprotein. In some embodiments, the targeting agent comprises an antibody selected from the group consisting of human carcinoma antigen, TP1 and TP3 antigens from osteocarcinoma cells, Thomsen-Friedenreich (TF) antigen from adenocarcinoma cells, KC-4 antigen from human prostrate adenocarcinoma, human colorectal cancer antigen, CA125 antigen from cystadenocarcinoma, DF3 antigen from human breast carcinoma, and p97 antigen of human melanoma, carcinoma or orosomucoid-related antigen. In some embodiments, the targeting agent is configured to permit the composition to cross the blood brain barrier. In some embodiments, the targeting agent is transferrin. In some embodiments, the targeting agent is configured to permit the composition to bind with a neuron within the central nervous system. In some embodiments, the targeting agent is a synthetic tetanus toxin fragment. In some embodiments, the synthetic tetanus toxin fragment comprises an amino acid peptide fragment. In some embodiments, the amino acid peptide fragment is HLNILSTLWKYR.

In some embodiments, the ligand comprises a trigger agent. The present invention is not limited to particular type or kind of trigger agent. In some embodiments, the trigger agent is configured to have a function such as, for example, a) a delayed release of a functional group from the dendrimer, b) a constitutive release of the therapeutic agent from the dendrimer, c) a release of a functional group from the dendrimer under conditions of acidosis, d) a release of a functional group from a dendrimer under conditions of hypoxia, and e) a release of the therapeutic agent from a dendrimer in the presence of a brain enzyme. Examples of trigger agents include, but are not limited to, an ester bond, an amide bond, an ether bond, an indoquinone, a nitroheterocyle, and a nitroimidazole. In some embodiments, the trigger agent is attached with the dendrimer via a linker.

Ligands suitable for use in certain method embodiments of the present invention are not limited to a particular type or kind of imaging agent. Examples of imaging agents include, but are not limited to, fluorescein isothiocyanate (FITC), 6-TAMARA, acridine orange, and cis-parinaric acid.

Specific examples of functional ligands used in some method embodiments of the present invention include but are not limited to folic acid, methotrexate, camptothecin deriviatives (e.g., SN-38), and fluorescein-5(6)-carboxamidocaproic acid (FITC).

Certain embodiments of the present invention provide a method of treating a condition with a composition comprising a plurality of dendrimer molecules, wherein each dendrimer molecule is conjugated to at least one type of ligand, and wherein the structural uniformity of the number of ligand conjugates within the plurality of dendrimer molecules is approximately 80% or higher (e.g., 70-73%, 73-75%, 75-80%, 80-81%, 81-85%, 85-90%, 90-97%, 99.99% or higher); or a composition comprising ten or more dendrimer molecules having one or more ligands, wherein approximately 80% or more (e.g., 70-73%, 73-75%, 75-80%, 80-81%, 81-85%, 85-90%, 90-97%, 99.99% or higher) of said dendrimer molecules having one or more ligands are structurally uniform. The methods are not limited to treating a particular condition. Examples of such conditions include, but are not limited to, any type of cancer or cancer-related disorder (e.g., tumor, a neoplasm, a lymphoma, or a leukemia), a neoplastic disease, osteoarthritis, rheumatoid arthritis, septic arthritis, gout and pseudo-gout, juvenile idiopathic arthritis, psoriatic arthritis, Still's disease, and ankylosing spondylitis.

In some embodiments, the methods further involve, for example, co-administration of an agent selected from the group consisting of an antirheumatic drug, a biologicals agent, a nonsteroidal anti-inflammatory drug, an analgesic, an immunomodulator, a glucocorticoid, a TNF-α inhibitor, an IL-1 inhibitor, and a metalloprotease inhibitor. In some embodiments, the antirheumatic drug is selected from the group consisting of leflunomide, methotrexate, sulfasalazine, and hydroxychloroquine. In some embodiments, the biologicals agent is selected from the group consisting of rituximab, finfliximab, etanercept, adalimumab, and golimumab. In some embodiments, the nonsteroidal anti-inflammatory drug is selected from the group consisting of ibuprofen, celecoxib, ketoprofen, naproxen, piroxicam, and diclofenac. In some embodiments, the analgesic agent is selected from the group consisting of acetaminophen, and tramadol. In some embodiments, the immunomodulator is selected from the group consisting of anakinra, and abatacept. In some embodiments, the glucocorticoid is selected from the group consisting of prednisone, and methylprednisone. In some embodiments, the TNF-α inhibitor is selected from the group consisting of adalimumab, certolizumab pegol, etanercept, golimumab, and infliximab. In some embodiments, the methods further involve, for example, co-administration of an anti-cancer agent, a pain relief agent, and/or a pain relief agent antagonist.

In some embodiments, the neoplastic disease includes, but is not limited to, leukemia, acute leukemia, acute lymphocytic leukemia, acute myelocytic leukemia, myeloblastic, promyelocytic, myelomonocytic, monocytic, erythroleukemia, chronic leukemia, chronic myelocytic, (granulocytic) leukemia, chronic lymphocytic leukemia, Polycythemia vera, lymphoma, Hodgkin's disease, non-Hodgkin's disease, Multiple myeloma, Waldenstrom's macroglobulinemia, Heavy chain disease, solid tumors, sarcomas and carcinomas, fibrosarcoma, myxosarcoma, liposarcoma, chondrosarcoma, osteogenic sarcoma, chordoma, angiosarcoma, endotheliosarcoma, lymphangiosarcoma, lymphangioendotheliosarcoma, synovioma, mesothelioma, Ewing's tumor, leiomyosarcoma, rhabdomyosarcoma, colon carcinoma, pancreatic cancer, breast cancer, ovarian cancer, prostate cancer, squamous cell carcinoma, basal cell carcinoma, adenocarcinoma, sweat gland carcinoma, sebaceous gland carcinoma, papillary carcinoma, papillary adenocarcinomas, cystadenocarcinoma, medullary carcinoma, bronchogenic carcinoma, renal cell carcinoma, hepatoma, bile duct carcinoma, choriocarcinoma, seminoma, embryonal carcinoma, Wilms' tumor, cervical cancer, uterine cancer, testicular tumor, lung carcinoma, small cell lung carcinoma, bladder carcinoma, epithelial carcinoma, glioma, astrocytoma, medulloblastoma, craniopharyngioma, ependymoma, pinealoma, hemangioblastoma, acoustic neuroma, oligodendroglioma, meningioma, melanoma, and neuroblastomaretinoblastoma.

In some embodiments, the disorder is an inflammatory disease selected from the group consisting of, but not limited to, eczema, inflammatory bowel disease, rheumatoid arthritis, asthma, psoriasis, ischemia/reperfusion injury, ulcerative colitis and acute respiratory distress syndrome.

In some embodiments, the disorder is a viral disease selected from the group consisting of, but not limited to, viral disease caused by hepatitis B, hepatitis C, rotavirus, human immunodeficiency virus type I (HIV-I), human immunodeficiency virus type II (HIV-II), human T-cell lymphotropic virus type I (HTLV-I), human T-cell lymphotropic virus type II (HTLV-II), AIDS, DNA viruses such as hepatitis type B and hepatitis type C virus; parvoviruses, such as adeno-associated virus and cytomegalovirus; papovaviruses such as papilloma virus, polyoma viruses, and SV40; adenoviruses; herpes viruses such as herpes simplex type I (HSV-I), herpes simplex type II (HSV-II), and Epstein-Barr virus; poxviruses, such as variola (smallpox) and vaccinia virus; and RNA viruses, such as human immunodeficiency virus type I (HIV-I), human immunodeficiency virus type II (HIV-II), human T-cell lymphotropic virus type I (HTLV-I), human T-cell lymphotropic virus type II (HTLV-II), influenza virus, measles virus, rabies virus, Sendai virus, picornaviruses such as poliomyelitis virus, coxsackieviruses, rhinoviruses, reoviruses, togaviruses such as rubella virus (German measles) and Semliki forest virus, arboviruses, and hepatitis type A virus.

In some embodiments, the present invention also provides kits comprising one or more of the reagents and tools necessary to generate a conjugated dendrimer compositions of the present invention (e.g., a composition comprising ten or more (e.g., 10, 10-50, 50-100, 100-1000, 10⁴-10⁵, 10⁵-10⁶, 10⁶-10⁷, 10⁷-10¹⁶, 10¹⁶-10¹⁰⁰, 10¹⁰⁰ or more, etc.) dendrimer molecules having one or more ligands, wherein approximately 80% or more (e.g., 70-73%, 73-75%, 75-80%, 80-81%, 81-85%, 85-90%, 90-97%, 99.99% or higher) of the dendrimer molecules having one or more ligands are structurally uniform).

Additional embodiments will be apparent to persons skilled in the relevant art based on the teachings contained herein.

### DESCRIPTION OF THE DRAWINGS

FIG. 1 shows ¹H NMR spectra of PAMAM dendrimer conjugates. All samples refer to Example 2. a) Spectrum of the partially acetylated dendrimer G5-Ac₈₀—(NH₂)₃₂. Comparison of peak integrals for the methylene protons (c and e) on primary amine terminated dendrimer arms with the methyl protons (j) that are unique to acetamide terminated arms was used to determine the mean ratio of dendrimer arms. Combining this ratio with the mean total number of arms per dendrimer, determined by potentiometric titration and the number average molecular weight measurement from GPC provides the mean number of amine and acetamide terminated arms per dendrimer. These peaks were used as internal reference peaks to determine the mean number of dendrimer interior protons (f, h, and i). b) Spectrum of the partially acetylated dendrimer with a mean of 2.7 alkyne ligands G5-Ac₈₀—(NH₂)₂₉-Alkyne_{2.7} (Sample G). The mean number of ligands was calculated using the aromatic aa′ bb′ proton peaks in the alkyne ligand and the methyl proton peak j. c) Spectrum of the amine-terminated dendrimer with a mean of 3.8 alkyne ligands G5-(NH₂)₁₀₈-Alkyne_{3.8} (Sample B). The mean number of ligands was calculated using the aromatic aa′ bb′ proton peaks in the alkyne ligand and the internal dendrimer proton peaks f, h, and i. d) Chemical structure and proton labels of four terminal dendrimer arms with three different end group terminations: amine, actyl, amine, and the alkyne ligand (listed right to left).

FIG. 2 shows an expanded view of the aa′ bb′ proton peaks in the ¹H NMR spectra of Samples A-D (Example 2) (panel a-d respectively). As the mean number of ligands increases from 1.1 to 12.9, the full width at half max (FWHM) of both aromatic peaks increases: 0.034 Hz, 0.042 Hz, 0.044 Hz, and 0.064 Hz respectively.

FIG. 3 shows HPLC elution traces of dendrimer-ligand conjugates at 210 nm. All samples refer to Example 2. Traces were normalized to the largest peak and off-set on the vertical axis based on the mean number of ligands per dendrimer. The HPLC trace of the un-modified parent dendrimer for each sample set is provided at the base of each panel (G5-(NH₂)₁₁₂ and G5-Ac₈₀—(NH₂)₃₂). a) HPLC traces for the G5-NH₂-Alkyne sample set (Samples A-D). b) HPLC traces for the G5-Ac₈₀-Alkyne sample set (Samples E-I).

FIG. 4 shows that a peak fitting method used in one embodiment of the present invention quantifies the distribution of dendrimer-ligand species resolved in the HPLC elution traces. All samples refer to Example 2. a) HPLC trace at 210 nm of Sample B (G5-(NH₂)₁₀₈-Alkyne_{3.8}). Six different peaks (0-5) were observed in the sample's trace. Peak 0 had the same elution time as the parent dendrimer (G5-(NH₂)₁₁₂). HPLC trace at 210 nm of Sample G (G5-Ac₈₀—(NH₂)₁₀₉-Alkyne_{2.7}). Six different peaks (0-5) were observed in the sample's trace. Peak 0 had the same elution time as the parent dendrimer (G5-Ac₈₀—(NH₂)₃₂).

c) Fitted HPLC trace for Sample B. The experimental HPLC data is shown with gray dots, individual fitting peaks are plotted in thick black, and the summation of the fitting peaks is plotted in thin black. The fitting peak was developed to have the same shape as the parent dendrimer. d) Fitted HPLC trace for Sample G. The pattern code for panel d is the same as panel c. Residual values for panels c and d are in 10⁻⁶.

FIG. 5 shows quantified dendrimer-ligand distributions determined by the peak fitting enabled decovolution of the HPLC traces. All samples refer to Example 2. a) Dendrimer-ligand distributions for G5-NH₂-based samples (Samples A-D). b) Dendrimer-ligand distributions for G5-Ac₈₀—(NH₂)₃₂-based samples (Samples E-I).

FIG. 6 shows comparison of dendrimer-ligand distributions for samples with similar ligand means. All samples refer to Example 2. a) Distributions for Samples I and D with ligand means of 10.2 and 12.9, respectively. b) Distributions for samples with means between 2.7 and 6.8 (Samples G, B, C and H). c) Distributions for samples with means between 0.4 and 1.1 (Samples E, F and A).

FIG. 7 shows theoretical distribution of dendrimer species that compose a dendrimer sample with a mean of 4 folic acid and 5 methotrexate molecules per dendrimer. This figure assumes that folic acid and methotrexate follow Poissonian distributions (statistically distributed). a) Poisson distributions with means of 4 and 5 molecules per dendrimer. b) The relative concentration of dendrimer species with different numbers of folic acid and methotrexate. Approximately 4% of the dendrimer sample is composed of a dendrimer with exactly 4 folic acid and 5 methotrexate molecules. Only 0.3 to <0.01% is expect to consist of 4 folic acid and 5 methotrexate molecules with the optimally active γ regiochemistry.

FIG. 8 shows a comparison of dendrimer-ligand distributions with Poisson and Gaussian distributions. In all cases, the Poisson distribution has two inputs: the ligand mean and the total number of available attachment points on the dendrimer surface (32). The Gaussian distribution also has two inputs: the ligand mean and the standard deviation. a) The distribution for Sample H with a mean of 6.8 ligands per dendrimer. Two Gaussian distributions are shown, each with means of 6.8 and with standard deviations of 1 (gray crosshatching) and 4 (solid gray). b) The distribution for Sample G with a mean of 2.7 ligands per dendrimer. Two Gaussian distributions are show, each with means of 2.7 and with standard deviations of 1 (gray crosshatching) and 3 (solid green). c) The distribution for Sample E with a mean of 0.4 ligands per dendrimer. The Gaussian distribution has a mean of 0.4 and a standard deviation of 1 (solid gray).

FIG. 9 shows isolation of dendrimer systems with exact numbers of ligand conjugates per dendrimer molecule. Partially acetylated G5 PAMAM dendrimer with an average of 0.45 ligands per dendrimer were injected four times on a semi-preparative reverse phase HPLC. The resolved component peaks (Peaks 0-4) corresponding to dendrimer with different numbers of conjugated ligands were isolated using a fraction collector. Identification of the component peaks was achieved using a peak fitting analysis.

FIG. 10 shows equilibrated molecular dynamics models and schematics of G5 PAMAM dendrimers with different numbers of ligands. Terminal amines, acetyl groups, and ligands are depicted in the models. Corresponding schematic representations show the dendrimer in as a shaded sphere with terminal groups. PAMAM dendrimers are monodisperse, highly ordered, water soluble, polymeric nanoparticles (˜4.5 nm diameter). Terminal amines can be used as coupling points to attach different ligands.

FIG. 11 shows ¹H NMR spectrum for sample D in Example 2. The average number of ligands per dendrimer was determined by comparison of the aromatic protons on the ligand vs the methyl protons in the acetyl group of the dendrimer. The number of acetyl groups was determined independently by GPC and potentiometric titration.

FIG. 12 shows HPLC elution data for dendrimer-ligand conjugates. (a) Dendrimer concentration monitored at 210 nm for samples A-D (Example 2) are shown with solid lines. The elution profile of sample D at 276 nm, which is the maximum absorbance for the ligand, is displayed with a dashed line. Absorbance is normalized to the peak maximum. (b) The elution profile at 210 nm for sample D is shown in gray dots. Individual fitted peaks are presented in thick black, and the summation of the fitted peaks are in thin black.

FIG. 13 shows experimental and statistical distributions of ligand-dendrimer conjugates A-D (Example 2). Experimental distribution is calculated from fitted peaks to the HPLC elution profiles.

FIG. 14 shows that standard analytical techniques that are commonly utilized to characterize nanoparticle conjugates fail to detect the different dendrimer-ligand populations. (a) The light scattering data of four dendrimer-ligand samples and partially acetylated dendrimer starting material, as separated by gel permeation chromatography (GPC), clearly demonstrate the challenges in detecting the different populations based on differences in size. The single peak resolution achieved by GPC is in stark contrast to the multiple peak resolution achieved by HPLC (see Example 2 for GPC conditions). (b) Similarly, molecular weight analysis of the same material by matrix-assisted laser desorption time-of-flight mass spectrometry (MALDI-TOF MS) cannot detect significant differences between the five samples (see Example 2 for MALDI-TOF conditions).

FIG. 15 shows peaks fit to each of the elution using the fitting procedure described in Example 2. Peak concentration was calculated as the product of the Peak Area Fraction and the Sample Concentration. The linear relationship found in FIG. 16 between Peak Area and Peak concentration clearly demonstrates that Beer's Law is followed at 210 nm for the dendrimer conjugates.

FIG. 16 shows peak area vs. peak concentration as described in FIG. 15.

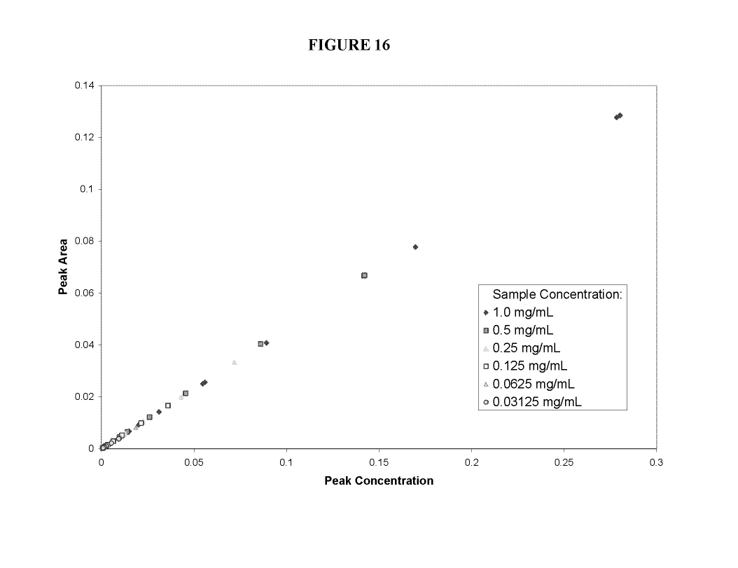

FIG. 17 shows HPLC profiles for partially acetylated dendrimer (dark line) and partially acetylated dendrimer with an average of 3.1 ligands (light line).

FIG. 18 shows isolation of dendrimer-ligand components by semi-preparative HPLC. a) Semi-preparative HPLC traces for the 12 identical runs. The 120 fractions starting at 20 minutes are shown in grey. The selected fractions for each of the different dendrimer-ligand components (0-8) are highlighted in solid grey bars. b) Peak fitting analysis of the trace for Run 6. The HPLC data is presented in circles and the multiple copies of the fitting peak are shown in thin grey lines. The summation of these fitting peaks is shown as a thick dark grey line. The residual values in panel b are multiplied by 10⁶.

FIG. 19 shows analytical HPLC analysis for the isolated dendrimer-ligand components. a) Baseline-corrected traces for dendrimer-ligand components with 0-8 ligands run immediately after the isolation process. The area of each peak is directly proportional to the amount of isolated material. The HPLC trace for the dendrimer distribution with a mean of 4.3 ligands is also included. This trace of the distribution has been normalized. b) Traces for the isolated dendrimer-ligand components after purification. Each trace has been baseline corrected and normalized. Thin vertical lines show the relationships between each isolated component and the material with the distribution of components. In addition to the major peak in each component, small amount of other components have been detected. c) The peak fitting method was used to quantify the purity of each isolated component. Fitting peaks are shown in thin grey lines, with the summation of these peaks as a thick grey line. The HPLC data is shown in circles. The residual values in panel c are multiplied by 10⁶.

FIG. 20 shows ¹H NMR characterization. a) Spectrum for the isolated dendrimer with one ligand. b) Chemical structure and proton labels for the Azide Ligand and acetyl terminated dendrimer arms.

### DEFINITIONS

To facilitate an understanding of the present invention, a number of terms and phrases are defined below:

As used herein, the term “subject” refers to any animal (e.g., a mammal), including, but not limited to, humans, non-human primates, rodents, and the like, which is to be the recipient of a particular treatment. Typically, the terms “subject” and “patient” are used interchangeably herein in reference to a human subject.

As used herein, the term “non-human animals” refers to all non-human animals including, but not limited to, vertebrates such as rodents, non-human primates, ovines, bovines, ruminants, lagomorphs, porcines, caprines, equines, canines, felines, ayes, etc.

As used herein, the term “subject suspected of having cancer” refers to a subject that presents one or more symptoms indicative of a cancer (e.g., a noticeable lump or mass) or is being screened for a cancer (e.g., during a routine physical). A subject suspected of having cancer may also have one or more risk factors. A subject suspected of having cancer has generally not been tested for cancer. However, a “subject suspected of having cancer” encompasses an individual who has received a preliminary diagnosis (e.g., a CT scan showing a mass) but for whom a confirmatory test (e.g., biopsy and/or histology) has not been done or for whom the stage of cancer is not known. The term further includes people who once had cancer (e.g., an individual in remission). A “subject suspected of having cancer” is sometimes diagnosed with cancer and is sometimes found to not have cancer.

As used herein, the term “subject diagnosed with a cancer” refers to a subject who has been tested and found to have cancerous cells. The cancer may be diagnosed using any suitable method, including but not limited to, biopsy, x-ray, blood test, and the diagnostic methods of the present invention.

As used herein, the term “sample” is used in its broadest sense. In one sense, it is meant to include a specimen or culture obtained from any source, as well as biological and environmental samples. Biological samples may be obtained from animals (including humans) and encompass fluids, solids, tissues, and gases. Biological samples include blood products, such as plasma, serum and the like. Environmental samples include environmental material such as surface matter, soil, water, crystals and industrial samples. Such examples are not however to be construed as limiting the sample types applicable to the present invention.

As used herein, the term “drug” is meant to include any molecule, molecular complex or substance administered to an organism for diagnostic or therapeutic purposes, including medical imaging, monitoring, contraceptive, cosmetic, nutraceutical, pharmaceutical and prophylactic applications. The term “drug” is further meant to include any such molecule, molecular complex or substance that is chemically modified and/or operatively attached to a biologic or biocompatible structure.

As used herein, the term “purified” or “to purify” or “compositional purity” refers to the removal of components (e.g., contaminants) from a sample or the level of components (e.g., contaminants) within a sample. For example, unreacted moieties, degradation products, excess reactants, or byproducts are removed from a sample following a synthesis reaction or preparative method.

“Amino acid sequence” and terms such as “polypeptide” or “protein” are not meant to limit the amino acid sequence to the complete, native amino acid sequence associated with the recited protein molecule.

The term “native protein” as used herein to indicate that a protein does not contain amino acid residues encoded by vector sequences; that is, the native protein contains only those amino acids found in the protein as it occurs in nature. A native protein may be produced by recombinant means or may be isolated from a naturally occurring source.

As used herein the term “portion” when in reference to a protein (as in “a portion of a given protein”) refers to fragments of that protein. The fragments may range in size from four amino acid residues to the entire amino acid sequence minus one amino acid.

As used herein, the term “cell culture” refers to any in vitro culture of cells. Included within this term are continuous cell lines (e.g., with an immortal phenotype), primary cell cultures, transformed cell lines, finite cell lines (e.g., non-transformed cells), and any other cell population maintained in vitro.

As used herein, the term “eukaryote” refers to organisms distinguishable from “prokaryotes.” It is intended that the term encompass all organisms with cells that exhibit the usual characteristics of eukaryotes, such as the presence of a true nucleus bounded by a nuclear membrane, within which lie the chromosomes, the presence of membrane-bound organelles, and other characteristics commonly observed in eukaryotic organisms. Thus, the term includes, but is not limited to such organisms as fungi, protozoa, and animals (e.g., humans).

As used herein, the term “in vitro” refers to an artificial environment and to processes or reactions that occur within an artificial environment. In vitro environments can consist of, but are not limited to, test tubes and cell culture. The term “in vivo” refers to the natural environment (e.g., an animal or a cell) and to processes or reaction that occur within a natural environment.

The terms “test compound” and “candidate compound” refer to any chemical entity, pharmaceutical, drug, and the like that is a candidate for use to treat or prevent a disease, illness, sickness, or disorder of bodily function (e.g., cancer). Test compounds comprise both known and potential therapeutic compounds. A test compound can be determined to be therapeutic by screening using screening methods known in the art.

As used herein, the term “nanodevice” or “nanodevices” refer, generally, to compositions comprising dendrimers of the present invention. As such, a nanodevice may refer to a composition comprising a dendrimer of the present invention that may contain one or more ligands, linkers, and/or functional groups (e.g., a therapeutic agent, a targeting agent, a trigger agent, an imaging agent) conjugated to the dendrimer.

As used herein, the term “degradable linkage,” when used in reference to a polymer refers to a conjugate that comprises a physiologically cleavable linkage (e.g., a linkage that can be hydrolyzed (e.g., in vivo) or otherwise reversed (e.g., via enzymatic cleavage). Such physiologically cleavable linkages include, but are not limited to, ester, carbonate ester, carbamate, sulfate, phosphate, acyloxyalkyl ether, acetal, and ketal linkages (See, e.g., U.S. Pat. No. 6,838,076, herein incorporated by reference in its entirety). Similarly, the conjugate may comprise a cleavable linkage present in the linkage between the dendrimer and functional group, or, may comprise a cleavable linkage present in the polymer itself (See, e.g., U.S. Pat. App. Nos. 20050158273 and 20050181449, each of which is herein incorporated by reference in its entirety).

A “physiologically cleavable” or “hydrolysable” or “degradable” bond is a bond that reacts with water (i.e., is hydrolyzed) under physiological conditions. The tendency of a bond to hydrolyze in water will depend not only on the general type of linkage connecting two central atoms but also on the substituents attached to these central atoms. Appropriate hydrolytically unstable or weak linkages include but are not limited to carboxylate ester, phosphate ester, anhydrides, acetals, ketals, acyloxyalkyl ether, imines, orthoesters, peptides and oligonucleotides.

An “enzymatically degradable linkage” means a linkage that is subject to degradation by one or more enzymes.

A “hydrolytically stable” linkage or bond refers to a chemical bond (e.g., typically a covalent bond) that is substantially stable in water (i.e., does not undergo hydrolysis under physiological conditions to any appreciable extent over an extended period of time). Examples of hydrolytically stable linkages include, but are not limited to, carbon-carbon bonds (e.g., in aliphatic chains), ethers, amides, urethanes, and the like.

As used herein, the term “NAALADase inhibitor” refers to any one of a multitude of inhibitors for the neuropeptidase NAALADase (N-acetylated-alpha linked acidic dipeptidase). Such inhibitors of NAALADase have been well characterized. For example, an inhibitor can be selected from the group comprising, but not limited to, those found in U.S. Pat. No. 6,011,021, herein incorporated by reference in its entirety.

As used herein, an “NH₂-terminal blocking agent” is a functional group that prevents the reactivity of NH₂-terminal branches of dendrimers. Such blocking agents include but are not limited to acetyl groups. Blocking of NH₂-terminal dendrimers may be partial or complete.

As used herein, an “ester coupling agent” refers to a reagent that can facilitate the formation of an ester bond between two reactants. The present invention is not limited to any particular coupling agent or agents. Examples of coupling agents include but are not limited to 2-chloro-1-methylpyridium iodide and 4-(dimethylamino) pyridine, or dicyclohexylcarbodiimide and 4-(dimethylamino) pyridine or diethyl azodicarboxylate and triphenylphosphine or other carbodiimide coupling agent and 4-(dimethylamino)pyridine.

As used herein, the term “glycidolate” refers to the addition of a 2,3-dihydroxylpropyl group to a reagent using glycidol as a reactant. In some embodiments, the reagent to which the 2,3-dihydroxylpropyl groups are added is a dendrimer. In some embodiments, the dendrimer is a PAMAM dendrimer. Glycidolation may be used generally to add terminal hydroxyl functional groups to a reagent.

As used herein, the term “amino alcohol” or “amino-alcohol” refers to any organic compound containing both an amino and an aliphatic hydroxyl functional group (e.g., which may be an aliphatic or branched aliphatic or alicyclic or hetero-alicyclic compound containing an amino group and one or more hydroxyl(s)). The generic structure of an amino alcohol may be expressed as NH₂—R—(OH)ₘ wherein m is an integer, and wherein R comprises at least two carbon molecules (e.g., at least 2 carbon molecules, 10 carbon molecules, 25 carbon molecules, 50 carbon molecules).

As used herein, the term “one-pot synthesis reaction” or equivalents thereof, e.g., “1-pot”, “one pot”, etc., refers to a chemical synthesis method in which all reactants are present in a single vessel. Reactants may be added simultaneously or sequentially, with no limitation as to the duration of time elapsing between introduction of sequentially added reactants. In some embodiments, conjugation between a dendrimer (e.g., a terminal arm of a dendrimer) and a functional ligand is accomplished during a “one-pot” reaction. The term “one-pot synthesis reaction” or equivalents thereof, e.g., “1-pot”, “one pot”, etc., refers to a chemical synthesis method in which all reactants are present in a single vessel. Reactants may be added simultaneously or sequentially, with no limitation as to the duration of time elapsing between introduction of sequentially added reactants. In some embodiments, a one-pot reaction occurs wherein a hydroxyl-terminated dendrimer (e.g., HO-PAMAM dendrimer) is reacted with one or more functional ligands (e.g., a therapeutic agent, a pro-drug, a trigger agent, a targeting agent, an imaging agent) in one vessel, such conjugation being facilitated by ester coupling agents (e.g., 2-chloro-1-methylpyridinium iodide and 4-(dimethylamino) pyridine) (see, e.g., U.S. Patent App. No. 61/226,993, herein incorporated by reference in its entirety).

As used herein, the term “solvent” refers to a medium in which a reaction is conducted. Solvents may be liquid but are not limited to liquid form. Solvent categories include but are not limited to nonpolar, polar, protic, and aprotic.

As used herein, the term “dialysis” refers to a purification method in which the solution surrounding a substance is exchanged over time with another solution. Dialysis is generally performed in liquid phase by placing a sample in a chamber, tubing, or other device with a selectively permeable membrane. In some embodiments, the selectively permeable membrane is cellulose membrane. In some embodiments, dialysis is performed for the purpose of buffer exchange. In some embodiments, dialysis may achieve concentration of the original sample volume. In some embodiments, dialysis may achieve dilution of the original sample volume.

As used herein, the term “precipitation” refers to purification of a substance by causing it to take solid form, usually within a liquid context. Precipitation may then allow collection of the purified substance by physical handling, e.g. centrifugation or filtration.

As used herein, the term “Baker-Huang dendrimer” or “Baker-Huang PAMAM dendrimer” refers to a dendrimer comprised of branching units of structure:

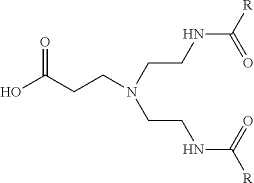

wherein R comprises a carbon-containing functional group (e.g., CF₃). In some embodiments, the branching unit is activated to its HNS ester. In some embodiments, such activation is achieved using TSTU. In some embodiments, EDA is added. In some embodiments, the dendrimer is further treated to replace, e.g., CF₃ functional groups with NH₂ functional groups; for example, in some embodiments, a CF₃-containing version of the dendrimer is treated with K₂CO₃ to yield a dendrimer with terminal NH₂ groups (for example, as shown in U.S. patent application Ser. No. 12/645,081, herein incorporated by reference in its entirety). In some embodiments, terminal groups of a Baker-Huang dendrimer are further derivatized and/or further conjugated with other moieties. For example, one or more functional ligands (e.g., for therapeutic, targeting, imaging, or drug delivery function(s)) may be conjugated to a Baker-Huang dendrimer, either via direct conjugation to terminal branches or indirectly (e.g., through linkers, through other functional groups (e.g., through an OH-functional group)). In some embodiments, the order of iterative repeats from core to surface is amide bonds first, followed by tertiary amines, with ethylene groups intervening between the amide bond and tertiary amines. In preferred embodiments, a Baker-Huang dendrimer is synthesized by convergent synthesis methods.

As used herein, the term “click chemistry” refers to chemistry tailored to generate substances quickly and reliably by joining small modular units together (see, e.g., Kolb et al. (2001) Angewandte Chemie Intl. Ed. 40:2004-2011; Evans (2007) Australian J. Chem. 60:384-395; Carlmark et al. (2009) Chem. Soc. Rev. 38:352-362; each herein incorporated by reference in its entirety).

As used herein, the term “alkyne ligand” refers to a ligand bearing an alkyne functional group. In some embodiments, alkyne ligands further comprise an aromatic group.

As used herein, the term “azide ligand” refers to a ligand bearing an azide functional group. In some embodiments, azide ligands further comprise an aromatic group.

As used herein, the term “peak fitting analysis” refers to mathematical determination of the functional form of a curve in a chromatographic trace. In some embodiments, an HPLC trace is used. In some embodiments, a reverse phase HPLC trace is used. In some embodiments, software is used for peak fitting analysis (e.g., graphing software, image analysis software, data analysis software). In some embodiments, the Igor Pro software package is used. Functional forms applied to peaks may include but are not limited to Gaussian, double exponential, polynomial, Lorentzian, linear, exponential, power law, sine, lognormal, Hill equation, sigmoid, or a combination thereof. In some embodiments, a Gaussian curve with an exponential decay tail is applied. Fitting peaks may be constrained or not constrained.

As used herein, the term “high performance liquid chromatography” or “high pressure liquid chromatography” or “HPLC” refers to techniques known in the art of macromolecule separation, quantification, and identification. HPLC is used to separate mixtures of molecules on the basis of inherent properties possessed by the molecules including but not limited to size, polarity, ligand affinity, hydrophobicity, and charge. In some embodiments, “reverse phase HPLC” (also referred to as “reversed phase HPLC”, “reverse-phase HPLC”, “reversed-phase HPLC”, “RPC” or “RP-HPLC”) may be used with methods, systems, and synthesis methods of the present invention. Reverse phase HPLC involves a non-polar stationary phase and an aqueous, moderately polar mobile phase. One common stationary phase is a silica which has been treated with RMe₂SiCl, where R is a straight chain alkyl group such as C₁₈H₃₇ or C₈H₁₇. The number of carbons in the straight chain alkyl group can vary (e.g., 2, 3, 4, 5, 6, 7, 8, greater than 8). With these stationary phases, retention time is longer for molecules which are more non-polar, while polar molecules elute more readily. Retention time can be increased by adding more water to the mobile phase; thereby making the affinity of the hydrophobic analyte for the hydrophobic stationary phase stronger relative to the now more hydrophilic mobile phase. Similarly, retention time can be decreased by adding more organic solvent to the eluent.

As used herein, the term “distribution” refers to the variance in the number of different ligands attached to a dendrimer within a population of dendrimers. For example, a dendrimer sample in which the average number of ligands attachments (ligand conjugates) is 5 may have a distribution of 0-10 (i.e., some proportion of the dendrimers in the population have no ligands attached, some proportion of the dendrimers in the population have 10 ligands attached, and other proportions have between 2 and 9 ligands attached.)

As used herein, the term “ligand” refers to any moiety covalently attached (e.g., conjugated) to a dendrimer branch. Some ligands may serve as “linkers” such that they intervene or are intended to intervene in the future between the dendrimer branch terminus and another more terminal ligand. Some ligands have functional utility for specific applications, e.g., for therapeutic, targeting, imaging, or drug delivery function(s). The terms “ligand” and “conjugate” may be used interchangeably.

As used herein, the term “inflammatory disease” refers to any disease characterized by inflammation of tissues or cells. Inflammatory diseases may be acute or chronic, and include but are not limited to eczema, inflammatory bowel disease, ulcerative colitis, multiple sclerosis, myocarditis, rheumatoid arthritis, asthma, psoriasis, ischemia/reperfusion injury, ulcerative colitis, necrotizing enterocolitis, pelvic inflammatory disease, empyema, pleurisy, pyelitis, pharyginitis, acne, urinary tract infection, Crohn disease, systemic lupus erythematosus, and acute respiratory distress syndrome.

As used herein, the term “rheumatoid arthritis” (RA) refers to a chronic systemic inflammatory disease of unknown cause that primarily affects the peripheral joints in a symmetric pattern. Common symptoms include but are not limited to fatigue, malaise, and morning stiffness. Extra-articular involvement of organs such as the skin, heart, lungs, and eyes can be significant. One of ordinary skill in the medical arts appreciate that RA causes joint destruction and thus often leads to considerable morbidity and mortality.

As used herein, the term “structural uniformity” refers to the number of ligand conjugations within a dendrimer device (e.g., dendrimer system, ligand-conjugated dendrimer). In a population of dendrimer compositions with 100% structural uniformity, for example, all dendrimer molecules bear the same number of ligands if one ligand type is present; or the same number of each type of ligand if different ligand types are present. As used herein, high structural uniformity does not preclude variances in dendrimer backbone and/or branches insofar as such variances do not impact the number of ligand attachments.

### DETAILED DESCRIPTION OF THE INVENTION

While dendrimers generally offer an increased synthetic control and monodispersity over other polymeric platforms, understanding conjugate product distributions is still a critical area of interest shared over all multivalent or multifunctional materials. Functionalized dendrimers are typically reported to have an average number of targeting ligands or therapeutics, where the distribution of the population cannot be distinguished by most common characterization techniques including NMR, GPC, and MALDI (Majoros et al. (2006) Biomacromolecules 7:572-579; herein incorporated by reference in its entirety). The distributions become increasingly complicated as additional functionalities are conjugated to the dendrimer, though it should be noted that the polydispersity of these multifunctional dendrimers remain lower than other common polymeric platforms. Minute changes in reaction conditions between batches can significantly alter these distributions and as a result affect the biological activity, including toxicity, of the material. It is possible synthetic errors or alterations can create portions of the product distribution that are non-active or, worse, non-specifically toxic. For dendrimers to become a viable option for many therapeutic applications, it can be important that the biological activity does not significantly change between batches or that members of the distribution be separated to ensure a uniform population. Optimizing the product distribution through use of embodiments of the present invention offers improved control and customization over other polymeric delivery devices.

The well-defined number of terminal arms potentially allows these distributions to be better understood or controlled compared to more polydisperse platforms. For example, in experiments conducted during the course of developing some embodiments of the present invention, it was shown that dendrimers with a unique number of conjugated aromatic ligands can be distinguished using high performance liquid chromatography (HPLC). This allows a defined understanding of the distribution of ligands for a set of reaction conditions and enables clarity regarding to the relationship between biological activity and the specific number of active ligands conjugated to a dendrimer (i.e., the relationship between structural uniformity and biological activity).

Conjugation strategies commonly employed to attach ligands to the surfaces of nanoparticles generate a stochastic distribution of products. The majority of nanoparticle-ligand product characterization techniques, however, only determines the average number of ligands bound per nanoparticle and gives no information about the distribution or number of fractions that give rise to the average. Many commonly used techniques, including but not limited to nuclear magnetic resonance (NMR), ultraviolet/visible (UV/Vis) spectroscopy, Fourier transformed infrared spectroscopy (FTIR), and elemental analysis are only capable of determining the average ligand to nanoparticle ratio. Other techniques with potential to resolve product distributions such as gel permeation chromatography (GPC), high performance liquid chromatography (HPLC), and matrix assisted laser desorption ionization-time of flight (MALDI-TOF) are often unable to resolve the distribution. The observation of unresolved “single peaks” using these techniques often gives rise to optimistic, but unjustified and inaccurate, interpretations or conclusions regarding sample homogeneity.

Given the great potential that nanoparticle-ligand conjugates possess with respect to therapeutic delivery (Tong et al. (2007) Polymer Rev. 47:345-381; Rawat et al. (20060 Biol. & Pharmaceutical Bull. 29:1790-1798; Patri et al. (2002) Curr. Opin. Chem. Biol. 6:466-471; Peer et al. (2007) Nature Nanotechnol. 2:751-760; Fortin et al. (2007) J. Amer. Chem. Soc. 129:2628-2635; Johns et al. (2008) 19:1333-1346; each herein incorporated by reference in its entirety), cell targeting (Josephson et al. (1999) Bioconj. Chem. 10:186-191; Babic et al. (2008) Bioconj. Chem. 19:740-750; each herein incorporated by reference in its entirety), biomedical diagnostics (Nie et al. (2007) Ann. Rev. Biomed. Engineering 9:257-288; Landmark et al. (2008) Acs Nano 2:773-783; Kircher et al. (2003) Cancer Res. 63:8122-8125; Jain et al. (2005) Clinica Chemica Acta 358:37-54; each herein incorporated by reference in its entirety), and sensing (Pandana et al. (2008) Ieee Sensors J. 8:661-666; Park et al. (2002) Science 295:1503-1506; each herein incorporated by reference in its entirety), a comprehensive and accurate understanding of the product distributions that result from nanoparticle-ligand conjugations is paramount.

Experiments conducted during the course of developing some embodiments of the present invention demonstrated systems, methods and processes for characterizing and resolving the product distributions resulting from nanoparticle-ligand conjugations to yield dendrimer compositions with high structural uniformity. In particular, ligand distributions existing for samples produced using poly(amidoamine) (PAMAM) dendrimers were exemplified. Methods of some embodiments of the present invention are generalizable to a broad range of ligand nanoparticle conjugation reactions. Relevant examples include particles composed of gold, iron oxide, polymers, silica, albumin, quantum dots, carbon nanotubes, and dendrimers (Myc et al. (2007) Biomacromol. 8:2986-2989; Chandrasekar et al. (2007) Biomaterials 28:504-512; Derfus et al. (2007) Bioconj. Chem. 18:1391-1396; Schellenberger et al. (2004) Chembiochem. 5:275-279; Polito et al. (2008) J. Am. Chem. Soc. 130:12712-12724; Choi et al. (2005) Chem. & Biol. 12:35-43; Choi et al. (2004) Nano Lett. 4:391-394; Majoros et al. (2006) Biomacromol. 7:572-579; Chandrasekar et al. (2007) J. Biomed. Mater. Res. Part A 82A:92-103; Majoros et al. (2005) J. Med. Chem. 48:5892-5899; Hill et al. (2007) Bioconj. Chem. 18:1756-1762; Shukla et al. (2005) Chem. Comm. 46:5739-5741; each herein incorporated by reference in its entirety). Methods of some embodiments of the present invention are relevant to nanoparticle-based systems that employ stochastic synthesis techniques to achieve conjugated ligand means between 0.4 and 13 ligands per nanoparticle under reaction regimes wherein an excess of attachment sites relative to the number of conjugated ligands is present. Additionally, some method embodiments of the present invention apply primarily to small and moderate sized ligands (50 g/mole to 1000 g/mole). Nanoparticle-ligand systems include but are not limited to Quantum Dots conjugated to siRNA (Derfus et al. (2007) Bioconj. Chem. 18:1391-1396; herein incorporated by reference in its entirety) and peptides (Derfus et al. (2007) Bioconj. Chem. 18:1391-1396; herein incorporated by reference in its entirety), iron oxide nanoparticles conjugated to fluorescein isothiocyanate (FITC) (Schellenberger et al. (2004) Chembiochem 5:275-279; herein incorporated by reference in its entirety) and other small organic molecules (Schellenberger et al. (2004) Chembiochem 5:275-279; Polito et al. (2008) J. Am. Chem. Soc. 130:12712-12724; each herein incorporated by reference in its entirety), and dendrimers conjugated to oligonucleotides (Choi et al. (2005) Chem. & Biol. 12:35-43; Choi et al. (2004) Nano Lett. 4:391-397; each herein incorporated by reference in its entirety), folic acid (Myc et al. (2007) Biomacromol. 8:2986-2989; Chandrasekar et al. (2007) Biomaterials 28:504-512; Majoros et al. (2006) Biomacromol. 7:572-579; Chandrasekar et al. (2007) J. Biomed. Mater. Res. Part A 82A:92-103; Majoros et al (2005) J. Med. Chem. 48:5892-5899; each herein incorporated by reference in its entirety), peptides (Hill et al. (2007) Bioconj. Chem. 18:1756-1762; Shukla et al. (2005) 46:5739-5741; each herein incorporated by reference in its entirety), FITC (Hill et al. (2007) Bioconj. Chem. 18:1756-1762; herein incorporated by reference in its entirety), and other small molecules (Majoros et al. (2005) J. Med. Chem. 48:5892-5899; herein incorporated by reference in its entirety). The diversity of ligands that have been conjugated to dendrimers for use in biological applications makes the dendrimer a compelling system to utilize (Cloninger et al. (2002) Curr. Opin. Chem. Biol. 6:742-748; Lee et al. (2005) Nature Biotechnol. 23:1517-1526; Svenson et al. (2005) Adv. Drug Delivery Rev. 57:2106-2129; Gillies et al. (2005) Drug Discov. Today 10:35-43; Wolinsky et al. (2008) Adv. Drug Delivery Rev. 60:1037-1055; each herein incorporated by reference in its entirety). Furthermore, several of these dendrimer-ligand combinations are highly effective in biological systems both in vitro and in vivo (Kukowska-Latallo et al. (2005) Cancer Res. 65:5317-5324; Thomas et al. (2005) J. Med. Chem. 48:3729-3735; Quintana et al. (2002) Pharma. Res. 19:1310-1316; Myc et al. (2008) Anti-Cancer Drugs 19:143-149; Patri et al. (2004) Bioconj. Chem. 15:1174-1181; Baek et al. (2002) Bioorg. & Med. Chem. 10:11-17; Wu et al. (2004) Bioconj. Chem. 15:185-194; Wu et al. (2005) Chem. Comm. 44:5775-5777; each herein incorporated by reference in its entirety). A final factor making the dendrimer an attractive system for utilization is that dendrimers are structurally well-defined and well-characterized. This is especially true for PAMAM dendrimers. PAMAM dendrimers have a well defined branched structure which leads to exceptionally high degrees of monodispersity (PDI=1.01) and quantifiable mean number of surface functional groups. Generally and with few exceptions (Mullen et al. (2008) 19:1748-1752; Cason et al. (2008) J. Nanomater., Article ID 456082 doi:10.1155/2008/456082; each herein incorporated by reference in its entirety), however, only the mean number of ligands bound per dendrimer has been reported.

These challenges are exemplified by the PAMAM dendrimer-ligand system developed for targeted drug delivery by Majoros et al (Majoros et al. (2006) Biomacromol. 7:572-579; herein incorporated by reference in its entirety). Dendrimers within this dendrimer system were modified sequentially with a mean of 72 acetyl groups, 4 FITC dye molecules, 4 folic acid (FA) targeting ligands, 60 alcohols from glycidolation, and 5 methotrexate (MTX) drug molecules. Thomas et al. demonstrated cellular-uptake of this targeted drug delivery platform in KB cells that express a high cellular membrane concentration of the folic acid receptor (FAR) (Thomas et al. (2005) J. Med. Chem. 48:3729-3735; herein incorporated by reference in its entirety). In addition, Kukowska-Latallo et al. found that such targeted dendrimer nanoparticles increased the antitumor activity of MTX and substantially decreased its toxicity relative to the free drug in mice bearing human epithelial cancer (Kukowska-Latallo et al. (2005) Cancer Res. 65:5317-5324; herein incorporated by reference in its entirety). However, information about the different dendrimer-ligand distributions that existed in the material was not reported. For example, the number of different G5-FA species that are represented by the mean of 4 FA was not known, nor was it known if the largest population was even the dendrimer species with 4 FA molecules. Furthermore, information about how the various ligand distributions were affected by conducting the conjugation reactions in a step-wise fashion with distributions forming in the presence of pre-existing ligand distributions was not available. Accordingly, the utilization of such dendrimers compositions is limited.

The present invention provides systems and methods that overcome such limitations. For example, in experiments conducted during the course of developing some embodiments of the present invention, HPLC was used to quantitatively analyze and characterize functionalized dendrimer samples. In particular, HPLC traces of two different sets of nanoparticle-ligand samples were quantitatively analyzed. The nanoparticle-ligand sets were formed using two different nanoparticles: a G5 PAMAM dendrimer with a mean of 112 primary amines and a partially acetylated G5 PAMAM dendrimer with a mean of 80 Ac and 32 NH₂ groups; and a small molecule ligand: 3-(4-(prop-2-ynyloxy)phenyl)propanoic acid (Alkyne Ligand). Within each of the two sets (G5-NH₂-Alkyne and G5-Ac₈₀-Alkyne), samples were synthesized to have ligand means in the range commonly used in dendrimer applications as well as many other nanoparticle-ligand systems. The products were analyzed by ¹H NMR spectroscopy to determine the mean ligand-nanoparticle ratio. When combined with GPC and potentiometric titration data, the mean number of ligands per nanoparticle was computed. HPLC combined with a peak fitting method resolved the nanoparticle-ligand distributions and provided the mean, median, and mode of the number of ligands per particle. The HPLC quantified distributions were in excellent agreement with the ligand/dendrimer average ratio, measured by ¹H NMR, gel permeation chromatography (GPC), and potentiometric titration.

Accordingly, the present invention relates to novel methods of synthesis and isolation of dendrimer systems having a particular structural uniformity (e.g., homogeneity). In particular, the present invention is directed to novel dendrimer conjugates of defined numbers of ligand conjugates, methods of synthesizing the same, compositions comprising the conjugates, as well as systems and methods utilizing the conjugates (e.g., in diagnostic and/or therapeutic settings (e.g., for the delivery of therapeutics, imaging, and/or targeting agents (e.g., in disease (e.g., cancer) diagnosis and/or therapy, pain therapy, etc.)).

The present invention is not limited to the use of particular dendrimers. Dendrimeric polymers have been described extensively (See, e.g., Tomalia, Advanced Materials 6:529 (1994); Angew, Chem. Int. Ed. Engl., 29:138 (1990); incorporated herein by reference in their entireties). Dendrimer polymers are synthesized as defined spherical structures typically ranging from 1 to 20 nanometers in diameter. Methods for manufacturing a G5 PAMAM dendrimer with a protected core are known (U.S. patent application Ser. No. 12/403,179; herein incorporated by reference in its entirety). In preferred embodiments, the protected core diamine is NH₂—CH₂—CH₂—NHPG. Molecular weight and the number of terminal groups increase exponentially as a function of generation (the number of layers) of the polymer. In some embodiments of the present invention, half generation PAMAM dendrimers are used. For example, when an ethylenediamine (EDA) core is used for dendrimer synthesis, alkylation of this core through Michael addition results in a half-generation molecule with ester terminal groups; amidation of such ester groups with excess EDA results in creation of a full-generation, amine-terminated dendrimer (Majoros et al., Eds. (2008) Dendrimer-based Nanomedicine, Pan Stanford Publishing Pte. Ltd., Singapore, p. 42). Different types of dendrimers can be synthesized based on the core structure that initiates the polymerization process. In some embodiments, the PAMAM dendrimers are “Baker-Huang dendrimers” or “Baker-Huang PAMAM dendrimers” (see, e.g., U.S. Provisional Patent Application Ser. No. 61/251,244; herein incorporated by reference in its entirety).

The dendrimer core structures dictate several characteristics of the molecule such as the overall shape, density and surface functionality (See, e.g., Tomalia et al., Chem. Int. Ed. Engl., 29:5305 (1990)). Spherical dendrimers can have ammonia as a trivalent initiator core or ethylenediamine (EDA) as a tetravalent initiator core. Recently described rod-shaped dendrimers (See, e.g., Yin et al., J. Am. Chem. Soc., 120:2678 (1998)) use polyethyleneimine linear cores of varying lengths; the longer the core, the longer the rod. Dendritic macromolecules are available commercially in kilogram quantities and are produced under current good manufacturing processes (GMP) for biotechnology applications.

Dendrimers may be characterized by a number of techniques including, but not limited to, electrospray-ionization mass spectroscopy, ¹³C nuclear magnetic resonance spectroscopy, ¹H nuclear magnetic resonance spectroscopy, size exclusion chromatography with multi-angle laser light scattering, ultraviolet spectrophotometry, capillary electrophoresis and gel electrophoresis. These tests assure the uniformity of the polymer population and are important for monitoring quality control of dendrimer manufacture for GMP applications and in vivo usage.

Numerous U.S. Patents describe methods and compositions for producing dendrimers. Examples of some of these patents are given below in order to provide a description of some dendrimer compositions that may be useful in the present invention, however it should be understood that these are merely illustrative examples and numerous other similar dendrimer compositions could be used in the present invention.

U.S. Pat. No. 4,507,466, U.S. Pat. No. 4,558,120, U.S. Pat. No. 4,568,737, and U.S. Pat. No. 4,587,329 each describe methods of making dense star polymers with terminal densities greater than conventional star polymers. These polymers have greater/more uniform reactivity than conventional star polymers, i.e. 3rd generation dense star polymers. These patents further describe the nature of the amidoamine dendrimers and the 3-dimensional molecular diameter of the dendrimers.

U.S. Pat. No. 4,631,337 describes hydrolytically stable polymers. U.S. Pat. No. 4,694,064 describes rod-shaped dendrimers. U.S. Pat. No. 4,713,975 describes dense star polymers and their use to characterize surfaces of viruses, bacteria and proteins including enzymes. Bridged dense star polymers are described in U.S. Pat. No. 4,737,550. U.S. Pat. No. 4,857,599 and U.S. Pat. No. 4,871,779 describe dense star polymers on immobilized cores useful as ion-exchange resins, chelation resins and methods of making such polymers.

U.S. Pat. No. 5,338,532 is directed to starburst conjugates of dendrimer(s) in association with at least one unit of carried agricultural, pharmaceutical or other material. This patent describes the use of dendrimers to provide means of delivery of high concentrations of carried materials per unit polymer, controlled delivery, targeted delivery and/or multiple species such as e.g., drugs antibiotics, general and specific toxins, metal ions, radionuclides, signal generators, antibodies, interleukins, hormones, interferons, viruses, viral fragments, pesticides, and antimicrobials.

U.S. Pat. No. 6,471,968 describes a dendrimer complex comprising covalently linked first and second dendrimers, with the first dendrimer comprising a first agent and the second dendrimer comprising a second agent, wherein the first dendrimer is different from the second dendrimer, and where the first agent is different than the second agent.

Other useful dendrimer type compositions are described in U.S. Pat. No. 5,387,617, U.S. Pat. No. 5,393,797, and U.S. Pat. No. 5,393,795 in which dense star polymers are modified by capping with a hydrophobic group capable of providing a hydrophobic outer shell. U.S. Pat. No. 5,527,524 discloses the use of amino terminated dendrimers in antibody conjugates.

PAMAM dendrimers are highly branched, narrowly dispersed synthetic macromolecules with well-defined chemical structures. PAMAM dendrimers can be easily modified and conjugated with multiple functionalities such as targeting molecules, imaging agents, and drugs (Thomas et al. (2007) Poly(amidoamine) Dendrimer-based Multifunctional Nanoparticles, in Nanobiotechnology: Concepts, Methods and Perspectives, Merkin, Ed., Wiley-VCH; herein incorporated by reference in its entirety). They are water soluble, biocompatible, and cleared from the blood through the kidneys (Peer et al. (2007) Nat. Nanotechnol. 2:751-760; herein incorporated by reference in its entirety) which eliminates the need for biodegradability. Because of these desirable properties, PAMAM dendrimers have been widely investigated for drug delivery (Esfand et al. (2001) Drug Discov. Today 6:427-436; Patri et al. (2002) Curr. Opin. Chem. Biol. 6:466-471; Kukowska-Latallo et al. (2005) Cancer Res. 65:5317-5324; Quintana et al. (2002) Pharmaceutical Res. 19:1310-1316; Thomas et al. (2005) J. Med. Chem. 48:3729-3735; each herein incorporated by reference in its entirety), gene therapy (KukowskaLatallo et al. (1996) PNAS 93:4897-4902; Eichman et al. (2000) Pharm. Sci. Technolo. Today 3:232-245; Luo et al. (2002) Macromol. 35:3456-3462; each herein incorporated by reference in its entirety), and imaging applications (Kobayashi et al. (2003) Bioconj. Chem. 14:388-394; herein incorporated by reference in its entirety).

The use of dendrimers as metal ion carriers is described in U.S. Pat. No. 5,560,929. U.S. Pat. No. 5,773,527 discloses non-crosslinked polybranched polymers having a comb-burst configuration and methods of making the same. U.S. Pat. No. 5,631,329 describes a process to produce polybranched polymer of high molecular weight by forming a first set of branched polymers protected from branching; grafting to a core; deprotecting first set branched polymer, then forming a second set of branched polymers protected from branching and grafting to the core having the first set of branched polymers, etc.

U.S. Pat. No. 5,902,863 describes dendrimer networks containing lipophilic organosilicone and hydrophilic polyanicloamine nanscopic domains. The networks are prepared from copolydendrimer precursors having PAMAM (hydrophilic) or polyproyleneimine interiors and organosilicon outer layers. These dendrimers have a controllable size, shape and spatial distribution. They are hydrophobic dendrimers with an organosilicon outer layer that can be used for specialty membrane, protective coating, composites containing organic organometallic or inorganic additives, skin patch delivery, absorbants, chromatography personal care products and agricultural products.

U.S. Pat. No. 5,795,582 describes the use of dendrimers as adjuvants for influenza antigen. Use of the dendrimers produces antibody titer levels with reduced antigen dose. U.S. Pat. No. 5,898,005 and U.S. Pat. No. 5,861,319 describe specific immunobinding assays for determining concentration of an analyte. U.S. Pat. No. 5,661,025 provides details of a self-assembling polynucleotide delivery system comprising dendrimer polycation to aid in delivery of nucleotides to target site. This patent provides methods of introducing a polynucleotide into a eukaryotic cell in vitro comprising contacting the cell with a composition comprising a polynucleotide and a dendrimer polycation non-covalently coupled to the polynucleotide.

Dendrimer-antibody conjugates for use in in vitro diagnostic applications have previously been demonstrated (See, e.g., Singh et al., Clin. Chem., 40:1845 (1994)), for the production of dendrimer-chelant-antibody constructs, and for the development of boronated dendrimer-antibody conjugates (for neutron capture therapy); each of these latter compounds may be used as a cancer therapeutic (See, e.g., Wu et al., Bioorg. Med. Chem. Lett., 4:449 (1994); Wiener et al., Magn. Reson. Med. 31:1 (1994); Barth et al., Bioconjugate Chem. 5:58 (1994); and Barth et al.).

Some of these conjugates have also been employed in the magnetic resonance imaging of tumors (See, e.g., Wu et al., (1994) and Wiener et al., (1994), supra). Results from this work have documented that, when administered in vivo, antibodies can direct dendrimer-associated therapeutic agents to antigen-bearing tumors. Dendrimers also have been shown to specifically enter cells and carry either chemotherapeutic agents or genetic therapeutics. In particular, studies show that cisplatin encapsulated in dendrimer polymers has increased efficacy and is less toxic than cisplatin delivered by other means (See, e.g., Duncan and Malik, Control Rel. Bioact. Mater. 23:105 (1996)).

Dendrimers have also been conjugated to fluorochromes or molecular beacons and shown to enter cells. They can then be detected within the cell in a manner compatible with sensing apparatus for evaluation of physiologic changes within cells (See, e.g., Baker et al., Anal. Chem. 69:990 (1997)). Finally, dendrimers have been constructed as differentiated block copolymers where the outer portions of the molecule may be digested with either enzyme or light-induced catalysis (See, e.g., Urdea and Hom, Science 261:534 (1993)). This allows the controlled degradation of the polymer to release therapeutics at the disease site and provides a mechanism for an external trigger to release the therapeutic agents.

The present invention is not limited to particular method for conjugating dendrimers with functional agents (see, e.g., U.S. Pat. Nos. 6,471,968, 7,078,461, and U.S. Patent application Ser. Nos. 09/940,243, 10/431,682, 11,503,742, 11,661,465, 11/523,509, 12/403,179, 12/106,876, 11/827,637, U.S. Provisional Patent Application Ser. Nos. 61/140,840, 61/091,608, 61/097,780, 61/101,461; each herein incorporated by reference in their entireties).

In some embodiments, conjugation between a dendrimer (e.g., a terminal arm of a dendrimer) and a functional ligand is accomplished during a “one-pot” reaction. The term “one-pot synthesis reaction” or equivalents thereof, e.g., “1-pot”, “one pot”, etc., refers to a chemical synthesis method in which all reactants are present in a single vessel. Reactants may be added simultaneously or sequentially, with no limitation as to the duration of time elapsing between introduction of sequentially added reactants. In some embodiments, a one-pot reaction occurs wherein a hydroxyl-terminated dendrimer (e.g., HO-PAMAM dendrimer) is reacted with one or more functional ligands (e.g., a therapeutic agent, a pro-drug, a trigger agent, a targeting agent, an imaging agent) in one vessel, such conjugation being facilitated by ester coupling agents (e.g., 2-chloro-1-methylpyridinium iodide and 4-(dimethylamino) pyridine) (see, e.g., U.S. Provisional Patent App. No. 61/226,993, herein incorporated by reference in its entirety).

The present invention is directed towards dendrimer composition embodiments with high structural uniformity. For example, in some embodiments, dendrimer compositions of the present invention comprise ten or more dendrimer molecules having one or more ligands (e.g., functional agents) wherein approximately 80% (e.g., 70-73%, 73-75%, 75-80%, 80-81%, 81-85%, 85-90%, 90-97%, 99.99% or higher) of the dendrimer molecules are structurally uniform. Such compositions described herein are novel in their structural uniformity. Dendrimer-based systems prepared and purified by traditional methods have been composed of a distribution of dendrimer species, each with a different number of conjugated functional groups. In experiments conducted during the development of some embodiments of the present invention, it has been found that 16 different dendrimer species compose a dendrimer conjugate with an average of 5 functional molecules. In some preferred embodiments of the present invention, dendrimer systems do not exist as a distribution and rather are composed of a dendrimer with an exact number of conjugated functional groups. There are very few macromolecule-based systems that have achieved this level of molecular control, and such novel, structurally uniform systems have significant utility that a distributed dendrimer system would not, such utility including but not limited to enhanced or more specific potency as a pure composition. The method and system embodiments of the present invention in which novel systems are generated also result in less sensitivity to the molecular weight and PDI inconsistencies that currently hinder the commercial supply of PAMAM dendrimers.

For example, the number of different dendrimer species within a multi-functional dendrimer system functionalized with an “average” of 5 methotrexate drug molecules and 5 folic acid targeting molecules is 256 (16×16). Because both methotrexate and folic acid can be conjugated via two different carboxylic acid groups separately as well as both carboxylic acid groups combined, there are 3 different versions of the conjugated functional groups. Two out of three of these coupling routes results in a reduction or complete loss of biological activity. Taking the three different versions of methotrexate and folic acid into account indicates that this particular dendrimer system is composed of 2304 (16×16×3×3) different dendrimer species. Experiments conducted during the course of developing some embodiments of the present invention demonstrate that, surprisingly, dendrimer systems of lower structural uniformity prepared by traditional methods (e.g., for which only average number of ligand attachments are known) have a broad structural distribution such that, in some cases, the majority of the sample has suboptimal ligand conjugation (e.g, no ligands present, undesirable ratios of different ligand types, etc.). In contrast, dendrimer systems described herein have only a single species present—i.e., the dendrimers have a known number of ligands attached and structural uniformity equal to or exceeding 80% (e.g., 70-73%, 73-75%, 75-80%, 80-81%, 81-85%, 85-90%, 90-97%, 99.99% or higher) throughout the sample (e.g., subpopulation, plurality of dendrimer systems). Therefore, compositions of the present invention having high levels of structural uniformity have unique properties in comparison to compositions of lower structural uniformity. Such properties include but are not limited to enhanced therapeutic potency, pharmacokinetics, and/or effectiveness for multivalent targeting.

The present invention is further directed towards methods for synthesis and preparation of such compositions. In some embodiments, methods of the present invention involve conjugation of at least one type of ligand to a dendrimer to yield a population of ligand-conjugated dendrimers, which are then subjected to reverse-phase HPLC to yield subpopulations of ligand-conjugated dendrimers. The chromatographic traces from elution of these subpopulations are analyzed, for example, using peak fitting analysis methods to identify subpopulation (e.g., subsamples, eluate fractions) wherein the structural uniformity of ligand conjugates within each subpopulation (e.g., subsample, eluate fraction) is 80% or higher (e.g., 70-73%, 73-75%, 75-80%, 80-81%, 81-85%, 85-90%, 90-97%, 99.99% or higher). Such methods are compatible with other analytical methods for structural determination or molecular analysis, such analytical methods including but not limited to nuclear magnetic resonance (NMR) (e.g., ¹H NMR), gel permeation chromatograph (GPC), mass spectrometry methods (MS) (e.g., MALDI-TOF-MS), and potentiometric titration.

Peak fitting analysis and distribution analysis are also compatible with mathematical modeling methods. Such mathematical modeling methods may include application of a two path kinetic model which allows for deviations from the Poisson distribution by varying the activation energy of the reaction a a function of n ligands on the dendrimer, e.g.,

Rₙ=A₁e^{-E}^{ₐ₁}^{/(RT)}+nA₂e^{-E}^{ₐ₂}^{/(RT)} (equation 1)

(see, e.g., Example 2)
In some embodiments, skewed-Poisson, Poisson, or Gaussian distribution models may be utilized to analyze dendrimer distributions (see, e.g., Examples 2 and 3).

The present invention is also directed towards products synthesized and/or prepared using methods of the present invention, e.g., by conjugation of at least one type of ligand to a dendrimer to yield a population of ligand-conjugated dendrimers, which are then subjected to reverse-phase HPLC to yield subpopulations of ligand-conjugated dendrimers; and analyzing the chromatographic traces from elution of these subpopulations using peak fitting analysis methods to identify subpopulation (e.g., subsamples, eluate fractions) wherein the structural uniformity of ligand conjugates within each subpopulation (e.g., subsample, eluate fraction) is 80% or higher (e.g., 70-73%, 73-75%, 75-80%, 80-81%, 81-85%, 85-90%, 90-97%, 99.99% or higher).

In some embodiments of the present invention, the preparation of PAMAM dendrimers is performed according to a typical divergent (building up the macromolecule from an initiator core) synthesis. It involves, for example, a two-step growth sequence that includes a Michael addition of amino groups to the double bond of methyl acrylate (MA) followed by the amidation of the resulting terminal carbomethoxy, —(CO₂ CH₃) group, with ethylenediamine (EDA).

In the first step of this process, ammonia is allowed to react under an inert nitrogen atmosphere with MA (molar ratio: 1:4.25) at 47° C. for 48 hours. The resulting compound is referred to as generation=0, the star-branched PAMAM tri-ester. The next step involves reacting the tri-ester with an excess of EDA to produce the star-branched PAMAM tri-amine (G=O). This reaction is performed under an inert atmosphere (nitrogen) in methanol and requires 48 hours at 0° C. for completion. Reiteration of this Michael addition and amidation sequence produces generation=1.

Preparation of this tri-amine completes the first full cycle of the divergent synthesis of PAMAM dendrimers. Repetition of this reaction sequence results in the synthesis of larger generation (G=1-5) dendrimers (i.e., ester- and amine-terminated molecules, respectively). For example, the second iteration of this sequence produces generation 1, with an hexa-ester and hexa-amine surface, respectively. The same reactions are performed in the same way as for all subsequent generations from 1 to 9, building up layers of branch cells giving a core-shell architecture with precise molecular weights and numbers of terminal groups as shown above. Carboxylate-surfaced dendrimers can be produced by hydrolysis of ester-terminated PAMAM dendrimers, or reaction of succinic anhydride with amine-surfaced dendrimers (e.g., full generation PAMAM, POPAM or POPAM-PAMAM hybrid dendrimers).

Various dendrimers can be synthesized based on the core structure that initiates the polymerization process. These core structures dictate several important characteristics of the dendrimer molecule such as the overall shape, density, and surface functionality (See, e.g., Tomalia et al., Angew. Chem. Int. Ed. Engl., 29:5305 (1990)). Spherical dendrimers derived from ammonia possess trivalent initiator cores, whereas EDA is a tetra-valent initiator core. In some embodiments, rod-shaped dendrimers are used (See, e.g., Yin et al., J. Am. Chem. Soc., 120:2678 (1998)).

In some embodiments, dendrimers of the present invention comprise a protected core diamine. In some embodiments, the protected initiator core diamine is NH2-(CH2)ₙ—NHPG, (n=1-10). In other embodiments, the initiator core is selected from the group comprising, but not limited to, NH₂—(CH₂)ₙ—NH₂ (n=1-10), NH₂—((CH₂)ₙNH₂)₃ (n=1-10), or unsubstituted or substituted 1,2-; 1,3-; or 1,4-phenylenedi-n-alkylamine, with a monoprotected diamine (e.g., NH₂—(CH₂)ₙ—NHPG) used during the amide formation of each generation. In these approaches, the protected diamine allows for the large scale production of dendrimers without the production of non-uniform nanostructures that hinders characterization and analysis. By limiting the reactivity of the diamine to only one terminus, for example, the opportunities of dimer/polymer formation and intramolecular reactions are obviated without the need of employing large excesses of diamine. The terminus monoprotected intermediates can be readily purified as the protecting groups provide suitable handle for productive purifications by classical techniques (e.g., crystallization and/or chromatography).

The protected intermediates can be deprotected in a deprotection step, and the resulting generation of the dendrimer subjected to an iterative chemical reaction without the need for purification. The invention is not limited to a particular protecting group. Indeed a variety of protecting groups are contemplated including, but not limited to, t-butoxycarbamate (N-t-Boc), allyloxycarbamate (N-Alloc), benzylcarbamate (N-Cbz), 9-fluorenylmethylcarbamate (FMOC), or phthalimide (Phth). In preferred embodiments of the present invention, the protecting group is benzylcarbamate (N-Cbz). N-Cbz is ideal for the present invention since it alone can be easily cleaved under “neutral” conditions by catalytic hydrogenation (Pd/C) without resorting to strongly acidic or basic conditions needed to remove an F-MOC group. The use of protected monomers finds particular use in high through-put production runs because a lower amount of monomer can be used, reducing production costs.

The dendrimers may be characterized for size and uniformity by any suitable analytical techniques. These include, but are not limited to, atomic force microscopy (AFM), electrospray-ionization mass spectroscopy, MALDI-TOF mass spectroscopy, ¹³C nuclear magnetic resonance spectroscopy, high performance liquid chromatography (HPLC) size exclusion chromatography (SEC) (equipped with multi-angle laser light scattering, dual UV and refractive index detectors), gel permeation chromatography (GPC), capillary electrophoresis and get electrophoresis. These analytical methods assure the uniformity of the dendrimer population and are important in the quality control of dendrimer production for eventual use, for example, in in vivo applications. Moreover, studies with dendrimers have shown no evidence of toxicity when administered intravenously (Roberts et al., J. Biomed. Mater. Res., 30:53 (1996) and Boume et al., J. Magnetic Resonance Imaging, 6:305 (1996)).

A wide range of therapeutic agents find use with the present invention. In some embodiments, the therapeutic agents are effective in treating autoimmune disorders and/or inflammatory disorders (e.g., arthritis). Examples of such therapeutic agents include, but are not limited to, disease-modifying antirheumatic drugs (e.g., leflunomide, methotrexate, sulfasalazine, hydroxychloroquine), biologic agents (e.g., rituximab, infliximab, etanercept, adalimumab, golimumab), nonsteroidal anti-inflammatory drugs (e.g., ibuprofen, celecoxib, ketoprofen, naproxen, piroxicam, diclofenac), analgesics (e.g., acetaminophen, tramadol), immunomodulators (e.g., anakinra, abatacept), and glucocorticoids (e.g., prednisone, methylprednisone), TNF-α inhibitors (e.g., adalimumab, certolizumab pegol, etanercept, golimumab, infliximab), IL-1 inhibitors, and metalloprotease inhibitors. In some embodiments, the therapeutic agents include, but are not limited to, infliximab, adalimumab, etanercept, parenteral gold or oral gold.

In some embodiments, the therapeutic agent is an agent configured for treating rheumatoid arthritis. Examples of agents configured for treating rheumatoid arthritis include, but are not limited to, disease-modifying antirheumatic drugs (e.g., leflunomide, methotrexate, sulfasalazine, hydroxychloroquine), biologic agents (e.g., rituximab, infliximab, etanercept, adalimumab, golimumab), nonsteroidal anti-inflammatory drugs (e.g., ibuprofen, celecoxib, ketoprofen, naproxen, piroxicam, diclofenac), analgesics (e.g., acetaminophen, tramadol), immunomodulators (e.g., anakinra, abatacept), and glucocorticoids (e.g., prednisone, methylprednisone).

In some embodiments, the therapeutic agent is a pain relief agent. Examples of pain relief agents include, but are not limited to, analgesic drugs and respective antagonists. Examples of analgesic drugs include, but are not limited to, paracetamol and Non-steroidal anti-inflammatory drugs (NSAIDs), COX-2 inhibitors, opiates and morphonimimetics, and specific analgesic agents.

In some embodiments, the therapeutic agent includes, but is not limited to, a chemotherapeutic agent, an anti-oncogenic agent, an anti-angiogenic agent, a tumor suppressor agent, and/or an anti-microbial agent, although the present invention is not limited by the nature of the therapeutic agent.

In some embodiments, the chemotherapeutic agent is selected from a group consisting of, but not limited to, platinum complex, verapamil, podophylltoxin, carboplatin, procarbazine, mechloroethamine, cyclophosphamide, camptothecin, ifosfamide, melphalan, chlorambucil, bisulfan, nitrosurea, adriamycin, dactinomycin, daunorubicin, doxorubicin, bleomycin, plicomycin, mitomycin, bleomycin, etoposide, tamoxifen, paclitaxel, taxol, transplatinum, 5-fluorouracil, vincristin, vinblastin, bisphosphonate (e.g., CB3717), chemotherapeutic agents with high affinity for folic acid receptors, ALIMTA (Eli Lilly), and methotrexate.

Examples of anti-angiogenic agents include, but not limited to, Batimastat, Marimastat, AG3340, Neovastat, PEX, TIMP-1, -2, -3, -4, PAI-1, -2, uPA Ab, uPAR Ab, Amiloride, Minocycline, tetracyclines, steroids, cartilage-derived TIMP, αvβ3 Ab:LM609 and Vitaxin, RGD containing peptides, αvβ5 Ab, Endostatin, Angiostatin, aaAT, IFN-α, IFN-γ, IL-12, nitric oxide synthase inhibitors, TSP-1, TNP-470, Combretastatin A4, Thalidomide, Linomide, IFN-α, PF-4, prolactin fragment, Suramin and analogues, PPS, distamycin A analogues, FGF-2 Ab, antisense-FGF-2, Protamine, SU5416, soluble Flt-1, dominant-negative Flk-1, VEGF receptor ribosymes, VEGF Ab, Aspirin, NS-398, 6-AT, 6A5BU, 7-DX, Genistein, Lavendustin A, Ang-2, batimastat, marimastat, anti-αvβ3 monoclonal antibody (LM609) thrombospondin-1 (TSP-1) Angiostatin, endostatin, TNP-470, Combretastatin A-4, Anti-VEGF antibodies, soluble Flk-1, Flt-1 receptors, inhibitors of tyrosine kinase receptors, SU5416, heparin-binding growth factors, pentosan polysulfate, platelet-derived endothelial cell growth factor/Thymidine phosphorylase (PD-ECGF/TP), cox (e.g., cox-1 an cox-2) inhibitors (e.g., Celebrex and Vioxx), DT385, Tissue inhibitor of metalloprotease (TIMP-1, TIMP-2), Zinc, Plasminogen activator-inhibitor-1 (PAI-1), p53 Rb, Interleukin-10 Interleukin-12, Angiopoietin-2, Angiotensin, Angiotensin II (AT2 receptor), Caveolin-1, caveolin-2, Angiopoietin-2, Angiotensin, Angiotensin II (AT2 receptor), Caveolin-1, caveolin-2, Endostatin, Interferon-alpha, Isoflavones, Platelet factor-4, Prolactin (16 Kd fragment), Thrombospondin, Troponin-1, Bay 12-9566, AG3340, CGS 27023A, CGS 27023A, COL-3, (Neovastat), BMS-275291, Penicillamine, TNP-470 (fumagillin derivative), Squalamine, Combretastatin, Endostatin, Penicillamine, Farnesyl Transferase Inhibitor (FTI), -L-778,123, -SCH66336, -R115777, anti-VEGF antibody, Thalidomide, SU5416, Ribozyme, Angiozyme, SU6668, PTK787/ZK22584, Interferon-alpha, Interferon-alpha, Suramin, Vitaxin, EMD121974, Penicillamine, Tetrathiomolybdate, Captopril, serine protease inhibitors, CAI, ABT-627, CM101/ZD0101, Interleukin-12, IM862, PNU-145156E, those described in U.S. Patent App. No. 20050123605, herein incorporated by reference in its entirety, and fragments or portions of the above that retain anti-angiogenic (e.g., angiostatic or inhibitory properties).

In some embodiments of the present invention, a dendrimer conjugate comprises one or more agents that directly cross-link nucleic acids (e.g., DNA) to facilitate DNA damage leading to, for example, synergistic, antineoplastic agents of the present invention. Agents such as cisplatin, and other DNA alkylating agents may be used. Cisplatin has been widely used to treat cancer, with efficacious doses used in clinical applications of 20 mg/M² for 5 days every three weeks for a total of three courses. The dendrimers may be delivered via any suitable method, including, but not limited to, injection intravenously, subcutaneously, intratumorally, intraperitoneally, or topically (e.g., to mucosal surfaces).

Agents that damage DNA also include compounds that interfere with DNA replication, mitosis and chromosomal segregation. Such chemotherapeutic compounds include adriamycin, also known as doxorubicin, etoposide, verapamil, podophyllotoxin, and the like. Widely used in a clinical setting for the treatment of neoplasms, these compounds are administered through bolus injections intravenously at doses ranging from 25-75 Mg/M² at 21 day intervals for adriamycin, to 35-50 Mg/M² for etoposide intravenously or double the intravenous dose orally.

Agents that disrupt the synthesis and fidelity of nucleic acid precursors and subunits also lead to DNA damage and find use as chemotherapeutic agents in the present invention. A number of nucleic acid precursors have been developed. Particularly useful are agents that have undergone extensive testing and are readily available. As such, agents such as 5-fluorouracil (5-FU) are preferentially used by neoplastic tissue, making this agent particularly useful for targeting to neoplastic cells. The doses delivered may range from 3 to 15 mg/kg/day, although other doses may vary considerably according to various factors including stage of disease, amenability of the cells to the therapy, amount of resistance to the agents and the like.

Photodynamic therapeutic agents may also be used as therapeutic agents in the present invention. In some embodiments, the dendrimer conjugates of the present invention containing photodynamic compounds are illuminated, resulting in the production of singlet oxygen and free radicals that diffuse out of the fiberless radiative effector to act on the biological target (e.g., tumor cells or bacterial cells).

Other photodynamic compounds useful in the present invention include those that cause cytotoxity by a different mechanism than singlet oxygen production (e.g., copper benzochlorin, Selman, et al., Photochem. Photobiol., 57:681-85 (1993), incorporated herein by reference). Examples of photodynamic compounds that find use in the present invention include, but are not limited to Photofrin 2, phtalocyanins (See e.g., Brasseur et al., Photochem. Photobiol., 47:705-11 (1988)), benzoporphyrin, tetrahydroxyphenylporphyrins, naphtalocyanines (See e.g., Firey and Rodgers, Photochem. Photobiol., 45:535-38 (1987)), sapphyrins (See, e.g., Sessler et al., Proc. SPIE, 1426:318-29 (1991)), porphinones (See, e.g., Chang et al., Proc. SPIE, 1203:281-86 (1990)), tin etiopurpurin, ether substituted porphyrins (See, e.g., Pandey et al., Photochem. Photobiol., 53:65-72 (1991)), and cationic dyes such as the phenoxazines (See e.g., Cincotta et al., SPIE Proc., 1203:202-10 (1990)).

In some embodiments, the therapeutic complexes of the present invention comprise a photodynamic compound and a targeting agent that is administred to a patient. In some embodiments, the targeting agent is then allowed a period of time to bind the “target” cell (e.g. about 1 minute to 24 hours) resulting in the formation of a target cell-target agent complex. In some embodiments, the therapeutic complexes comprising the targeting agent and photodynamic compound are then illuminated (e.g., with a red laser, incandescent lamp, X-rays, or filtered sunlight). In some embodiments, the light is aimed at the jugular vein or some other superficial blood or lymphatic vessel. In some embodiments, the singlet oxygen and free radicals diffuse from the photodynamic compound to the target cell (e.g. cancer cell or pathogen) causing its destruction.

In some embodiments, the therapeutic agent is conjugated to a trigger agent. The present invention is not limited to particular types or kinds of trigger agents.

In some embodiments, sustained release (e.g., slow release over a period of 24-48 hours) of the therapeutic agent is accomplished through conjugating the therapeutic agent (e.g., directly) (e.g., indirectly through one or more additional functional groups) to a trigger agent that slowly degrades in a biological system (e.g., amide linkage, ester linkage, ether linkage). In some embodiments, constitutively active release of the therapeutic agent is accomplished through conjugating the therapeutic agent to a trigger agent that renders the therapeutic agent constitutively active in a biological system (e.g., amide linkage, ether linkage).

In some embodiments, release of the therapeutic agent under specific conditions is accomplished through conjugating the therapeutic agent (e.g., directly) (e.g., indirectly through one or more additional functional groups) to a trigger agent that degrades under such specific conditions (e.g., through activation of a trigger molecule under specific conditions that leads to release of the therapeutic agent). For example, once a conjugate (e.g., a therapeutic agent conjugated with a trigger agent and a targeting agent) arrives at a target site in a subject (e.g., a tumor, or a site of inflammation), components in the target site (e.g., a tumor associated factor, or an inflammatory or pain associated factor) interact with the trigger agent thereby initiating cleavage of the therapeutic agent from the trigger agent. In some embodiments, the trigger agent is configured to degrade (e.g., release the therapeutic agent) upon exposure to a tumor-associated factor (e.g., hypoxia and pH, an enzyme (e.g., glucuronidase and/or plasmin), a cathepsin, a matrix metalloproteinase, a hormone receptor (e.g., integrin receptor, hyaluronic acid receptor, luteinizing hormone-releasing hormone receptor, etc.), cancer and/or tumor specific DNA sequence), an inflammatory associated factor (e.g., chemokine, cytokine, etc.) or other moiety.

In some embodiments, the present invention provides a therapeutic agent conjugated with a trigger agent that is sensitive to (e.g., is cleaved by) hypoxia (e.g., indolequinone). Hypoxia is a feature of several disease states, including cancer, inflammation and rheumatoid arthritis, as well as an indicator of respiratory depression (e.g., resulting from analgesic drugs).

Advances in the chemistry of bioreductive drug activation have led to the design of various hypoxia-selective drug delivery systems in which the pharmacophores of drugs are masked by reductively cleaved groups. In some embodiments, the trigger agent is utilizes a quinone, N-oxide and/or (hetero)aromatic nitro groups. For example, a quinone present in a conjugate is reduced to phenol under hypoxia conditions, with spontaneous formation of lactone that serves as a driving force for drug release. In some embodiments, a heteroaromatic nitro compound present in a conjugate (e.g., a therapeutic agent conjugated (e.g., directly or indirectly) with a trigger agent) is reduced to either an amine or a hydroxylamine, thereby triggering the spontaneous release of a therapeutic agent. In some embodiments, the trigger agent degrades upon detection of reduced pO₂ concentrations (e.g., through use of a redox linker).

The concept of pro-drug systems in which the pharmacophores of drugs are masked by reductively cleavable groups has been widely explored by many research groups and pharmaceutical companies (see, e.g., Beall, H. D., et al., Journal of Medicinal Chemistry, 1998. 41(24): p. 4755-4766; Ferrer, S., D. P. Naughton, and M. D. Threadgill, Tetrahedron, 2003. 59(19): p. 3445-3454; Naylor, M. A., et al., Journal of Medicinal Chemistry, 1997.

40(15): p. 2335-2346; Phillips, R. M., et al., Journal of Medicinal Chemistry, 1999. 42(20): p. 4071-4080; Zhang, Z., et al., Organic & Biomolecular Chemistry, 2005. 3(10): p. 1905-1910; each of which are herein incorporated by reference in their entireties). Several such hypoxia activated pro-drugs have been advanced to clinical investigations, and work in relevant oxygen concentrations to prevent cerebral damage. The present invention is not limited to particular hypoxia-activated trigger agents. In some embodiments, the hypoxia-activated trigger agents include, but are not limited to, indolequinones, nitroimidazoles, and nitroheterocycles (see, e.g., Damen, E. W. P., et al., Bioorganic & Medicinal Chemistry, 2002. 10(1): p. 71-77; Hay, M. P., et al., Journal of Medicinal Chemistry, 2003. 46(25): p. 5533-5545; Hay, M. P., et al., Journal of the Chemical Society-Perkin Transactions 1, 1999(19): p. 2759-2770; each herein incorporated by reference in their entireties).

In some embodiments, the trigger agent is sensitive to (e.g., is cleaved by) and/or associates with a tumor-associated enzyme. For example, in some embodiments, the trigger agent that is sensitive to (e.g., is cleaved by) and/or associates with a glucuronidase. Glucuronic acid can be attached to several anticancer drugs via various linkers. These anticancer drugs include, but are not limited to, doxorubicin, paclitaxel, docetaxel, 5-fluorouracil, 9-aminocamtothecin, as well as other drugs under development. These pro-drugs are generally stable at physiological pH and are significantly less toxic than the parent drugs.

In some embodiments, the trigger agent is sensitive to (e.g., is cleaved by) and/or associates with brain enzymes. For example, trigger agents such as indolequinone are reduced by brain enzymes such as, for example, diaphorase (DT-diaphorase) (see, e.g., Damen, E. W. P., et al., Bioorganic & Medicinal Chemistry, 2002. 10(1): p. 71-77; herein incorporated by reference in its entirety). For example, in such embodiments, the antagonist is only active when released during hypoxia to prevent respiratory failure. In some embodiments, the trigger agent is sensitive to (e.g., is cleaved by) and/or associates with a protease. The present invention is not limited to any particular protease. In some embodiments, the protease is a cathepsin. In some embodiments, a trigger comprises a Lys-Phe-PABC moiety (e.g., that acts as a trigger). In some embodiments, a Lys-Phe-PABC moiety linked to doxorubicin, mitomycin C, and paclitaxel are utilized as a trigger-therapeutic conjugate in a conjugated dendrimer provided herein (e.g., that serve as substrates for lysosomal cathepsin B or other proteases expressed (e.g., overexpressed) in tumor cells). In some embodiments, utilization of a 1,6-elimination spacer/linker is utilized (e.g., to permit release of therapeutic drug post activation of trigger).

In some embodiments, the trigger agent is sensitive to (e.g., is cleaved by) and/or associates with plasmin. The serine protease plasmin is over expressed in many human tumor tissues. Tripeptide specifiers (e.g., including, but not limited to, Val-Leu-Lys) have been identified and linked to anticancer drugs through elimination or cyclization linkers.

In some embodiments, the trigger agent is sensitive to (e.g., is cleaved by) and/or associates with a matrix metalloprotease (MMP). In some embodiments, the trigger agent is sensitive to (e.g., is cleaved by) and/or that associates with β-Lactamase (e.g., a β-Lactamase activated cephalosporin-based pro-drug).

In some embodiments, the trigger agent is sensitive to (e.g., is cleaved by) and/or activated by a receptor (e.g., expressed on a target cell (e.g., a tumor cell)).

In some embodiments, the trigger agent that is sensitive to (e.g., is cleaved by) and/or activated by a nucleic acid. Nucleic acid triggered catalytic drug release can be utilized in the design of chemotherapeutic agents. Thus, in some embodiments, disease specific nucleic acid sequence is utilized as a drug releasing enzyme-like catalyst (e.g., via complex formation with a complimentary catalyst-bearing nucleic acid and/or analog). In some embodiments, the release of a therapeutic agent is facilitated by the therapeutic component being attached to a labile protecting group, such as, for example, cisplatin or methotrexate being attached to a photolabile protecting group that becomes released by laser light directed at cells emitting a color of fluorescence (e.g., in addition to and/or in place of target activated activation of a trigger component of a conjugated dendrimer of the present invention. In some embodiments, the therapeutic device also may have a component to monitor the response of the tumor to therapy. For example, where a therapeutic agent of the dendrimer induces apoptosis of a target cell (e.g., a cancer cell (e.g., a prostate cancer cell)), the caspase activity of the cells may be used to activate a green fluorescence. This allows apoptotic cells to turn orange, (combination of red and green) while residual cells remain red. Any normal cells that are induced to undergo apoptosis in collateral damage fluoresce green.

In some embodiments, dendrimer conjugates of the present invention contain one or more signature identifying agents that are activated by, or are able to interact with, a signature component (“signature”). In preferred embodiments, the signature identifying agent is an antibody, preferably a monoclonal antibody, that specifically binds the signature (e.g., cell surface molecule specific to a cell to be targeted).

In some embodiments of the present invention, tumor cells are identified. Tumor cells have a wide variety of signatures, including the defined expression of cancer-specific antigens such as Mucl, HER-2 and mutated p53 in breast cancer. These act as specific signatures for the cancer, being present in 30% (HER-2) to 70% (mutated p53) of breast cancers. In some embodiments, a dendrimer of the present invention comprises a monoclonal antibody that specifically binds to a mutated version of p53 that is present in breast cancer. In some embodiments, a dendrimer of the present invention comprises an antibody (e.g., monoclonal antibody) with high affinity for a signature including, but not limited to, Mucl and HER-2.

In some embodiments of the present invention, cancer cells expressing susceptibility genes are identified. For example, in some embodiments, there are two breast cancer susceptibility genes that are used as specific signatures for breast cancer: BRCA1 on chromosome 17 and BRCA2 on chromosome 13. When an individual carries a mutation in either BRCA1 or BRCA2, they are at an increased risk of being diagnosed with breast or ovarian cancer at some point in their lives. These genes participate in repairing radiation-induced breaks in double-stranded DNA. It is thought that mutations in BRCA1 or BRCA2 might disable this mechanism, leading to more errors in DNA replication and ultimately to cancerous growth.

In addition, a number of different expressed cell surface receptors find use as targets for the binding and uptake of a dendrimer conjugate. Such receptors include, but are not limited to, EGF receptor, folate receptor, FGR receptor 2, and the like.

FA has a high affinity for the folate receptor which is overexpressed in many epithelial cancer cells, including breast, ovary, endometrium, kidney, lung, head and neck, brain, and myeloid cancers (Weitman et al. (1992) Cancer Res. 52:6708-6711; Campbell et al. (1991) Cancer Res. 51:5329-5338; Weitman et al. (1992) Cancer Res. 73:2432-2443; Ross et al. (1994) Cancer 73:2432-2443; each herein incorporated by reference in its entirety), and is internalized into cells after ligand binding (Antony et al. (1985) J. Biol. Chem. 260:4911-4917; herein incorporated by reference in its entirety). Tumor-selective targeting has been achieved by FA-conjugated liposomes encapsulting an antineoplastic drug (Lee et al. (1995) Bioochem. Biophys. Acta-Biomembranes 1233:134-144; herein incorporated by reference in its entirety) or an antisense olignucleotides (Wang et al. (1995) PNAS 92:3318-3322; herein incorporated by reference in its entirety), FA-conjugated protein toxin (Leamon et al. (1994) J. Drug Targeting 2:101-112; herein incorporated by reference in its entirety), and FA-derivatized antibodies or their Fab/scFv fragments binding to the T-cell receptor (Rund et al. (1999) Intl. J. Cancer 83:141-149; herein incorporated by reference in its entirety). In vivo studies have shown that the administration of multivalent, folate-targeted dendrimer-methotrexate conjugates resulted in significantly lower toxicity and a ten-fold enhancement in efficacy compared to free methotrexate at an equal cumulative dose (Kukowska-Latallo et al. (2005) Cancer Res. 65:5317-5324; Hong et al. (2007) Chem. & Biol. 14:107-115; each herein incorporated by reference in its entirety.

In some embodiments of the present invention, changes in gene expression associated with chromosomal abborations are the signature component. For example, Burkitt lymphoma results from chromosome translocations that involve the Myc gene. A chromosome translocation means that a chromosome is broken, which allows it to associate with parts of other chromosomes. The classic chromosome translocation in Burkitt lymphoma involves chromosome 8, the site of the Myc gene. This changes the pattern of Myc expression, thereby disrupting its usual function in controlling cell growth and proliferation. In other embodiments, gene expression associated with colon cancer are identified as the signature component. Two key genes are known to be involved in colon cancer: MSH2 on chromosome 2 and MLH1 on chromosome 3. Normally, the protein products of these genes help to repair mistakes made in DNA replication. If the MSH2 and MLH1 proteins are mutated, the mistakes in replication remain unrepaired, leading to damaged DNA and colon cancer. MEN1 gene, involved in multiple endocrine neoplasia, has been known for several years to be found on chromosome 11, was more finely mapped in 1997, and serves as a signature for such cancers. In preferred embodiments of the present invention, an antibody specific for the altered protein or for the expressed gene to be detected is complexed with nanodevices of the present invention.

In yet another embodiment, adenocarcinoma of the colon has defined expression of CEA and mutated p53, both well-documented tumor signatures. The mutations of p53 in some of these cell lines are similar to that observed in some of the breast cancer cells and allows for the sharing of a p53 sensing component between the two nanodevices for each of these cancers (i.e., in assembling the nanodevice, dendrimers comprising the same signature identifying agent may be used for each cancer type). Both colon and breast cancer cells may be reliably studied using cell lines to produce tumors in nude mice, allowing for optimization and characterization in animals.

From the discussion above it is clear that there are many different tumor signatures that find use with the present invention, some of which are specific to a particular type of cancer and others which are promiscuous in their origin. The present invention is not limited to any particular tumor signature or any other disease-specific signature. For example, tumor suppressors that find use as signatures in the present invention include, but are not limited to, p53, Mucl, CEA, p16, p21, p2′7, CCAM, RB, APC, DCC, NF-1, NF-2, WT-1, MEN-1, MEN-II, p′73, VHL, FCC and MCC.

In some embodiments, dendrimer is conjugated (e.g., directly or indirectly) to a targeting agent. The present invention is not limited to any particular targeting agent. In some embodiments, targeting agents are conjugated to the therapeutic agents for delivery of the dendrimer to desired body regions (e.g., to the central nervous system (CNS); to a tissue region associated with an inflammatory disorder and/or an autoimmune disorder (e.g., arthritis)). The targeting agents are not limited to targeting specific body regions.

In some embodiments, the targeting agent is a moiety that has affinity for a tumor associated factor. For example, a number of targeting agents are contemplated to be useful in the present invention including, but not limited to, RGD sequences, low-density lipoprotein sequences, a NAALADase inhibitor, epidermal growth factor, and other agents that bind with specificity to a target cell (e.g., a cancer cell)).

The present invention is not limited to cancer and/or tumor targeting agents. Indeed, conjugated dendrimers of the present invention can be targeted (e.g., via a linker conjugated to the dendrimer wherein the linker comprises a targeting agent) to a variety of target cells or tissues (e.g., to a biologically relevant environment) via conjugation to an appropriate targeting agent. For example, in some embodiments, the targeting agent is a moiety that has affinity for an inflammatory factor (e.g., a cytokine or a cytokine receptor moiety (e.g., TNF-α receptor)). In some embodiments, the targeting agent is a sugar, peptide, antibody or antibody fragment, hormone, hormone receptor, or the like.

In some embodiments of the present invention, the targeting agent includes but is not limited to an antibody, receptor ligand, hormone, vitamin, and antigen; however, the present invention is not limited by the nature of the targeting agent. In some embodiments, the antibody is specific for a disease-specific antigen. In some embodiments, the disease-specific antigen comprises a tumor-specific antigen. In some embodiments, the receptor ligand includes, but is not limited to, a ligand for CFTR, EGFR, estrogen receptor, FGR2, folate receptor, IL-2 receptor, glycoprotein, and VEGFR. In some embodiments, the receptor ligand is folic acid.

In some embodiments of the present invention, targeting groups are conjugated to dendrimers and/or linkers conjugated to the dendrimers with either short (e.g., direct coupling), medium (e.g. using small-molecule bifunctional linkers such as SPDP, sold by PIERCE CHEMICAL Company), or long (e.g., PEG bifunctional linkers, sold by NEKTAR, Inc.) linkages. Since dendrimers have surfaces with a large number of functional groups, more than one targeting group and/or linker may be attached to each dendrimer. As a result, multiple binding events may occur between the dendrimer conjugate and the target cell. In these embodiments, the dendrimer conjugates have a very high affinity for their target cells via this “cooperative binding” or polyvalent interaction effect. In preferred embodiments, at least two different ligand types are attached to the dendrimer, with or without linkers. In particularly preferred embodiments, the two different ligands are attached to the dendrimer through ester bonds.

For steric reasons, in some embodiments, the smaller the ligands, the more can be attached to the surface of a dendrimer and/or linkers attached thereto. Recently, Wiener reported that dendrimers with attached folic acid would specifically accumulate on the surface and within tumor cells expressing the high-affinity folate receptor (hFR) (See, e.g., Wiener et al., Invest. Radiol., 32:748 (1997)). The hFR receptor is expressed or upregulated on epithelial tumors, including breast cancers. Control cells lacking hFR showed no significant accumulation of folate-derivatized dendrimers. Folic acid can be attached to full generation PAMAM dendrimers via a carbodiimide coupling reaction. Folic acid is a good targeting candidate for the dendrimers, with its small size and a simple conjugation procedure.

Antibodies can be generated to allow for the targeting of antigens or immunogens (e.g., tumor, tissue or pathogen specific antigens) on various biological targets (e.g., pathogens, tumor cells, normal tissue). Such antibodies include but are not limited to polyclonal, monoclonal, chimeric, single chain, Fab fragments, and an Fab expression library.

In some embodiments, the targeting agent is an antibody. In some embodiments, the antibodies recognize, for example, tumor-specific epitopes (e.g., TAG-72 (See, e.g., Kjeldsen et al., Cancer Res. 48:2214-2220 (1988); U.S. Pat. Nos. 5,892,020; 5,892,019; and 5,512,443; each herein incorporated by reference in their entireties); human carcinoma antigen (See, e.g., U.S. Pat. Nos. 5,693,763; 5,545,530; and 5,808,005; each herein incorporated by reference in their entireties); TP1 and TP3 antigens from osteocarcinoma cells (See, e.g., U.S. Pat. No. 5,855,866; herein incorporated by reference in its entirety); Thomsen-Friedenreich (TF) antigen from adenocarcinoma cells (See, e.g., U.S. Pat. No. 5,110,911; herein incorporated by reference in its entirety); “KC-4 antigen” from human prostrate adenocarcinoma (See, e.g., U.S. Pat. Nos. 4,708,930 and 4,743,543; each herein incorporated by reference in their entireties); a human colorectal cancer antigen (See, e.g., U.S. Pat. No. 4,921,789; herein incorporated by reference in its entirety); CA125 antigen from cystadenocarcinoma (See, e.g., U.S. Pat. No. 4,921,790; herein incorporated by reference in its entirety); DF3 antigen from human breast carcinoma (See, e.g., U.S. Pat. Nos. 4,963,484 and 5,053,489; each herein incorporated by reference in their entireties); a human breast tumor antigen (See, e.g., U.S. Pat. No. 4,939,240: herein incorporated by reference in its entirety); p97 antigen of human melanoma (See, e.g., U.S. Pat. No. 4,918,164: herein incorporated by reference in its entirety); carcinoma or orosomucoid-related antigen (CORA) (See, e.g., U.S. Pat. No. 4,914,021; herein incorporated by reference in its entirety); a human pulmonary carcinoma antigen that reacts with human squamous cell lung carcinoma but not with human small cell lung carcinoma (See, e.g., U.S. Pat. No. 4,892,935; herein incorporated by reference in its entirety); T and Tn haptens in glycoproteins of human breast carcinoma (See, e.g., Springer et al., Carbohydr. Res. 178:271-292 (1988); herein incorporated by reference in its entirety), MSA breast carcinoma glycoprotein termed (See, e.g., Tjandra et al., Br. J. Surg. 75:811-817 (1988); herein incorporated by reference in its entirety); MFGM breast carcinoma antigen (See, e.g., Ishida et al., Tumor Biol. 10:12-22 (1989); herein incorporated by reference in its entirety); DU-PAN-2 pancreatic carcinoma antigen (See, e.g., Lan et al., Cancer Res. 45:305-310 (1985); herein incorporated by reference in its entirety); CA125 ovarian carcinoma antigen (See, e.g., Hanisch et al., Carbohydr. Res. 178:29-47 (1988); herein incorporated by reference in its entirety); YH206 lung carcinoma antigen (See, e.g., Hinoda et al., (1988) Cancer J. 42:653-658 (1988); herein incorporated by reference in its entirety).

Various procedures known in the art are used for the production of polyclonal antibodies. For the production of antibody, various host animals can be immunized by injection with the peptide corresponding to the desired epitope including but not limited to rabbits, mice, rats, sheep, goats, etc. In a preferred embodiment, the peptide is conjugated to an immunogenic carrier (e.g., diphtheria toxoid, bovine serum albumin (BSA), or keyhole limpet hemocyanin (KLH)). Various adjuvants are used to increase the immunological response, depending on the host species, including but not limited to Freund's (complete and incomplete), mineral gels such as aluminum hydroxide, surface active substances such as lysolecithin, pluronic polyols, polyanions, peptides, oil emulsions, keyhole limpet hemocyanins, dinitrophenol, and potentially useful human adjuvants such as BCG (Bacille Calmette-Guerin) and Corynebacterium parvum.

For preparation of monoclonal antibodies, any technique that provides for the production of antibody molecules by continuous cell lines in culture may be used (See e.g., Harlow and Lane, Antibodies: A Laboratory Manual, Cold Spring Harbor Laboratory Press, Cold Spring Harbor, N.Y.). These include, but are not limited to, the hybridoma technique originally developed by Kohler and Milstein (Kohler and Milstein, Nature 256:495-497 (1975)), as well as the trioma technique, the human B-cell hybridoma technique (See e.g., Kozbor et al. Immunol. Today 4:72 (1983)), and the EBV-hybridoma technique to produce human monoclonal antibodies (Cole et al., in Monoclonal Antibodies and Cancer Therapy, Alan R. Liss, Inc., pp. 77-96 (1985)).

In an additional embodiment of the invention, monoclonal antibodies can be produced in germ-free animals utilizing recent technology (See e.g., PCT/US90/02545). According to the invention, human antibodies may be used and can be obtained by using human hybridomas (Cote et al., Proc. Natl. Acad. Sci. U.S.A. 80:2026-2030 (1983)) or by transforming human B cells with EBV virus in vitro (Cole et al., in Monoclonal Antibodies and Cancer Therapy, Alan R. Liss, pp. 77-96 (1985)).

According to the invention, techniques described for the production of single chain antibodies (U.S. Pat. No. 4,946,778; herein incorporated by reference) can be adapted to produce specific single chain antibodies. An additional embodiment of the invention utilizes the techniques described for the construction of Fab expression libraries (Huse et al., Science 246:1275-1281 (1989)) to allow rapid and easy identification of monoclonal Fab fragments with the desired specificity.

Antibody fragments that contain the idiotype (antigen binding region) of the antibody molecule can be generated by known techniques. For example, such fragments include but are not limited to: the F(ab′)2 fragment that can be produced by pepsin digestion of the antibody molecule; the Fab′ fragments that can be generated by reducing the disulfide bridges of the F(ab′)2 fragment, and the Fab fragments that can be generated by treating the antibody molecule with papain and a reducing agent.

In the production of antibodies, screening for the desired antibody can be accomplished by techniques known in the art (e.g., radioimmunoassay, ELISA (enzyme-linked immunosorbant assay), “sandwich” immunoassays, immunoradiometric assays, gel diffusion precipitin reactions, immunodiffusion assays, in situ immunoassays (using colloidal gold, enzyme or radioisotope labels, for example), Western Blots, precipitation reactions, agglutination assays (e.g., gel agglutination assays, hemagglutination assays, etc.), complement fixation assays, immunofluorescence assays, protein A assays, and immunoelectrophoresis assays, etc.).

The dendrimer conjugates of the present invention have many advantages over liposomes, such as their greater stability, better control of their size and polydispersity, and generally lower toxicity and immunogenicity (See e.g., Duncan et al, Polymer Preprints 39:180 (1998)). Thus, in some embodiments of the present invention, anti-HER2 antibody fragments, as well as other targeting antibodies are conjugated to dendrimers, as targeting agents for the nanodevices of the present invention.

The bifunctional linkers SPDP and SMCC and the longer Mal-PEG-OSu linkers are particularly useful for antibody-dendrimer conjugation. In addition, many tumor cells contain surface lectins that bind to oligosaccharides, with specific recognition arising chiefly from the terminal carbohydrate residues of the latter (See, e.g., Sharon and L is, Science 246:227 (1989)). Attaching appropriate monosaccharides to nonglycosylated proteins such as BSA provides a conjugate that binds to tumor lectin much more tightly than the free monosaccharide (See, e.g., Monsigny et al., Biochemie 70:1633 (1988)).

Mannosylated PAMAM dendrimers bind mannoside-binding lectin up to 400 times more avidly than monomeric mannosides (See, e.g., Page and Roy, Bioconjugate Chem., 8:714 (1997)). Sialylated dendrimers and other dendritic polymers bind to and inhibit a variety of sialate-binding viruses both in vitro and in vivo. By conjugating multiple monosaccharide residues (e.g., α-galactoside, for galactose-binding cells) to dendrimers, polyvalent conjugates are created with a high affinity for the corresponding type of tumor cell. The attachment reactions are easily carried out via reaction of the terminal amines with commercially-available α-galactosidyl-phenylisothiocyanate. The small size of the carbohydrates allows a high concentration to be present on the dendrimer surface.

Related to the targeting approaches described above is the “pretargeting” approach (See e.g., Goodwin and Meares, Cancer (suppl.) 80:2675 (1997)). An example of this strategy involves initial treatment of a subject with conjugates of tumor-specific monoclonal antibodies and streptavidin. Remaining soluble conjugate is removed from the bloodstream with an appropriate biotinylated clearing agent. When the tumor-localized conjugate is all that remains, a radiolabeled, biotinylated agent is introduced, which in turn localizes at the tumor sites by the strong and specific biotin-streptavidin interaction. Thus, the radioactive dose is maximized in dose proximity to the cancer cells and minimized in the rest of the body where it can harm healthy cells.

It has been shown that if streptavidin molecules bound to a polystyrene well are first treated with a biotinylated dendrimer, and then radiolabeled streptavidin is introduced, up to four of the labeled streptavidin molecules are bound per polystyrene-bound streptavidin (See, e.g., Wilbur et al., Bioconjugate Chem., 9:813 (1998)). Thus, biotinylated dendrimers may be used in the methods of the present invention, acting as a polyvalent receptor for the radiolabel in vivo, with a resulting amplification of the radioactive dosage per bound antibody conjugate. In the preferred embodiments of the present invention, one or more multiply-biotinylated module(s) on the clustered dendrimer presents a polyvalent target for radiolabeled or boronated (See, e.g., Barth et al., Cancer Investigation 14:534 (1996)) avidin or streptavidin, again resulting in an amplified dose of radiation for the tumor cells.

Dendrimers may also be used as clearing agents by, for example, partially biotinylating a dendrimer that has a polyvalent galactose or mannose surface. The conjugate-clearing agent complex would then have a very strong affinity for the corresponding hepatocyte receptors.

In other embodiments of the present invention, an enhanced permeability and retention (EPR) method is used in targeting. The enhanced permeability and retention (EPR) effect is a more “passive” way of targeting tumors (See, e.g., Duncan and Sat, Ann. Oncol., 9:39 (1998)). The EPR effect is the selective concentration of macromolecules and small particles in the tumor microenvironment, caused by the hyperpermeable vasculature and poor lymphatic drainage of tumors. The dendrimer compositions of the present invention provide ideal polymers for this application, in that they are relatively rigid, of narrow polydispersity, of controlled size and surface chemistry, and have interior “cargo” space that can carry and then release antitumor drugs. In fact, PAMAM dendrimer-platinates have been shown to accumulate in solid tumors (Pt levels about 50 times higher than those obtained with cisplatin) and have in vivo activity in solid tumor models for which cisplatin has no effect (See, e.g., Malik et al., Proc. Int'l. Symp. Control. Rel. Bioact. Mater., 24:107 (1997) and Duncan et al., Polymer Preprints 39:180 (1998)).

In some embodiments, the targeting agents target the central nervous system (CNS). In some embodiments, where the targeting agent is specific for the CNS, the targeting agent is transferrin (see, e.g., Daniels, T. R., et al., Clinical Immunology, 2006. 121(2): p. 159-176; Daniels, T. R., et al., Clinical Immunology, 2006. 121(2): p. 144-158; each herein incorporated by reference in their entireties). Transferrin has been utilized as a targeting vector to transport, for example, drugs, liposomes and proteins across the blood-brain barrier (BBB) by receptor mediated transcytosis (see, e.g., Smith, M. W. and M. Gumbleton, Journal of Drug Targeting, 2006. 14(4): p. 191-214; herein incorporated by reference in its entirety). In some embodiments, the targeting agents target neurons within the central nervous system (CNS). In some embodiments, where the targeting agent is specific for neurons within the CNS, the targeting agent is a synthetic tetanus toxin fragment (e.g., a 12 amino acid peptide (Tet 1) (HLNILSTLWKYR)) (see, e.g., Liu, J. K., et al., Neurobiology of Disease, 2005. 19(3): p. 407-418; herein incorporated by reference in its entirety).

In some embodiments, the dendrimer is conjugated (e.g., directly or indirectly) to an imaging agent. A multiplicity of imaging agents find use in the present invention. In some embodiments, a conjugated dendrimer of the present invention comprises at least one imaging agent that can be readily imaged. The present invention is not limited by the nature of the imaging component used. In some embodiments of the present invention, imaging modules comprise surface modifications of quantum dots (See e.g., Chan and Nie, Science 281:2016 (1998)) such as zinc sulfide-capped cadmium selenide coupled to biomolecules (Sooklal, Adv. Mater., 10:1083 (1998)).

In some embodiments, the imaging module comprises dendrimers produced according to the “nanocomposite” concept (See, e.g., Balogh et al., Proc. of ACS PMSE 77:118 (1997) and Balogh and Tomalia, J. Am. Che. Soc., 120:7355 (1998)). In these embodiments, dendrimers are produced by reactive encapsulation, where a reactant is preorganized by the dendrimer template and is then subsequently immobilized in/on the polymer molecule by a second reactant. Size, shape, size distribution and surface functionality of these nanoparticles are determined and controlled by the dendritic macromolecules. These materials have the solubility and compatibility of the host and have the optical or physiological properties of the guest molecule (i.e., the molecule that permits imaging). While the dendrimer host may vary according to the medium, it is possible to load the dendrimer hosts with different compounds and at various guest concentration levels. Complexes and composites may involve the use of a variety of metals or other inorganic materials. The high electron density of these materials considerably simplifies the imaging by electron microscopy and related scattering techniques. In addition, properties of inorganic atoms introduce new and measurable properties for imaging in either the presence or absence of interfering biological materials. In some embodiments of the present invention, encapsulation of gold, silver, cobalt, iron atoms/molecules and/or organic dye molecules such as fluorescein are encapsulated into dendrimers for use as nanoscopic composite labels/tracers, although any material that facilitates imaging or detection may be employed. In a preferred embodiment, the imaging agent is fluorescein isothiocyanate.

In some embodiments of the present invention, imaging is based on the passive or active observation of local differences in density of selected physical properties of the investigated complex matter. These differences may be due to a different shape (e.g., mass density detected by atomic force microscopy), altered composition (e.g. radiopaques detected by X-ray), distinct light emission (e.g., fluorochromes detected by spectrophotometry), different diffraction (e.g., electron-beam detected by TEM), contrasted absorption (e.g., light detected by optical methods), or special radiation emission (e.g., isotope methods), etc. Thus, quality and sensitivity of imaging depend on the property observed and on the technique used. The imaging techniques for cancerous cells have to provide sufficient levels of sensitivity to allow observation of small, local concentrations of selected cells. The earliest identification of cancer signatures requires high selectivity (i.e., highly specific recognition provided by appropriate targeting) and the highest possible sensitivity.

In some embodiments, once a targeted dendrimer conjugate has attached to (or been internalized into) a target cell (e.g., tumor cell and or inflammatory cell), one or more modules on the device serve to image its location. Dendrimers have already been employed as biomedical imaging agents, perhaps most notably for magnetic resonance imaging (MRI) contrast enhancement agents (See e.g., Wiener et al., Mag. Reson. Med. 31:1 (1994); an example using PAMAM dendrimers). These agents are typically constructed by conjugating chelated paramagnetic ions, such as Gd(III)-diethylenetriaminepentaacetic acid (Gd(III)-DTPA), to water-soluble dendrimers. Other paramagnetic ions that may be useful in this context include, but are not limited to, gadolinium, manganese, copper, chromium, iron, cobalt, erbium, nickel, europium, technetium, indium, samarium, dysprosium, ruthenium, ytterbium, yttrium, and holmium ions and combinations thereof. In some embodiments of the present invention, a dendrimer conjugate is also conjugated to a targeting group, such as epidermal growth factor (EGF), to make the conjugate specifically bind to the desired cell type (e.g., in the case of EGF, EGFR-expressing tumor cells). In a preferred embodiment of the present invention, DTPA is attached to dendrimers via the isothiocyanate of DTPA as described by Wiener (Wiener et al., Mag. Reson. Med. 31:1 (1994)).

Dendrimeric MRI agents are particularly effective due to the polyvalency, size and architecture of dendrimers, which results in molecules with large proton relaxation enhancements, high molecular relaxivity, and a high effective concentration of paramagnetic ions at the target site. Dendrimeric gadolinium contrast agents have even been used to differentiate between benign and malignant breast tumors using dynamic MRI, based on how the vasculature for the latter type of tumor images more densely (Adam et al., Ivest. Rad. 31:26 (1996)). Thus, MRI provides a particularly useful imaging system of the present invention.

Some dendrimer conjugates of the present invention allow functional microscopic imaging of tumors and provide improved methods for imaging. The methods find use in vivo, in vitro, and ex vivo. For example, in one embodiment of the present invention, dendrimer conjugates of the present invention are designed to emit light or other detectable signals upon exposure to light. Although the labeled dendrimers may be physically smaller than the optical resolution limit of the microscopy technique, they become self-luminous objects when excited and are readily observable and measurable using optical techniques. In some embodiments of the present invention, sensing fluorescent biosensors in a microscope involves the use of tunable excitation and emission filters and multiwavelength sources (See, e.g., Farkas et al., SPEI 2678:200 (1997)). In embodiments where the imaging agents are present in deeper tissue, longer wavelengths in the Near-infrared (NMR) are used (See e.g., Lester et al., Cell Mol. Biol. 44:29 (1998)). Dendrimeric biosensing in the Near-IR has been demonstrated with dendrimeric biosensing antenna-like architectures (See, e.g., Shortreed et al., J. Phys. Chem., 101:6318 (1997)). Biosensors that find use with the present invention include, but are not limited to, fluorescent dyes and molecular beacons.

In some embodiments of the present invention, in vivo imaging is accomplished using functional imaging techniques. Functional imaging is a complementary and potentially more powerful technique as compared to static structural imaging. Functional imaging is best known for its application at the macroscopic scale, with examples including functional Magnetic Resonance Imaging (fMRI) and Positron Emission Tomography (PET). However, functional microscopic imaging may also be conducted and find use in in vivo and ex vivo analysis of living tissue. Functional microscopic imaging is an efficient combination of 3-D imaging, 3-D spatial multispectral volumetric assignment, and temporal sampling: in short a type of 3-D spectral microscopic movie loop. Interestingly, cells and tissues autofluoresce. When excited by several wavelengths, providing much of the basic 3-D structure needed to characterize several cellular components (e.g., the nucleus) without specific labeling. Oblique light illumination is also useful to collect structural information and is used routinely. As opposed to structural spectral microimaging, functional spectral microimaging may be used with biosensors, which act to localize physiologic signals within the cell or tissue. For example, in some embodiments of the present invention, biosensor-comprising dendrimers of the present invention are used to image upregulated receptor families such as the folate or EGF classes. In such embodiments, functional biosensing therefore involves the detection of physiological abnormalities relevant to carcinogenesis or malignancy, even at early stages. A number of physiological conditions may be imaged using the compositions and methods of the present invention including, but not limited to, detection of nanoscopic dendrimeric biosensors for pH, oxygen concentration, Ca²⁺ concentration, and other physiologically relevant analytes.

In some embodiments, the present invention provides dendrimers having a biological monitoring component. The biological monitoring or sensing component of a dendrimer is one that can monitor the particular response in a target cell (e.g., tumor cell) induced by an agent (e.g., a therapeutic agent provided by a conjugated dendrimer). While the present invention is not limited to any particular monitoring system, the invention is illustrated by methods and compositions for monitoring cancer treatments. In preferred embodiments of the present invention, the agent induces apoptosis in cells and monitoring involves the detection of apoptosis. In some embodiments, the monitoring component is an agent that fluoresces at a particular wavelength when apoptosis occurs. For example, in a preferred embodiment, caspase activity activates green fluorescence in the monitoring component. Apoptotic cancer cells, which have turned red as a result of being targeted by a particular signature with a red label, turn orange while residual cancer cells remain red. Normal cells induced to undergo apoptosis (e.g., through collateral damage), if present, will fluoresce green.

In these embodiments, fluorescent groups such as fluorescein are employed in the imaging agent. Fluorescein is easily attached to the dendrimer surface via the isothiocyanate derivatives, available from MOLECULAR PROBES, Inc. This allows the conjugated dendrimer to be imaged with the cells via confocal microscopy. Sensing of the effectiveness of the conjugated dendrimer or components thereof is preferably achieved by using fluorogenic peptide enzyme substrates. For example, apoptosis caused by the therapeutic agent results in the production of the peptidase caspase-1 (ICE). CALBIOCHEM sells a number of peptide substrates for this enzyme that release a fluorescent moiety. A particularly useful peptide for use in the present invention is: MCA-Tyr-Glu-Val-Asp-Gly-Trp-Lys-(DNP)-NH₂ (SEQ ID NO: 1) where MCA is the (7-methoxycoumarin-4-yl)acetyl and DNP is the 2,4-dinitrophenyl group (See, e.g., Talanian et al., J. Biol. Chem., 272: 9677 (1997); herein incorporated by reference in its entirety). In this peptide, the MCA group has greatly attenuated fluorescence, due to fluorogenic resonance energy transfer (FRET) to the DNP group. When the enzyme cleaves the peptide between the aspartic acid and glycine residues, the MCA and DNP are separated, and the MCA group strongly fluoresces green (excitation maximum at 325 nm and emission maximum at 392 nm). In some embodiments, the lysine end of the peptide is linked to pro-drug complex, so that the MCA group is released into the cytosol when it is cleaved. The lysine end of the peptide is a useful synthetic handle for conjugation because, for example, it can react with the activated ester group of a bifunctional linker such as Mal-PEG-OSu. Thus the appearance of green fluorescence in the target cells produced using these methods provides a clear indication that apoptosis has begun (if the cell already has a red color from the presence of aggregated quantum dots, the cell turns orange from the combined colors).

Additional fluorescent dyes that find use with the present invention include, but are not limited to, acridine orange, reported as sensitive to DNA changes in apoptotic cells (see, e.g., Abrams et al., Development 117:29 (1993); herein incorporated by reference in its entirety) and cis-parinaric acid, sensitive to the lipid peroxidation that accompanies apoptosis (see, e.g., Hockenbery et al., Cell 75:241 (1993); herein incorporated by reference in its entirety). It should be noted that the peptide and the fluorescent dyes are merely exemplary. It is contemplated that any peptide that effectively acts as a substrate for a caspase produced as a result of apoptosis finds use with the present invention.

In some embodiments of the present invention, the lysine end of the peptide is linked to the dendrimer conjugate, so that the MCA group is released into the cytosol when it is cleaved. The lysine end of the peptide is a useful synthetic handle for conjugation because, for example, it can react with the activated ester group of a bifunctional linker such as Mal-PEG-OSu. Thus the appearance of green fluorescence in the target cells produced using these methods provides a clear indication that apoptosis has begun (if the cell already has a red color from the presence of aggregated quantum dots, the cell turns orange from the combined colors).

Additional fluorescent dyes that find use with the present invention include, but are not limited to, acridine orange, reported as sensitive to DNA changes in apoptotic cells (Abrams et al., Development 117:29 (1993)) and cis-parinaric acid, sensitive to the lipid peroxidation that accompanies apoptosis (Hockenbery et al., Cell 75:241 (1993)). It should be noted that the peptide and the fluorescent dyes are merely exemplary. It is contemplated that any peptide that effectively acts as a substrate for a caspase produced as a result of apoptosis finds use with the present invention.

As described above, another component of the present invention is that the dendrimer conjugate compositions are able to specifically target a particular cell type (e.g., tumor cell). In some embodiments, the dendrimer conjugate targets neoplastic cells through a cell surface moiety and is taken into the cell through receptor mediated endocytosis.

Where clinical applications are contemplated, in some embodiments of the present invention, the dendrimer conjugates are prepared as part of a pharmaceutical composition in a form appropriate for the intended application. Generally, this entails preparing compositions that are essentially free of pyrogens, as well as other impurities that could be harmful to humans or animals. However, in some embodiments of the present invention, a straight dendrimer formulation may be administered using one or more of the routes described herein.

In preferred embodiments, the dendrimer conjugates are used in conjunction with appropriate salts and buffers to render delivery of the compositions in a stable manner to allow for uptake by target cells. Buffers also are employed when the dendrimer conjugates are introduced into a patient. Aqueous compositions comprise an effective amount of the dendrimer conjugates to cells dispersed in a pharmaceutically acceptable carrier or aqueous medium. Such compositions also are referred to as inocula. The phrase “pharmaceutically or pharmacologically acceptable” refer to molecular entities and compositions that do not produce adverse, allergic, or other untoward reactions when administered to an animal or a human. As used herein, “pharmaceutically acceptable carrier” includes any and all solvents, dispersion media, coatings, antibacterial and antifungal agents, isotonic and absorption delaying agents and the like. Except insofar as any conventional media or agent is incompatible with the vectors or cells of the present invention, its use in therapeutic compositions is contemplated. Supplementary active ingredients may also be incorporated into the compositions.

In some embodiments of the present invention, the active compositions include classic pharmaceutical preparations. Administration of these compositions according to the present invention is via any common route so long as the target tissue is available via that route. This includes oral, nasal, buccal, rectal, vaginal or topical. Alternatively, administration may be by orthotopic, intradermal, subcutaneous, intramuscular, intraperitoneal or intravenous injection.

The active dendrimer conjugates may also be administered parenterally or intraperitoneally or intratumorally. Solutions of the active compounds as free base or pharmacologically acceptable salts are prepared in water suitably mixed with a surfactant, such as hydroxypropylcellulose. Dispersions can also be prepared in glycerol, liquid polyethylene glycols, and mixtures thereof and in oils. Under ordinary conditions of storage and use, these preparations contain a preservative to prevent the growth of microorganisms. In some embodiments, a therapeutic agent is released from dendrimer conjugates within a target cell (e.g., within an endosome). This type of intracellular release (e.g., endosomal disruption of a linker-therapeutic conjugate) is contemplated to provide additional specificity for the compositions and methods of the present invention. In some embodiments, the dendrimer conjugates of the present invention contain between 100-150 primary amines on the surface. Thus, the present invention provides dendrimers with multiple (e.g., 100-150) reactive sites for the conjugation of linkers and/or functional groups comprising, but not limited to, therapeutic agents, targeting agents, imaging agents and biological monitoring agents.

The compositions and methods of the present invention are contemplated to be equally effective whether or not the dendrimer conjugates of the present invention comprise a fluorescein (e.g. FITC) imaging agent. Thus, each functional group present in a dendrimer composition is able to work independently of the other functional groups. Thus, the present invention provides dendrimer conjugates that can comprise multiple combinations of targeting, therapeutic, imaging, and biological monitoring functional groups.

The present invention also provides a very effective and specific method of delivering molecules (e.g., therapeutic and imaging functional groups) to the interior of target cells (e.g., cancer cells). Thus, in some embodiments, the present invention provides methods of therapy that comprise or require delivery of molecules into a cell in order to function (e.g., delivery of genetic material such as siRNAs).

The pharmaceutical forms suitable for injectable use include sterile aqueous solutions or dispersions and sterile powders for the extemporaneous preparation of sterile injectable solutions or dispersions. The carrier may be a solvent or dispersion medium containing, for example, water, ethanol, polyol (for example, glycerol, propylene glycol, and liquid polyethylene glycol, and the like), suitable mixtures thereof, and vegetable oils. The proper fluidity can be maintained, for example, by the use of a coating, such as lecithin, by the maintenance of the required particle size in the case of dispersion and by the use of surfactants. The prevention of the action of microorganisms can be brought about by various antibacterial an antifungal agents, for example, parabens, chlorobutanol, phenol, sorbic acid, thimerosal, and the like. In many cases, it may be preferable to include isotonic agents, for example, sugars or sodium chloride. Prolonged absorption of the injectable compositions can be brought about by the use in the compositions of agents delaying absorption, for example, aluminum monostearate and gelatin.

Sterile injectable solutions are prepared by incorporating the active compounds in the required amount in the appropriate solvent with various of the other ingredients enumerated above, as required, followed by filtered sterilization. Generally, dispersions are prepared by incorporating the various sterilized active ingredients into a sterile vehicle which contains the basic dispersion medium and the required other ingredients from those enumerated above. In the case of sterile powders for the preparation of sterile injectable solutions, the preferred methods of preparation are vacuum-drying and freeze-drying techniques which yield a powder of the active ingredient plus any additional desired ingredient from a previously sterile-filtered solution thereof.

Upon formulation, dendrimer conjugates are administered in a manner compatible with the dosage formulation and in such amount as is therapeutically effective. The formulations are easily administered in a variety of dosage forms such as injectable solutions, drug release capsules and the like. For parenteral administration in an aqueous solution, for example, the solution is suitably buffered, if necessary, and the liquid diluent first rendered isotonic with sufficient saline or glucose. These particular aqueous solutions are especially suitable for intravenous, intramuscular, subcutaneous and intraperitoneal administration. For example, one dosage could be dissolved in 1 ml of isotonic NaCl solution and either added to 1000 ml of hypodermoclysis fluid or injected at the proposed site of infusion, (see for example, “Remington's Pharmaceutical Sciences” 15th Edition, pages 1035-1038 and 1570-1580). In some embodiments of the present invention, the active particles or agents are formulated within a therapeutic mixture to comprise about 0.0001 to 1.0 milligrams, or about 0.001 to 0.1 milligrams, or about 0.1 to 1.0 or even about 10 milligrams per dose or so. Multiple doses may be administered.

Additional formulations that are suitable for other modes of administration include vaginal suppositories and pessaries. A rectal pessary or suppository may also be used. Suppositories are solid dosage forms of various weights and shapes, usually medicated, for insertion into the rectum, vagina or the urethra. After insertion, suppositories soften, melt or dissolve in the cavity fluids. In general, for suppositories, traditional binders and carriers may include, for example, polyalkylene glycols or triglycerides; such suppositories may be formed from mixtures containing the active ingredient in the range of 0.5% to 10%, preferably 1%-2%. Vaginal suppositories or pessaries are usually globular or oviform and weighing about 5 g each. Vaginal medications are available in a variety of physical forms, e.g., creams, gels or liquids, which depart from the classical concept of suppositories. In addition, suppositories may be used in connection with colon cancer. The dendrimer conjugates also may be formulated as inhalants for the treatment of lung cancer and such like.

It is contemplated that components of conjugated dendrimers of the present invention provide therapeutic benefits to patients suffering from medical conditions and/or diseases (e.g., cancer, inflammatory disease, chronic pain, autoimmune disease, etc.).

Indeed, in some embodiments of the present invention, methods and compositions are provided for the treatment of inflammatory diseases (e.g., dendrimers conjugated with therapeutic agents configured for treating inflammatory diseases). Inflammatory diseases include but are not limited to arthritis, rheumatoid arthritis, psoriatic arthritis, osteoarthritis, degenerative arthritis, polymyalgia rheumatic, ankylosing spondylitis, reactive arthritis, gout, pseudogout, inflammatory joint disease, systemic lupus erythematosus, polymyositis, and fibromyalgia. Additional types of arthritis include achilles tendinitis, achondroplasia, acromegalic arthropathy, adhesive capsulitis, adult onset Still's disease, anserine bursitis, avascular necrosis, Behcet's syndrome, bicipital tendinitis, Blount's disease, brucellar spondylitis, bursitis, calcaneal bursitis, calcium pyrophosphate dihydrate deposition disease (CPPD), crystal deposition disease, Caplan's syndrome, carpal tunnel syndrome, chondrocalcinosis, chondromalacia patellae, chronic synovitis, chronic recurrent multifocal osteomyelitis, Churg-Strauss syndrome, Cogan's syndrome, corticosteroid-induced osteoporosis, costosternal syndrome, CREST syndrome, cryoglobulinemia, degenerative joint disease, dermatomyositis, diabetic finger sclerosis, diffuse idiopathic skeletal hyperostosis (DISH), discitis, discoid lupus erythematosus, drug-induced lupus, Duchenne's muscular dystrophy, Dupuytren's contracture, Ehlers-Danlos syndrome, enteropathic arthritis, epicondylitis, erosive inflammatory osteoarthritis, exercise-induced compartment syndrome, Fabry's disease, familial Mediterranean fever, Farber's lipogranulomatosis, Felty's syndrome, Fifth's disease, flat feet, foreign body synovitis, Freiberg's disease, fungal arthritis, Gaucher's disease, giant cell arteritis, gonococcal arthritis, Goodpasture's syndrome, granulomatous arteritis, hemarthrosis, hemochromatosis, Henoch-Schonlein purpura, Hepatitis B surface antigen disease, hip dysplasia, Hurler syndrome, hypermobility syndrome, hypersensitivity vasculitis, hypertrophic osteoarthropathy, immune complex disease, impingement syndrome, Jaccoud's arthropathy, juvenile ankylosing spondylitis, juvenile dermatomyositis, juvenile rheumatoid arthritis, Kawasaki disease, Kienbock's disease, Legg-Calve-Perthes disease, Lesch-Nyhan syndrome, linear scleroderma, lipoid dermatoarthritis, Lofgren's syndrome, Lyme disease, malignant synovioma, Marfan's syndrome, medial plica syndrome, metastatic carcinomatous arthritis, mixed connective tissue disease (MCTD), mixed cryoglobulinemia, mucopolysaccharidosis, multicentric reticulohistiocytosis, multiple epiphyseal dysplasia, mycoplasmal arthritis, myofascial pain syndrome, neonatal lupus, neuropathic arthropathy, nodular panniculitis, ochronosis, olecranon bursitis, Osgood-Schlatter's disease, osteoarthritis, osteochondromatosis, osteogenesis imperfecta, osteomalacia, osteomyelitis, osteonecrosis, osteoporosis, overlap syndrome, pachydermoperiostosis Paget's disease of bone, palindromic rheumatism, patellofemoral pain syndrome, Pellegrini-Stieda syndrome, pigmented villonodular synovitis, piriformis syndrome, plantar fasciitis, polyarteritis nodos, Polymyalgia rheumatic, polymyositis, popliteal cysts, posterior tibial tendinitis, Pott's disease, prepatellar bursitis, prosthetic joint infection, pseudoxanthoma elasticum, psoriatic arthritis, Raynaud's phenomenon, reactive arthritis/Reiter's syndrome, reflex sympathetic dystrophy syndrome, relapsing polychondritis, retrocalcaneal bursitis, rheumatic fever, rheumatoid vasculitis, rotator cuff tendinitis, sacroiliitis, salmonella osteomyelitis, sarcoidosis, saturnine gout, Scheuermann's osteochondritis, scleroderma, septic arthritis, seronegative arthritis, shigella arthritis, shoulder-hand syndrome, sickle cell arthropathy, Sjogren's syndrome, slipped capital femoral epiphysis, spinal stenosis, spondylolysis, staphylococcus arthritis, Stickler syndrome, subacute cutaneous lupus, Sweet's syndrome, Sydenham's chorea, syphilitic arthritis, systemic lupus erythematosus (SLE), Takayasu's arteritis, tarsal tunnel syndrome, tennis elbow, Tietse's syndrome, transient osteoporosis, traumatic arthritis, trochanteric bursitis, tuberculosis arthritis, arthritis of Ulcerative colitis, undifferentiated connective tissue syndrome (UCTS), urticarial vasculitis, viral arthritis, Wegener's granulomatosis, Whipple's disease, Wilson's disease, and yersinial arthritis.

In some embodiments, the conjugated dendrimers of the present invention configured for treating autoimmune disorders and/or inflammatory disorders (e.g., rheumatoid arthritis) are co-administered to a subject (e.g., a human suffering from an autoimmune disorder and/or an inflammatory disorder) a therapeutic agent configured for treating autoimmune disorders and/or inflammatory disorders (e.g., rheumatoid arthritis). Examples of such agents include, but are not limited to, disease-modifying antirheumatic drugs (e.g., leflunomide, methotrexate, sulfasalazine, hydroxychloroquine), biologic agents (e.g., rituximab, infliximab, etanercept, adalimumab, golimumab), nonsteroidal anti-inflammatory drugs (e.g., ibuprofen, celecoxib, ketoprofen, naproxen, piroxicam, diclofenac), analgesics (e.g., acetaminophen, tramadol), immunomodulators (e.g., anakinra, abatacept), and glucocorticoids (e.g., prednisone, methylprednisone).

In some embodiments, the medical condition and/or disease is pain (e.g., chronic pain, mild pain, recurring pain, severe pain, etc.). In some embodiments, the conjugated dendrimers of the present invention are configured to deliver pain relief agents to a subject. In some embodiments, the dendrimer conjugates are configured to deliver pain relief agents and pain relief agent antagonists to counter the side effects of pain relief agents. The dendrimer conjugates are not limited to treating a particular type of pain and/or pain resulting from a disease. Examples include, but are not limited to, pain resulting from trauma (e.g., trauma experienced on a battlefield, trauma experienced in an accident (e.g., car accident)). In some embodiments, the dendrimer conjugates of the present invention are configured such that they are readily cleared from the subject (e.g., so that there is little to no detectable toxicity at efficacious doses).

In some embodiments, the disease is cancer. The present invention is not limited by the type of cancer treated using the compositions and methods of the present invention. Indeed, a variety of cancer can be treated including, but not limited to, prostate cancer, colon cancer, breast cancer, lung cancer and epithelial cancer. Similarly, the present invention is not limited by the type of inflammatory disease and/or chronic pain treated using the compositions of the present invention. Indeed, a variety of diseases can be treated including, but not limited to, arthritis (e.g., osteoarthritis, rheumatoid arthritis, etc.), inflammatory bowel disease (e.g., colitis, Crohn's disease, etc.), autoimmune disease (e.g., lupus erythematosus, multiple sclerosis, etc.), inflammatory pelvic disease, etc.

In some embodiments, the disease is a neoplastic disease, selected from, but not limited to, leukemia, acute leukemia, acute lymphocytic leukemia, acute myelocytic leukemia, myeloblastic, promyelocytic, myelomonocytic, monocytic, erythroleukemia, chronic leukemia, chronic myelocytic, (granulocytic) leukemia, chronic lymphocytic leukemia, Polycythemia vera, lymphoma, Hodgkin's disease, non-Hodgkin's disease, Multiple myeloma, Waldenstrom's macroglobulinemia, Heavy chain disease, solid tumors, sarcomas and carcinomas, fibrosarcoma, myxosarcoma, liposarcoma, chondrosarcoma, osteogenic sarcoma, chordoma, angiosarcoma, endotheliosarcoma, lymphangiosarcoma, lymphangioendotheliosarcoma, synovioma, mesothelioma, Ewing's tumor, leiomyosarcoma, rhabdomyosarcoma, colon carcinoma, pancreatic cancer, breast cancer, ovarian cancer, prostate cancer, squamous cell carcinoma, basal cell carcinoma, adenocarcinoma, sweat gland carcinoma, sebaceous gland carcinoma, papillary carcinoma, papillary adenocarcinomas, cystadenocarcinoma, medullary carcinoma, bronchogenic carcinoma, renal cell carcinoma, hepatoma, bile duct carcinoma, choriocarcinoma, seminoma, embryonal carcinoma, Wilms' tumor, cervical cancer, uterine cancer, testicular tumor, lung carcinoma, small cell lung carcinoma, bladder carcinoma, epithelial carcinoma, glioma, astrocytoma, medulloblastoma, craniopharyngioma, ependymoma, pinealoma, hemangioblastoma, acoustic neuroma, oligodendroglioma, meningioma, melanoma, and neuroblastomaretinoblastoma. In some embodiments, the disease is an inflammatory disease selected from the group consisting of, but not limited to, eczema, inflammatory bowel disease, rheumatoid arthritis, asthma, psoriasis, ischemia/reperfusion injury, ulcerative colitis and acute respiratory distress syndrome. In some embodiments, the disease is a viral disease selected from the group consisting of, but not limited to, viral disease caused by hepatitis B, hepatitis C, rotavirus, human immunodeficiency virus type I (HIV-I), human immunodeficiency virus type II (HIV-II), human T-cell lymphotropic virus type I (HTLV-I), human T-cell lymphotropic virus type II (HTLV-II), AIDS, DNA viruses such as hepatitis type B and hepatitis type C virus; parvoviruses, such as adeno-associated virus and cytomegalovirus; papovaviruses such as papilloma virus, polyoma viruses, and SV40; adenoviruses; herpes viruses such as herpes simplex type I (HSV-I), herpes simplex type II (HSV-II), and Epstein-Barr virus; poxviruses, such as variola (smallpox) and vaccinia virus; and RNA viruses, such as human immunodeficiency virus type I (HIV-I), human immunodeficiency virus type II (HIV-II), human T-cell lymphotropic virus type I (HTLV-I), human T-cell lymphotropic virus type II (HTLV-II), influenza virus, measles virus, rabies virus, Sendai virus, picornaviruses such as poliomyelitis virus, coxsackieviruses, rhinoviruses, reoviruses, togaviruses such as rubella virus (German measles) and Semliki forest virus, arboviruses, and hepatitis type A virus.

It is contemplated that the denddrimer conjugates of the present invention can be employed in the treatment of any pathogenic disease for which a specific signature has been identified or which can be targeted for a given pathogen. Examples of pathogens contemplated to be treatable with the methods of the present invention include, but are not limited to, Legionella peomophilia, Mycobacterium tuberculosis, Clostridium tetani, Hemophilus influenzae, Neisseria gonorrhoeae, Treponema pallidum, Bacillus anthracis, Vibrio cholerae, Borrelia burgdorferi, Cornebacterium diphtheria, Staphylococcus aureus, human papilloma virus, human immunodeficiency virus, rubella virus, polio virus, and the like.

The present invention also includes methods involving co-administration of the conjugated dendrimers of the present invention with one or more additional active agents. Indeed, it is a further aspect of this invention to provide methods for enhancing prior art therapies and/or pharmaceutical compositions by co-administering conjugated dendrimers of this invention. In co-administration procedures, the agents may be administered concurrently or sequentially. In some embodiments, the conjugated dendrimers described herein are administered prior to the other active agent(s). The agent or agents to be co-administered depends on the type of condition being treated. For example, when the condition being treated is arthritis, the additional agent can be an agent effective in treating arthritis (e.g., TNF-α inhibitors such as anti-TNF a monoclonal antibodies (such as REMICADE®, CDP-870 and HUMIRA™ (adalimumab) and TNF receptor-immunoglobulin fusion molecules (such as ENBREL®) (entanercept), IL-1 inhibitors, receptor antagonists or soluble IL-1R α (e.g. KINERET™ or ICE inhibitors), nonsteroidal anti-inflammatory agents (NSAIDS), piroxicam, diclofenac, naproxen, flurbiprofen, fenoprofen, ketoprofen ibuprofen, fenamates, mefenamic acid, indomethacin, sulindac, apazone, pyrazolones, phenylbutazone, aspirin, COX-2 inhibitors (such as CELEBREX® (celecoxib), VIOXX® (rofecoxib), BEXTRA® (valdecoxib) and etoricoxib, (preferably MMP-13 selective inhibitors), NEUROTIN®, pregabalin, sulfasalazine, low dose methotrexate, leflunomide, hydroxychloroquine, d-penicillamine, auranofin or parenteral or oral gold). The additional agents to be co-administered can be any of the well-known agents in the art, including, but not limited to, those that are currently in clinical use. The determination of appropriate type and dosage of radiation treatment is also within the skill in the art or can be determined with relative ease.

In some embodiments, the composition is co-administered with an anti-cancer agent (e.g., Acivicin; Aclarubicin; Acodazole Hydrochloride; Acronine; Adozelesin; Adriamycin; Aldesleukin; Alitretinoin; Allopurinol Sodium; Altretamine; Ambomycin; Ametantrone Acetate; Aminoglutethimide; Amsacrine; Anastrozole; Annonaceous Acetogenins; Anthramycin; Asimicin; Asparaginase; Asperlin; Azacitidine; Azetepa; Azotomycin; Batimastat; Benzodepa; Bexarotene; Bicalutamide; Bisantrene Hydrochloride; Bisnafide Dimesylate; Bizelesin; Bleomycin Sulfate; Brequinar Sodium; Bropirimine; Bullatacin; Busulfan; Cabergoline; Cactinomycin; Calusterone; Caracemide; Carbetimer; Carboplatin; Carmustine; Carubicin Hydrochloride; Carzelesin; Cedefingol; Celecoxib; Chlorambucil; Cirolemycin; Cisplatin; Cladribine; Crisnatol Mesylate; Cyclophosphamide; Cytarabine; Dacarbazine; DACA (N-[2-(Dimethyl-amino)ethyl]acridine-4-carboxamide); Dactinomycin; Daunorubicin Hydrochloride; Daunomycin; Decitabine; Denileukin Diftitox; Dexormaplatin; Dezaguanine; Dezaguanine Mesylate; Diaziquone; Docetaxel; Doxorubicin; Doxorubicin Hydrochloride; Droloxifene; Droloxifene Citrate; Dromostanolone Propionate; Duazomycin; Edatrexate; Eflornithine Hydrochloride; Elsamitrucin; Enloplatin; Enpromate; Epipropidine; Epirubicin Hydrochloride; Erbulozole; Esorubicin Hydrochloride; Estramustine; Estramustine Phosphate Sodium; Etanidazole; Ethiodized Oil 1131; Etoposide; Etoposide Phosphate; Etoprine; Fadrozole Hydrochloride; Fazarabine; Fenretinide; Floxuridine; Fludarabine Phosphate; Fluorouracil; 5-FdUMP; Fluorocitabine; Fosquidone; Fostriecin Sodium; FK-317; FK-973; FR-66979; FR-900482; Gemcitabine; Geimcitabine Hydrochloride; Gemtuzumab Ozogamicin; Gold Au 198; Goserelin Acetate; Guanacone; Hydroxyurea; Idarubicin Hydrochloride; Ifosfamide; Ilmofosine; Interferon Alfa-2a; Interferon Alfa-2b; Interferon Alfa-n1; Interferon Alfa-n3; Interferon Beta-1a; Interferon Gamma-1b; Iproplatin; Irinotecan Hydrochloride; Lanreotide Acetate; Letrozole; Leuprolide Acetate; Liarozole Hydrochloride; Lometrexol Sodium; Lomustine; Losoxantrone Hydrochloride; Masoprocol; Maytansine; Mechlorethamine Hydrochloride; Megestrol Acetate; Melengestrol Acetate; Melphalan; Menogaril; Mercaptopurine; Methotrexate; Methotrexate Sodium; Methoxsalen; Metoprine; Meturedepa; Mitindomide; Mitocarcin; Mitocromin; Mitogillin; Mitomalcin; Mitomycin; Mytomycin C; Mitosper; Mitotane; Mitoxantrone Hydrochloride; Mycophenolic Acid; Nocodazole; Nogalamycin; Oprelvekin; Ormaplatin; Oxisuran; Paclitaxel; Pamidronate Disodium; Pegaspargase; Peliomycin; Pentamustine; Peplomycin Sulfate; Perfosfamide; Pipobroman; Piposulfan; Piroxantrone Hydrochloride; Plicamycin; Plomestane; Porfimer Sodium; Porfiromycin; Prednimustine; Procarbazine Hydrochloride; Puromycin; Puromycin Hydrochloride; Pyrazofurin; Riboprine; Rituximab; Rogletimide; Rolliniastatin; Safingol; Safingol Hydrochloride; Samarium/Lexidronam; Semustine; Simtrazene; Sparfosate Sodium; Sparsomycin; Spirogermanium Hydrochloride; Spiromustine; Spiroplatin; Squamocin; Squamotacin; Streptonigrin; Streptozocin; Strontium Chloride Sr 89; Sulofenur; Talisomycin; Taxane; Taxoid; Tecogalan Sodium; Tegafur; Teloxantrone Hydrochloride; Temoporfin; Teniposide; Teroxirone; Testolactone; Thiamiprine; Thioguanine; Thiotepa; Thymitaq; Tiazofurin; Tirapazamine; Tomudex; TOP-53; Topotecan Hydrochloride; Toremifene Citrate; Trastuzumab; Trestolone Acetate; Triciribine Phosphate; Trimetrexate; Trimetrexate Glucuronate; Triptorelin; Tubulozole Hydrochloride; Uracil Mustard; Uredepa; Valrubicin; Vapreotide; Verteporfin; Vinblastine; Vinblastine Sulfate; Vincristine; Vincristine Sulfate; Vindesine; Vindesine Sulfate; Vinepidine Sulfate; Vinglycinate Sulfate; Vinleurosine Sulfate; Vinorelbine Tartrate; Vinrosidine Sulfate; Vinzolidine Sulfate; Vorozole; Zeniplatin; Zinostatin; Zorubicin Hydrochloride; 2-Chlorodeoxyadenosine; 2′-Deoxyformycin; 9-aminocamptothecin; raltitrexed; N-propargyl-5,8-dideazafolic acid; 2-chloro-2′-arabino-fluoro-2′-deoxyadenosine; 2-chloro-2′-deoxyadenosine; anisomycin; trichostatin A; hPRL-G129R; CEP-751; linomide; sulfur mustard; nitrogen mustard (mechlorethamine); cyclophosphamide; melphalan; chlorambucil; ifosfamide; busulfan; N-methyl-N-nitrosourea (MNU); N,N′-Bis(2-chloroethyl)-N-nitrosourea (BCNU); N-(2-chloroethyl)-N′-cyclohexyl-N-nitrosourea (CCNU); N-(2-chloroethyl)-N′-(trans-4-methylcyclohexyl-N-nitrosourea (MeCCNU); N-(2-chloroethyl)-N′-(diethyl)ethylphosphonate-N-nitrosourea (fotemustine); streptozotocin; diacarbazine (DTIC); mitozolomide; temozolomide; thiotepa; mitomycin C; AZQ; adozelesin; Cisplatin; Carboplatin; Ormaplatin; Oxaliplatin; CI-973; DWA 2114R; JM216; JM335; Bis (platinum); tomudex; azacitidine; cytarabine; gemcitabine; 6-Mercaptopurine; 6-Thioguanine; Hypoxanthine; teniposide; 9-amino camptothecin; Topotecan; CPT-11; Doxorubicin; Daunomycin; Epirubicin; darubicin; mitoxantrone; losoxantrone; Dactinomycin (Actinomycin D); amsacrine; pyrazoloacridine; all-trans retinol; 14-hydroxy-retro-retinol; all-trans retinoic acid; N-(4-Hydroxyphenyl) retinamide; 13-cis retinoic acid; 3-Methyl TTNEB; 9-cis retinoic acid; fludarabine (2-F-ara-AMP); and 2-chlorodeoxyadenosine (2-Cda). Other anti-cancer agents include, but are not limited to, Antiproliferative agents (e.g., Piritrexim Isothionate), Antiprostatic hypertrophy agent (e.g., Sitogluside), Benign prostatic hyperplasia therapy agents (e.g., Tamsulosin Hydrochloride), Prostate growth inhibitor agents (e.g., Pentomone), and Radioactive agents: Fibrinogen 1 125; Fludeoxyglucose F 18; Fluorodopa F 18; Insulin I 125; Insulin I 131; Iobenguane I 123; Iodipamide Sodium I 131; Iodoantipyrine I 131; Iodocholesterol I 131; Iodohippurate Sodium I 123; Iodohippurate Sodium I 125; Iodohippurate Sodium I 131; Iodopyracet I 125; Iodopyracet I 131; Iofetamine Hydrochloride I 123; Iomethin I 125; Iomethin I 131; Iothalamate Sodium I 125; Iothalamate Sodium I 131; Iotyrosine I 131; Liothyronine I 125; Liothyronine I 131; Merisoprol Acetate Hg 197; Merisoprol Acetate Hg 203; Merisoprol Hg 197; Selenomethionine Se 75; Technetium Tc 99m Antimony Trisulfide Colloid; Technetium Tc 99m Bicisate; Technetium Tc 99m Disofenin; Technetium Tc 99m Etidronate; Technetium Tc 99m Exametazime; Technetium Tc 99m Furifosmin; Technetium Tc 99m Gluceptate; Technetium Tc 99m Lidofenin; Technetium Tc 99m Mebrofenin; Technetium Tc 99m Medronate; Technetium Tc 99m Medronate Disodium; Technetium Tc 99m Mertiatide; Technetium Tc 99m Oxidronate; Technetium Tc 99m Pentetate; Technetium Tc 99m Pentetate Calcium Trisodium; Technetium Tc 99m Sestamibi; Technetium Tc 99m Siboroxime; Technetium Tc 99m Succimer; Technetium Tc 99m sulfur Colloid; Technetium Tc 99m Teboroxime; Technetium Tc 99m Tetrofosmin; Technetium Tc 99m Tiatide; Thyroxine I 125; Thyroxine I 131; Tolpovidone I 131; Triolein I 125; and Triolein I 131).

Additional anti-cancer agents include, but are not limited to anti-cancer Supplementary Potentiating Agents: Tricyclic anti-depressant drugs (e.g., imipramine, desipramine, amitryptyline, clomipramine, trimipramine, doxepin, nortriptyline, protriptyline, amoxapine and maprotiline); non-tricyclic anti-depressant drugs (e.g., sertraline, trazodone and citalopram); Ca⁺⁺ antagonists (e.g., verapamil, nifedipine, nitrendipine and caroverine); Calmodulin inhibitors (e.g., prenylamine, trifluoroperazine and clomipramine); Amphotericin B; Triparanol analogues (e.g., tamoxifen); antiarrhythmic drugs (e.g., quinidine); antihypertensive drugs (e.g., reserpine); Thiol depleters (e.g., buthionine and sulfoximine) and Multiple Drug Resistance reducing agents such as Cremaphor EL. Still other anticancer agents include, but are not limited to, annonaceous acetogenins; asimicin; rolliniastatin; guanacone, squamocin, bullatacin; squamotacin; taxanes; paclitaxel; gemcitabine; methotrexate FR-900482; FK-973; FR-66979; FK-317; 5-FU; FUDR; FdUMP; Hydroxyurea; Docetaxel; discodermolide; epothilones; vincristine; vinblastine; vinorelbine; meta-pac; irinotecan; SN-38; 10-OH campto; topotecan; etoposide; adriamycin; flavopiridol; C is —Pt; carbo-Pt; bleomycin; mitomycin C; mithramycin; capecitabine; cytarabine; 2-C1-2′ deoxyadenosine; Fludarabine-PO₄; mitoxantrone; mitozolomide; Pentostatin; and Tomudex. One particularly preferred class of anticancer agents are taxanes (e.g., paclitaxel and docetaxel). Another important category of anticancer agent is annonaceous acetogenin.

In some embodiments, the composition is co-administered with a pain relief agent. In some embodiments, the pain relief agents include, but are not limited to, analgesic drugs, anxiolytic drugs, anesthetic drugs, antipsychotic drugs, hypnotic drugs, sedative drugs, and muscle relaxant drugs.

In some embodiments, the analgesic drugs include, but are not limited to, non-steroidal anti-inflammatory drugs, COX-2 inhibitors, and opiates. In some embodiments, the non-steroidal anti-inflammatory drugs are selected from the group consisting of Acetylsalicylic acid (Aspirin), Amoxiprin, Benorylate/Benorilate, Choline magnesium salicylate, Diflunisal, Ethenzamide, Faislamine, Methyl salicylate, Magnesium salicylate, Salicyl salicylate, Salicylamide, arylalkanoic acids, Diclofenac, Aceclofenac, Acemethacin, Alclofenac, Bromfenac, Etodolac, Indometacin, Nabumetone, Oxametacin, Proglumetacin, Sulindac, Tolmetin, 2-arylpropionic acids, Ibuprofen, Alminoprofen, Benoxaprofen, Carprofen, Dexibuprofen, Dexketoprofen, Fenbufen, Fenoprofen, Flunoxaprofen, Flurbiprofen, Ibuproxam, Indoprofen, Ketoprofen, Ketorolac, Loxoprofen, Naproxen, Oxaprozin, Pirprofen, Suprofen, Tiaprofenic acid), N-arylanthranilic acids, Mefenamic acid, Flufenamic acid, Meclofenamic acid, Tolfenamic acid, pyrazolidine derivatives, Phenylbutazone, Ampyrone, Azapropazone, Clofezone, Kebuzone, Metamizole, Mofebutazone, Oxyphenbutazone, Phenazone, Sulfinpyrazone, oxicams, Piroxicam, Droxicam, Lornoxicam, Meloxicam, Tenoxicam, sulphonanilides, nimesulide, licofelone, and omega-3 fatty acids. In some embodiments, the COX-2 inhibitors are selected from the group consisting of Celecoxib, Etoricoxib, Lumiracoxib, Parecoxib, Rofecoxib, and Valdecoxib. In some embodiments, the opiate drugs are selected from the group consisting of natural opiates, alkaloids, morphine, codeine, thebaine, semi-synthetic opiates, hydromorphone, hydrocodone, oxycodone, oxymorphone, desomorphine, diacetylmorphine (Heroin), nicomorphine, dipropanoylmorphine, diamorphine, benzylmorphine, Buprenorphine, Nalbuphine, Pentazocine, meperidine, diamorphine, ethylmorphine, fully synthetic opioids, fentanyl, pethidine, Oxycodone, Oxymorphone, methadone, tramadol, Butorphanol, Levorphanol, propoxyphene, endogenous opioid peptides, endorphins, enkephalins, dynorphins, and endomorphins.

In some embodiments, the anxiolytic drugs include, but are not limited to, benzodiazepines, alprazolam, bromazepam (Lexotan), chlordiazepoxide (Librium), Clobazam, Clonazepam, Clorazepate, Diazepam, Midazolam, Lorazepam, Nitrazepam, temazepam, nimetazepam, Estazolam, Flunitrazepam, oxazepam (Serax), temazepam (Restoril, Normison, Planum, Tenox, and Temaze, Triazolam, serotonin 1A agonists, Buspirone (BuSpar), barbituates, amobarbital (Amytal), pentobarbital (Nembutal), secobarbital (Seconal), Phenobarbital, Methohexital, Thiopental, Methylphenobarbital, Metharbital, Barbexaclone), hydroxyzine, cannabidiol, valerian, kava (Kava Kava), chamomile, Kratom, Blue Lotus extracts, Sceletium tortuosum (kanna) and bacopa monniera.

In some embodiments, the anesthetic drugs include, but are not limited to, local anesthetics, procaine, amethocaine, cocaine, lidocaine, prilocalne, bupivacaine, levobupivacaine, ropivacaine, dibucaine, inhaled anesthetics, Desflurane, Enflurane, Halothane, Isoflurane, Nitrous oxide, Sevoflurane, Xenon, intravenous anesthetics, Barbiturates, amobarbital (Amytal), pentobarbital (Nembutal), secobarbital (Seconal), Phenobarbital, Methohexital, Thiopental, Methylphenobarbital, Metharbital, Barbexaclone)), Benzodiazepines, alprazolam, bromazepam (Lexotan), chlordiazepoxide (Librium), Clobazam, Clonazepam, Clorazepate, Diazepam, Midazolam, Lorazepam, Nitrazepam, temazepam, nimetazepam, Estazolam, Flunitrazepam, oxazepam (Serax), temazepam (Restoril, Normison, Planum, Tenox, and Temaze), Triazolam, Etomidate, Ketamine, and Propofol.

In some embodiments, the antipsychotic drugs include, but are not limited to, butyrophenones, haloperidol, phenothiazines, Chlorpromazine (Thorazine), Fluphenazine (Prolixin), Perphenazine (Trilafon), Prochlorperazine (Compazine), Thioridazine (Mellaril), Trifluoperazine (Stelazine), Mesoridazine, Promazine, Triflupromazine (Vesprin), Levomepromazine (Nozinan), Promethazine (Phenergan)), thioxanthenes, Chlorprothixene, Flupenthixol (Depixol and Fluanxol), Thiothixene (Navane), Zuclopenthixol (Clopixol & Acuphase)), clozapine, olanzapine, Risperidone (Risperdal), Quetiapine (Seroquel), Ziprasidone (Geodon), Amisulpride (Solian), Paliperidone (Invega), dopamine, bifeprunox, norclozapine (ACP-104), Aripiprazole (Abilify), Tetrabenazine, and Cannabidiol.

In some embodiments, the hypnotic drugs include, but are not limited to, Barbiturates, Opioids, benzodiazepines, alprazolam, bromazepam (Lexotan), chlordiazepoxide (Librium), Clobazam, Clonazepam, Clorazepate, Diazepam, Midazolam, Lorazepam, Nitrazepam, temazepam, nimetazepam, Estazolam, Flunitrazepam, oxazepam (Serax), temazepam (Restoril, Normison, Planum, Tenox, and Temaze), Triazolam, nonbenzodiazepines, Zolpidem, Zaleplon, Zopiclone, Eszopiclone, antihistamines, Diphenhydramine, Doxylamine, Hydroxyzine, Promethazine, gamma-hydroxybutyric acid (Xyrem), Glutethimide, Chloral hydrate, Ethchlorvynol, Levomepromazine, Chlormethiazole, Melatonin, and Alcohol.

In some embodiments, the sedative drugs include, but are not limited to, barbituates, amobarbital (Amytal), pentobarbital (Nembutal), secobarbital (Seconal), Phenobarbital, Methohexital, Thiopental, Methylphenobarbital, Metharbital, Barbexaclone), benzodiazepines, alprazolam, bromazepam (Lexotan), chlordiazepoxide (Librium), Clobazam, Clonazepam, Clorazepate, Diazepam, Midazolam, Lorazepam, Nitrazepam, temazepam, nimetazepam, Estazolam, Flunitrazepam, oxazepam (Serax), temazepam (Restoril, Normison, Planum, Tenox, and Temaze), Triazolam, herbal sedatives, ashwagandha, catnip, kava (Piper methysticum), mandrake, marijuana, valerian, solvent sedatives, chloral hydrate (Noctec), diethyl ether (Ether), ethyl alcohol (alcoholic beverage), methyl trichloride (Chloroform), nonbenzodiazepine sedatives, eszopiclone (Lunesta), zaleplon (Sonata), zolpidem (Ambien), zopiclone (Imovane, Zimovane)), clomethiazole (clomethiazole), gamma-hydroxybutyrate (GHB), Thalidomide, ethchlorvynol (Placidyl), glutethimide (Doriden), ketamine (Ketalar, Ketaset), methaqualone (Sopor, Quaalude), methyprylon (Noludar), and ramelteon (Rozerem).

In some embodiments, the muscle relaxant drugs include, but are not limited to, depolarizing muscle relaxants, Succinylcholine, short acting non-depolarizing muscle relaxants, Mivacurium, Rapacuronium, intermediate acting non-depolarizing muscle relaxants, Atracurium, Cisatracurium, Rocuronium, Vecuronium, long acting non-depolarizing muscle relaxants, Alcuronium, Doxacurium, Gallamine, Metocurine, Pancuronium, Pipecuronium, and d-Tubocurarine.

In some embodiments, the composition is co-administered with a pain relief agent antagonist. In some embodiments, the pain relief agent antagonists include drugs that counter the effect of a pain relief agent (e.g., an anesthetic antagonist, an analgesic antagonist, a mood stabilizer antagonist, a psycholeptic drug antagonist, a psychoanaleptic drug antagonist, a sedative drug antagonist, a muscle relaxant drug antagonist, and a hypnotic drug antagonist). In some embodiments, pain relief agent antagonists include, but are not limited to, a respiratory stimulant, Doxapram, BIMU-8, CX-546, an opiod receptor antagonist, Naloxone, naltrexone, nalorphine, levallorphan, cyprodime, naltrindole, norbinaltorphimine, buprenorphine, a benzodiazepine antagonist, flumazenil, a non-depolarizing muscle relaxant antagonist, and neostigmine.

### EXAMPLES

The following examples are provided in order to demonstrate and further illustrate certain preferred embodiments and aspects of the present invention and are not to be construed as limiting the scope thereof.

### Example 1

Previous experiments involving dendrimer related technologies are located in U.S. Pat. Nos. 6,471,968, 7,078,461, and U.S. patent application Ser. Nos. 09/940,243, 10/431,682, 11,503,742, 11,661,465, 11/523,509, 12/403,179, 12/106,876, 11/827,637, U.S. Provisional Patent Application Ser. Nos. 61/140,840, 61/091,608, 61/097,780, 61/101,461, 61/251,244; each herein incorporated by reference in their entireties.

### Example 2

### The Implications of Stochastic Synthesis for the Conjugation of Functional Groups to Nanoparticles

### Materials, Methods, and Mathematical Modeling

### Dendrimer Purification

Generation 5 PAMAM dendrimer was purchased from Dendritech Inc. To remove lower molecular weight impurities and trailing generations the dendrimer was dialysed with a 10,000 MWCO membrane against deionized water for three days, exchanging washes every 4 hours. The number average molecular weight (27,336 g/mol) and PDI (1.018+/−0.014) was determined by gel permeation chromatography (GPC). Potentiometric titration was conducted to determine the average number of primary amines (112).

### Partial Acetylation

Purified Generation 5 PAMAM dendrimer (133.7 mg, 4.89 μmole) was dissolved in anhydrous methanol (21 mL). Triethylamine (68.5 μL, 0.491 mmole) was added to this mixture and stirred for 30 minutes. Acetic anhydride (37.1 μL, 0.393 mmole) was added to anhydrous methanol (4 mL) and the resulting mixture was added in a dropwise manner to the dendrimer solution. The reaction was carried out in a glass flask, under nitrogen, at room temperature for 24 hours. Methanol was evaporated from the resulting solution and the product was purified using 10,000 MWCO centrifugal filtration devices. Purification consisted of five cycles (30 minutes at 5,000 rpm) using 1×PBS and five cycles using deionized water. The purified dendrimer was lyophilized for three days to yield a white solid (138.4 mg, 92%). Number average molecular weight (30,660 g/mol) and PDI (1.026+/−0.015) were determined by GPC. ¹H NMR integration determined the degree of acetylation to be 70%.

### Ligand Synthesis (3-(4-(prop-2-ynyloxy)phenyl)propanoic acid)

To a solution of methyl 3-(4-hydroxyphenyl)propanoate (2.18 g, 0.0121 mol) in dry acetone (56 mL) was added anhydrous K₂CO₃ (4.60 g, 0.0333 mol) followed by propargyl bromide (80% solution in toluene, 1.88 mL, 0.0126 mol). The resulting suspension was refluxed for 24 h with vigorous stirring. The reaction mixture was cooled to room temperature and the salt was removed by filtration followed by washing with portions of EtOAc. The filtrate was evaporated under vacuum to give the desired product as an oil (2.43 g, 92%).

The crude product from above was dissolved in MeOH (60 mL). KOH (8 M, 5.0 mL, 0.040 mol) was added and the resulting mixture was heated at 70° C. for 1.5 h. The solution was cooled to room temperature and condensed under reduced pressure. The residue was dissolved in water (30 mL) and was acidified by addition of 1N HCl to pH 1. The white cloudy solution was diluted with EtOAc. Layers were separated and the aqueous layer was extracted with EtOAc (2×70 mL). The combined organic extracts were washed with a saturated NaCl solution and dried over MgSO4. Solvent was evaporated under reduced pressure to give the desired product as a yellowish solid. (2.21 g, 97%).

¹H NMR (500 MHz, CDCl₃) δ 7.12, (d, 2H, J=8.74 Hz), 6.89 (d, 2H, J=8.71 Hz), 6.89 (d, 2H, J=8.71 Hz), 4.65 (d, 2H, J=2.40 Hz), 2.89 (t, 2H, J=7.74 Hz), 2.64 (t, 2H, J=7.75 Hz), 2.49 (t, 1H, J=2.40 Hz)

### Ligand Conjugation to Dendrimer

The ligand was conjugated to the partially acetylated dendrimer in two consecutive reactions. First, a stock solution of the ligand 3-(4-(prop-2-ynyloxy)phenyl)propanoic acid (9.4 mg, 0.046 mmole) was generated with a mixture of DMF (6.899 mL) and DMSO (2.300 mL). To this mixture was added 1-Ethyl-3-[3-dimethylaminopropyl]carbodiimide hydrochloride (EDC) (123.5 mg, 0.644 mmole). The resulting solution was stirred for 4 h at room temperature to create the active ester form of the ligand.

A stock solution of partially acetylated dendrimer (77.1 mg, 2.51 μmole) was made with deionized water (17.190 mL). This solution was partitioned into four aliquots, A-D (15.0 mg, 0.489 μmole each). Additional deionized water (2.520 mL, 2.016 mL, 1.512 mL) was added to the first three aliquots (A-C). The active ester form of the ligand (0.504 mL, 2.521 μmole) in DMF/DMSO was added in a dropwise manner (0.1 mL/min) to the first aliquot (A) of dendrimer-water solution. Similarly, the activated ester form of the ligand was added to the second, third, and fourth aliquots (5.043 μmole, 7.565 μmole, and 10.087 μmole respectively). The resulting mixtures were stirred for 2.5 days. All reaction steps were carried out in glass flasks at room temperature under nitrogen. The four reaction mixtures were purified using 10,000 MWCO centrifugal filtration devices. Purification consisted of five cycles using 1×PBS and six cycles using deionized water. All cycles were 30 minutes at 5,000 rpm. The resulting products (A-D) were lyophilized for three days to yield a white solid (14.6 mg, 16.5 mg, 15.7 mg, and 15.5 mg respectively).

### HPLC Characterization

HPLC analysis was carried out on a Waters Delta 600 HPLC system equipped with a Waters 2996 photodiode array detector, a Waters 717 Plus auto sampler, and Waters Fraction collector III. The instrument was controlled by Empower 2 software. For analysis of the conjugates, a C5 silica-based RP-HPLC column (250×4.6 mm, 300 Å) connected to a C5 guard column (4×3 mm) was used. The mobile phase for elution of the conjugates was a linear gradient beginning with 90:10 (v/v) water/acetonitrile and ending with 10:90 (v/v) water/acetonitrile over 25 min at a flow rate of 1 mL/min. Trifluoroacetic acid (TFA) at 0.14 wt % concentration in water as well as in acetonitrile was used as a counter ion to make the dendrimer surfaces hydrophobic.

To determine the experimental error associated with the HPLC characterization, Sample D was injected five times over two days under identical conditions. The absorbance data was normalized against the major peak for each injection and standard deviations were computed at each time point. The standard deviations were normalized against absorbance and the average error in the range between 12.5 and 15.5 minutes was computed to be 4%.

### Beer's Law: Dilution Study

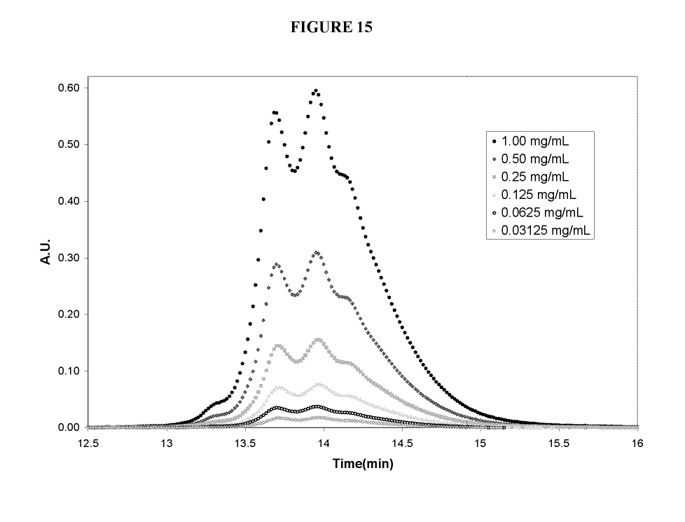

A dilution study of Sample D was performed to demonstrate that the dendrimer conjugates follow Beer's Law at 210 nm. Solutions of Sample D with different concentrations were injected on the HPLC using the conditions detailed supra. The elution profile at 210 nm of Sample D at varying concentrations can be found in FIG. 15.

### Characterization by Gel Permeation Chromatography (GPC)

GPC analysis was performed on the four dendrimer-ligand samples and the partially acetylated dendrimer using an Alliance Waters 2690/2695 separations module (Waters Corp., Milford, Mass.) equipped with a Waters 2487 UV absorbance detector (Waters Corp.), a Wyatt Dawn DSP laser photometer (Wyatt Technology Corp., Santa Barbara, Calif.), an Optilab DSP interferometric refractometer (Wyatt Technology Corp.), and TosoHaas TSK-Gel Guard PHW 06762 (75×7.5 mm, 12 μm), G 2000 PW 05761 (300×7.5 mm, 10 μm), G 3000 PW 05762 (300×7.5 mm, 10 μm), and G 4000 PW (300×7.5 mm, 17 μm) columns. Citric acid buffer (0.1 M concentration) with 0.025% sodium azide in water was used as a mobile phase, pH 2.74, using NaOH. Number Average Molecular Weight (Mn) and the Poly Dispersity Index (PDI) for each of the samples was calculated by using Astra software (version 4.9) (Wyatt Technology Corp.) and reported in Table 1 infra. The general trend of increasing molecular weight is consistent with samples of increasingly higher averages of conjugated ligands.

TABLE 1
Number Average Molecular Weight and PDI calculated from GPC for the
Dendrimer-Ligand conjugates

| | Mn | PDI |
|---|---|---|
| G5Ac (70%) | 30,660 | 1.026 ± 0.015 |
| Sample A | 32,560 | 1.026 ± 0.012 |
| Sample B | 33,200 | 1.025 ± 0.012 |
| Sample C | 33,960 | 1.034 ± 0.012 |
| Sample D | 35,080 | 1.024 ± 0.012 |

Molecular Weight Characterization of the Dendrimer-Ligand conjugates and Starting Material by MALDI-TOF

The four dendrimer-ligand samples and the partially acetylated dendrimer were characterized with a Micromass T of Spec-2E Matrix-Assisted, Laser-Desorption Time-of-Flight Mass Spectrometer. Spectra were acquired in Linear mode. The MALDI-TOF sample mixtures were prepared using 5 μL of the matrix trihydroxyacetophenone in amounts of water and acetonitrile (10 mg/mL), and 5 μL of the dendrimer in equal amounts of water and methanol (1 mg/mL). Each spot volume was 1 μL. Data summing and smoothing was applied post acquisition to each set of spectra. All processed spectra were normalized to the peak maximum.

### Additional HPLC Profiles

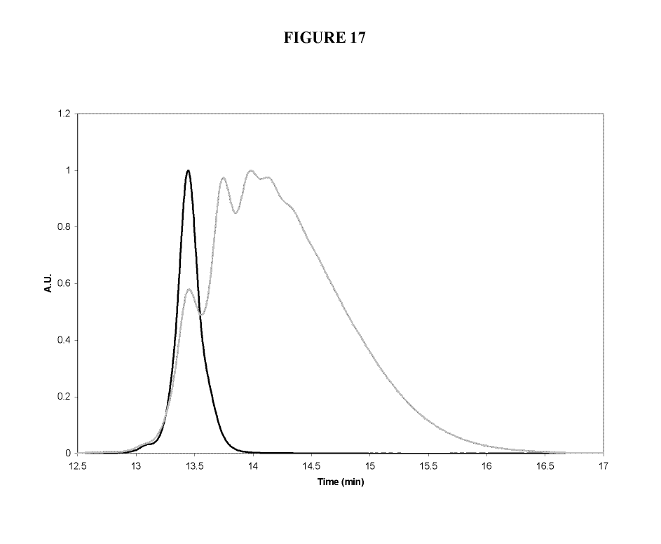

The HPLC profiles for partially acetylated dendrimer and a dendrimer-ligand conjugate with an average of 3.1 ligands can be found in FIG. 17. Synthesis of the partially acetylated dendrimer is described supra. The dendrimer-ligand conjugate with an average of 3.1 ligands was synthesized following the procedure described for the four dendrimer-ligand samples described herein (Example 2). Partially acetylated dendrimer for this dendrimer-ligand conjugate was 74% acetylated. A linear baseline subtraction was applied to both data sets and peak maxima were normalized.

### The Two Path Kinetic Model

Suppose a dendrimer has n ligands bound, but where n is small compared to total number of dendrimer branches M=112. Should another ligand encounter this dendrimer, there are two most probable avenues, that the ligand attaches to an available branch far from the influence of already-attached ligands, and that the ligand binds near a previously attached ligand. Given the low occupancy, the possibility of a ligand binding near more than one other ligand is discounted.

Each avenue has an associated rate of attachment depending upon the probability of encountering such a site, the activation energy barrier, and an underlying collision frequency w that is assumed to be the same for the two paths. The two parallel paths give two rate contributions, Rₙ₁ and Rₙ₂, such that the total rate Rₙ=Rₙ₁+Rₙ₂.

The probability p₂ of a ligand binding at a site near a previously bound ligand is given by p₂=nze^{-E}^{ₐ₂}^{/RT}, where z is the effective coordination number, the number of sites a bonded ligand influences, and Eₐ₂ is the activation energy barrier for this pathway, a value influenced by the proximity to the bound ligand. This leads to the rate Rₙ₂=nA₂e^{-E}^{ₐ₂}^{/RT} by multiplying with ω, giving the association of A₂=zω.

The probability p₁ of a ligand binding to one of the other available sites is the probability of encountering an open site that doesn't belong to the other pathway. That is, p₁=[m−n(z+1)]e^{-E}^{ₐ₂}^{/RT}, where m=34 is the number of non-acetylated sites, and Eₐ₁ is the activation energy barrier for this unassisted pathway. The term n(z+1)=nz+n has a contribution from discounting sites under the influence of a bound ligand, nz, and the sites at which the previously bound ligands are bound, giving the n term. This leads to the rate Rₙ₁=A₁e^{-E}^{ₐ₂}^{/RT} with the association A₁=[m−n(z+1)]ω.

The effective coordination number z depends on the arrangement of the dendrimer branches and the number of those branches which are not acetylated. If first nearest neighbor interactions are considered, the end of a given branch may be near a handful of others, say between four and six. It is expected that m/M=30% of these branches are ligated or open to ligation. Therefore, the effective coordination number is a number of order unity, say between one and two.

A numerical estimate of the effective coordination results in z=0.9. This estimate was generated by randomly populating a 10×10 triangular (close-packed) lattice with 30 sites, then counting the number of neighbors each site had. This process was sampled 10 000 times, giving a low-skewed distribution of numbers of neighbors with the average being 0.9. This results in a range of values for A₂/A₁ from 0.0025 to 0.1 for n between 1 and 10, with an average value of 0.04.

### Fitting the Model

The Master equation ċₙ=Rₙ₋₁cₙ₋₁−Rₙcₙ was numerically integrated using an Euler method for 1000 steps. The time step is arbitrary, since the time derivative in the equation is only known to a constant of proportionality that is absorbed into A₁ and A₂ for each data set. Integrating for 10 000 steps instead of 1000 does not significantly change the result. A non-linear least-squares fit was conducted simultaneously for the four data sets, resulting in the following fitted values for the parameters.

| | Fitted Value |
|---|---|
| $\frac{\text{?}}{\text{?}} \text{?}$ $\text{?} \text{indicates text missing or illegible when filed}$ | 0.58 |
| L₁ | 2.0 E − 5 |
| L₂ | 4.7 E − 5 |
| L₃ | 7.4 E − 5 |
| L₄ | 9.8 E − 5 |

A significant confirmation of the model is the recovery of the ligand concentration ratios. The constants L₁, L₂, L₃, L₄ are proportional to the ligand concentrations, though the constant of proportionality is not independently recoverable. Therefore, normalizing each by L₄, and normalizing the ligand concentrations by the amount used in the most concentrated data set allow comparable values.

| | Fitted Values | Actual Values |
|---|---|---|
| L₁/L₄ | 0.20 | 0.25 |
| L₂/L₄ | 0.47 | 0.5 |
| L₃/L₄ | 0.75 | 0.75 |

The prediction for this method is a difference between the activation energy barriers of the two paths in the model. From the fit (A₂/A₁)e^{-(E}^{ₐ₂}^{-E}^{ₐ₁}^{)/RT}=0.58, one can solve for the energy difference (Eₐ₁−Eₐ₂)=RT log(0.58(A₁/A₂)). After finding an estimate for A₁/A₂=10, one finds the energy difference Eₐ₁−Eₐ₂=6.2±1.5 kJ/mol.

Stochastic ligand conjugation is a common strategy to produce practical quantities of functionalized nanoparticles. Analytical methods used to quantify the average nanoparticle to ligand ratio (such as NMR, UV/visible spectroscopy, and elemental analysis) do not provide information about the distribution of ligands bound to each particle. In experiments conducted during the course of developing some embodiments of the present invention, the HPLC trace of the conjugated nanoparticle as analyzed quantitatively, including “tailing” effects, to show that the heterogeneity implied by the entire trace is consistent with theoretical expectations regarding the dispersity of the sample. The width of the distribution exceeds expectations regarding sample homogeneity and is not well represented by a conjugated nanoparticle showing the average number of conjugated ligands.

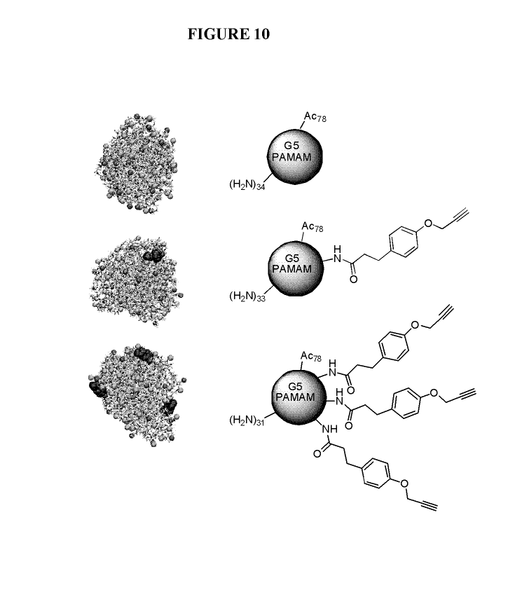

A series of reactions were conducted to conjugate varying amounts of 3-(4-(prop-2-ynyloxy)phenyl)propanoic acid to the surface primary amines of a partially acetylated generation 5 poly(amidoamine) dendrimer (G5 PAMAM; G5(Ac)78(NH2)34) (FIG. 10). This ligand is suitable for “click” chemistry applications. These products were analyzed by ¹H NMR spectroscopy and HPLC. The ¹H NMR analysis, when combined with gel permeation chromatography (GPC) and potentiometic titration data, gave information about the average number of ligands bound per particle. The HPLC data, when combined with a peak fitting analysis, provided both the distribution of ligands per dendrimer and the average number of ligands per dendrimer.

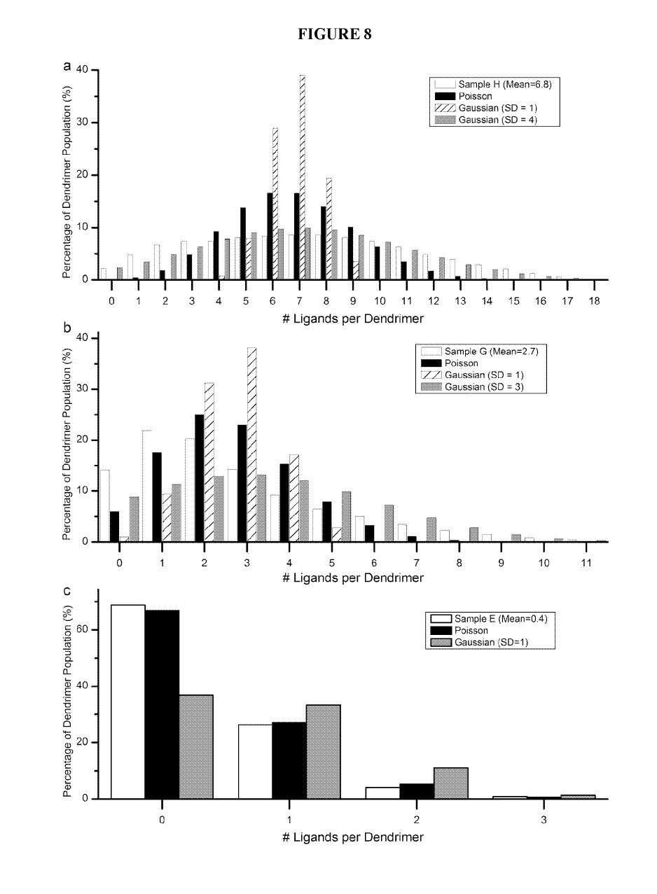

The ligand-dendrimer conjugates (samples A-D) were determined to have an average of 0.20, 0.60, 1.04, and 1.47 ligands per dendrimer by comparing the integration of the methyl protons in the terminal acetyl groups to the aromatic protons on the conjugated ligand (FIG. 8). The number of acetyl groups per dendrimer was independently determined by first computing the total number of end groups from the number average molecular weight (GPC) and potentiometric titration data for G5-NH2 (100%) as previously described (Majoros et al. (2005) J. Med. Chem. 48:5892-5899; herein incorporated by reference in its entirety). This value for the total number of end groups was applied to the ratio of primary amines to acetyl groups, obtained from the ¹H NMR of the partially acetylated dendrimer, to compute the average number of acetyl groups per dendrimer. This determination is sensitive to both the total number of particle functional groups and the number that have been acetylated. The excellent dispersity characteristics of PAMAM dendrimers (PDI=1.01) greatly facilitated this analysis.

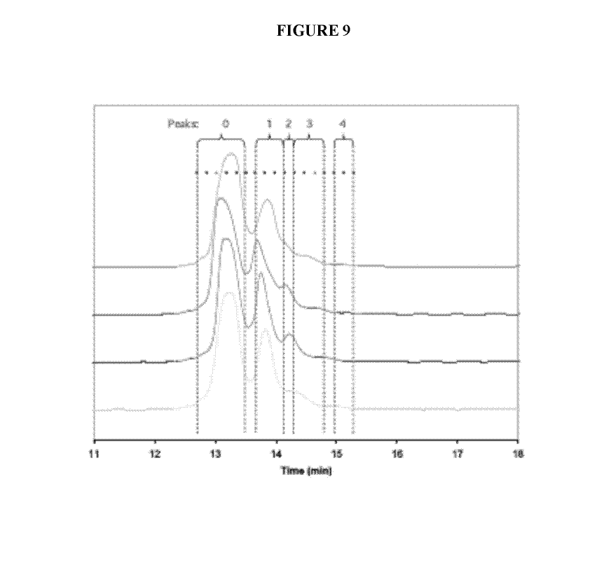

The HPLC elution profiles obtained at 210 nm for samples A-D are illustrated in FIG. 9, solid traces. The 210 nm wavelength was selected because it is convenient for monitoring the PAMAM dendrimers and was not significantly affected by varying amounts of conjugated ligands (Islam et al. (2005) J. Chromatogr., B:Anal. Technol. Biomed. Life Sci. 822:21-26; herein incorporated by reference in its entirety). The first large peak (0) appeared at an elution time consistent with unmodified G5(Ac)₇₈(NH₂)₃₄. The small peaks preceding peak 0 were also present in the original G5(Ac)₇₈(NH²)₃₄ sample and likely resulted from a small amount of lower generation dendrimer (Shi et al. (2006) Analyst 131:842-848; herein incorporated by reference in its entirety). The second large peak (1) was preliminarily assigned as G5(Ac)₇₈(NH₂)₃₃(L)₁ (L=NHCO(CH₂)₂C₆H₄OCH₂C₂H) based upon elution order (FIG. 9, solid traces A-D). Additional data supporting this assignment were obtained from the elution profile monitored at 276 nm (sample D, dashed trace). At 276 nm, an absorbance maximum for the ligand with minimal contribution from the dendrimer, peak 0 (G5(Ac)₇₈(NH₂)₃₄), largely disappeared as anticipated for dendrimer with no ligand conjugated. In this case, the first major feature observed (peak 1) was assigned as dendrimer containing one conjugated ligand (G5(Ac)₇₈(NH₂)₃₃(L)₁). This is consistent with the assignment obtained based on monitoring dendrimer at 210 nm.

For the HPLC traces monitoring concentration of dendrimer at 210 nm, up to three distinct species were clearly resolved with a fourth apparent as an inflection point in trace D. Since the absorbance at 210 nm scales linearly with dendrimer concentration, the area of each absorbance peak can be used to obtain the relative concentration of each different dendrimer-ligand conjugate. Dilution studies of the conjugates demonstrated that Beer's law is followed and that each of the fitted peaks has the same extinction coefficient (supra). The data taken at 276 nm confirmed the HPLC peak assignments but could not be used quantitatively for concentration determinations because each dendrimer-ligand conjugate generated a dramatically different local concentration of ligand, thus causing a deviation from Beer's law.

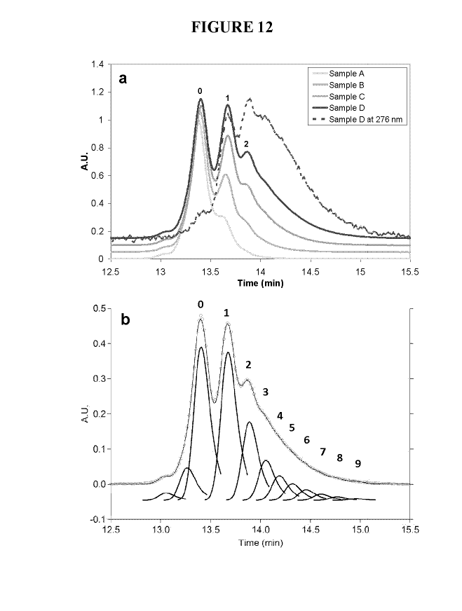

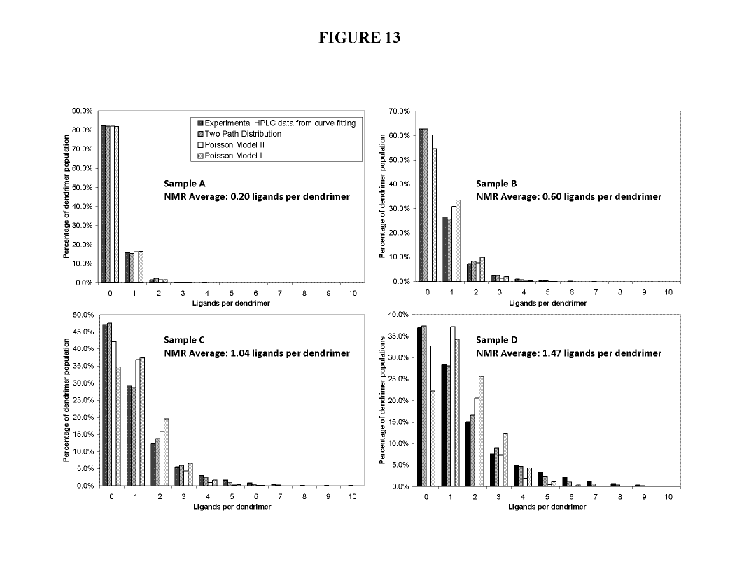

In order to quantitatively assess the relative concentration of each dendrimer-ligand conjugate present, it was necessary to apply a peak fitting procedure to the HPLC traces. The functional form of the dendrimer peaks was determined by fitting the elution profile of acylated dendrimer (G5(Ac)₇₈(NH₂)₃₄) using Igor Pro 6.01. The peak shape, a Gaussian with an exponential decay tail to the right side of the elution peak, was then applied uniformly to all fitted peaks. The position and area of peaks 0-9 and the two lower generation impurity peaks at ˜13 min were not constrained. The fit for sample D, which has a 1.47 ligand/dendrimer ratio measured by ¹H NMR spectroscopy, is illustrated in FIG. 12b. From these fits, the relative concentration of each dendrimer/ligand conjugate was determined (FIG. 13) as well as the average ligand/dendrimer ratio (Table 2).

TABLE 2
Comparison of the average number of ligands per dendrimer independently
computed by NMR and HPLC techniques with the three statistical models.

| | | | | | two- |
|---|---|---|---|---|---|
| | NMR | HPLC | Poisson I | Poisson II | path |
| | average | average^{a} | (χ² = 66)^{b} | (χ² = 47) | (χ² = 9) |
| sample A | 0.20 ± 0.02 | 0.20 ± 0.01 | 0.20 | 0.21 | 0.21 |
| sample B | 0.60 ± 0.06 | 0.54 ± 0.02 | 0.60 | 0.53 | 0.54 |
| sample C | 1.04 ± 0.10 | 0.98 ± 0.04 | 1.04 | 0.91 | 0.93 |
| sample D | 1.47 ± 0.15 | 1.45 ± 0.06 | 1.47 | 1.17 | 1.32 |

^{a}Determination of HPLC error is discussed in Materials and Methods, supra
^{b}The Poisson I model used the experimental NMR averages as input parameters

The relative proportions of dendrimer species, resolved by HPLC and quantified through fitted peaks, were used to calculate a weighted average number of ligands per dendrimer. Table 2 displays this for each of the dendrimer-ligand conjugates. This weighted average is in excellent agreement with the average determined independently by the combined NMR/GPC/titration analysis. Indeed, it is this comparison that gives confidence in the physical meaning of the peak fitting procedure. Significantly, the HPLC data produced additional distribution information that could not be extracted from the combined NMR/GPC/titration analysis.

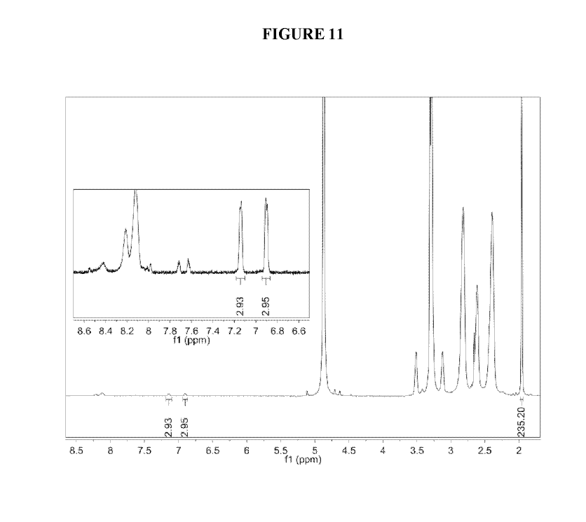

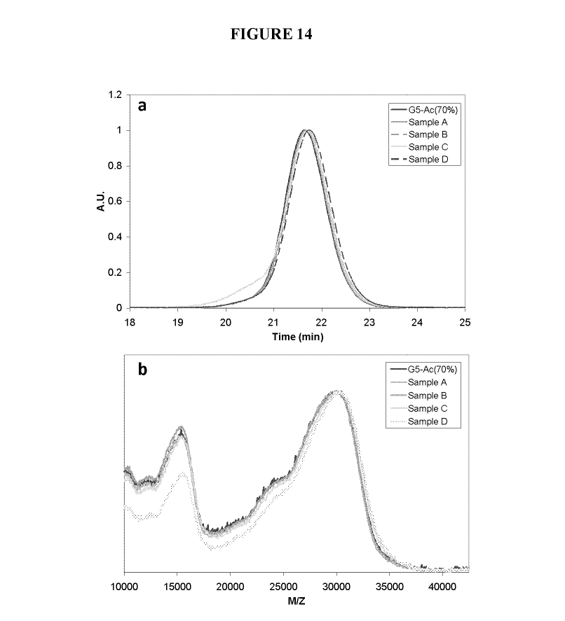

The resolution of the various conjugated species by HPLC stands in stark contrast to the results obtained by NMR (FIG. 11) in which no resolution of the various numbers of ligands conjugated was obtained. Gel permeation chromatography (GPC) exhibited a trend toward longer retention time but did not resolve the components (FIG. 14a). The longer retention time indicated that the conjugates were effectively smaller, as measured by GPC, although the light scattering and refractive index detectors verified that the mass had increased upon conjugation.

MALDI-TOF MS also exhibited a trend to higher mass, but once again, the individual components were not resolved (FIG. 14b).

Three statistical models were employed for comparison with the experimentally determined distributions (310, Table 2). Poisson model I assumed that ligand conjugation with the nanoparticle proceeded in a stochastic fashion. The total number of available attachment points on the dendrimer surface (34) and the average ligand/dendrimer ratio determined by NMR were used as input. This fit gave a χ² per degree of freedom of 66. In Poisson model II, the ligand/dendrimer ratios were allowed to vary as fitting parameters in a simultaneous χ² minimization using all four data sets. This fit gave a χ₂ per degree of freedom of 47. Both Poisson models match the 0.20 and 0.60 ligand/dendrimer distributions quite well but began to deviate from the experimental data as the ligand/dendrimer ratio increased.

In order to better reproduce the experimental ligand distributions, a two-path kinetic model was used (see Materials, Methods and Mathematical Modeling supra). It allowed for deviations from the Poisson distribution by varying the activation energy of the reaction as a function of n ligands on the nanoparticle (eq 1). This two-path model was also motivated by previous publications that indicate product amide autocatalysis should be expected for this reaction (Menger et al. (1994) J. Am. Chem. Soc. 116:3613-3614; Menger et al. (1995) J. Org. Chem. 60:2870-2878; Titskii et al. (1970) Zh. Obshch. Khim. 40:2680-2688; each herein incorporated by reference in its entirety).

Rₙ=A₁e^{-E}^{ₐ₁}^{/(RT)}+nA₂e^{-E}^{ₐ₂}^{/(RT)} (equation 2)

The two paths corresponded to attaching a ligand far from other ligands or near enough to previously attached ligands so that the barrier for attachment was reduced. These rates were fed into a master equation for the concentrations, cₙ, of dendrimers with n ligands attached:

ċₙ=Rₙ₋₁cₙ₋₁−Rₙcₙ.

A_{1,2} were adjusted to account for the number of available sites for the two paths. The solutions of the master equations were fit to all four data sets simultaneously using five independent parameters (Eₐ₁-Eₐ₂, and four independent values for the A parameters), resulting in a χ² per degree of freedom of 9. The best fit reproduced the experimental changes in concentration, which is a strong confirmation that the approach had physical meaning for this system. The difference in activation barrier between the two paths could be extracted from the fit and was determined to be Eₐ₁-Eₐ₂=6.2±1.5 kJ/mol or 0.064±0.016 eV.

Typically, analyses of functionalized nanoparticles only determine the average number of ligands per nanoparticle. In most cases, even HPLC does not resolve the distribution. Indeed, the “tailing” observed in the plots (FIG. 12) is frequently ascribed to non-ideal interaction between the analyte and the chromatography support. Herein, qualitative and quantitative data are provided to demonstrate that tailing results from the distribution of ligands bound to dendrimers. This is supported by the fact that: (1) no tailing was observed for the partially acetylated sample (see FIG. 17); (2) the lower conversion samples (A, B) exhibited well-defined peaks; (3) dendrimers with a large number of conjugated ligands appeared in “tail” region (see FIG. 17); (4) the HPLC fits quantitatively agreed with the NMR spectra in terms of the assessment of the average number of conjugated ligands.

The resolution of the distribution provided insight into the meaning of average ligand/dendrimer ratios. For the average of 0.20 ligands/dendrimer, the distribution comprised over 81% unmodified dendrimer, about 16% dendrimer with one ligand attached, and less than 3% dendrimer with two ligands, in fairly good accord with common expectations. However, the dendrime-ligand conjugate with an average of 1.47 contained 0-9 ligands per dendrimer with the largest population of dendrimers actually containing no ligands. Both the random distribution and the two-path kinetic model accurately predicted the breadth of the population. These experimentally measured breadths modeled herein challenged the commonly held perceptions that such a sample would comprise a narrower distribution predominantly containing dendrimers with one or two ligands attached. Furthermore, the average number misrepresents the functionally active portion of the dendrimer sample and does not make it apparent that the most common species contains no ligands and would therefore be inactive.

The deviation at larger ligand/dendrimers ratios of the experimental distribution from a Poisson analysis is informative. The conjugation probability would be expected to decrease because of site blocking effects. Thus, the observation of an increased probability is unexpected. A straightforward explanation of the activation energy barrier difference of ˜6 kJ/mol is product amide autocatalysis. This has the implication of creating nonrandom spatial distribution of ligands on the polymer surface.

In experiments presented herein, the ligand/dendrimer distributions arising from conjugation of approximately one ligand on average to a spherical nanoparticle were quantitatively analyzed, with excellent agreement between experimental measurements and theoretical analysis. Accurate determination of these distributions for functional nanomaterials enables more informed applications and predictions of nanoparticle structure, function, and activity. While the present invention is not limited to any particular mechanism, and an understanding of the mechanism is not necessary to practice the present invention, it is contemplated that the details of the conjugation chemistry, site saturation effects, and steric blocking caused by the conjugated ligand affected the distributions obtained.

### Example 3

### Quantitative Assessment of Nanoparticle Ligand Distributions

### Materials and Methods

### Reagents and Materials

Biomedical grade Generation 5 PAMAM (poly(amidoamine)) dendrimer was purchased from Dendritech Inc. and purified as described infra. MeOH (99.8%), acetic anhydride (99.5%), triethylamine (99.5%), dimethyl sulfoxide (99.9%), dimethylformamide (99.8%), acetone (ACS reagent grade≧99.5%), N,N-diisopropylethylamine, benzotriazol-1-yl-oxytripyrrolidinophosphonium hexafluorophosphate (98%), D₂O, and volumetric solutions (0.1 M HCl and 0.1 M NaOH) for potentiometric titration were purchased from Sigma Aldrich Co. and used as received. 10,000 molecular weight cut-off centrifugal filters (Amicon Ultra) were obtained from Fisher Scientific. 1× phosphate buffer saline (PBS) (Ph=7.4) without calcium or magnesium was purchased from Invitrogen. The Alkyne Ligand (3-(4-(prop-2-ynyloxy)phenyl)propanoic acid) was synthesized as described previously (Mullen et al. (2008) Bioconj. Chem. 19:1748-1852; herein incorporated by reference in its entirety).

### Nuclear Magnetic Resonance Spectroscopy

All ¹H NMR experiments were conducted using a Varian Inova 400 MHz instrument. 10 s delay time and 64 scans were set for each dendrimer sample. Temperature was controlled at 25° C. For experiments conducted in D₂O, the internal reference peak was set to 4.717 ppm.

### Gel Permeation Chromatography

GPC experiments were performed on an Alliance Waters 2695 separation module equipped with a 2487 dual wavelength UV absorbance detector (Waters Corporation), a Wyatt HELEOS Multi Angle Laser Light Scattering (MALLS) detector, and an Optilab rEX differential refractometer (Wyatt Technology Corporation). Columns employed were TosoHaas TSK-Gel Guard PHW 06762 (75 mm×7.5 mm, 12 μm), G 2000 PW 05761 (300 mm×7.5 mm, 10 μm), G 3000 PW 05762 (300 mm×7.5 mm, 10 μm), and G 4000 PW (300 mm×7.5 mm, 17 μm). Column temperature was maintained at 25±0.1° C. with a Waters temperature control module. The isocratic mobile phase was 0.1 M citric acid and 0.025 wt % sodium azide, pH 2.74, at a flow rate of 1 mL/min. The sample concentration was 10 mg/5 mL with an injection volume of 100 μL. The weight average molecular weight, M_{w}, was determined by GPC, and the number average molecular weight, Mₙ, was calculated with Astra 5.3.14 software (Wyatt Technology Corporation) based on the molecular weight distribution.

### Reverse Phase High Performance Liquid Chromatography

HPLC analysis was carried out on a Waters Delta 600 HPLC system equipped with a Waters 2996 photodiode array detector, a Waters 717 Plus auto sampler, and Waters Fraction collector III. The instrument was controlled by Empower 2 software. For analysis of the conjugates, a C5 silica-based RP-HPLC column (250×4.6 mm, 300 Å) connected to a C5 guard column (4×3 mm) was used. The mobile phase for elution of the conjugates was a linear gradient beginning with 100:0 (v/v) water/acetonitrile and ending with 20:80 (v/v) water/acetonitrile over 30 min at a flow rate of 1 mL/min. Trifluoroacetic acid (TFA) at 0.14 wt % concentration in water as well as in acetonitrile was used as a counter ion to make the dendrimer surfaces hydrophobic.

### Synthesis

The G5-(NH₂)₁₁₂ dendrimer was conjugated to Ac and Alkyne groups. Ac refers to the acetyl termination, and Alkyne to the Alkyne Ligand.

### 1. Purification of Generation 5 PAMAM Dendrimer G5-(NH₂)₁₁₂

The purchased G5 PAMAM dendrimer was purified by dialysis, as previously described (Mullen et al. (2008) Bioconj. Chem. 19:1748-1852; herein incorporated by reference in its entirety) to remove lower molecular weight impurities including trailing generation dendrimer defect structures. The number average molecular weight (27,336 g/mol) and PDI (1.018+/−0.014) was determined by GPC. Potentiometric titration was conducted to determine the mean number of primary amines (112).

### 2. Synthesis of Partially Acetylated Dendrimer G5-Ac₈₀—(NH₂)₃₂

Purified Generation 5 PAMAM dendrimer 1 (180.1 mg, 6.588 μmole) was dissolved in anhydrous methanol (26.8 mL). Triethylamine (83.6 μL, 0.600 mmole) was added to this mixture and stirred for 30 minutes. Acetic anhydride (45.3 μL, 0.480 mmole) was added to anhydrous methanol (7.3 mL) and the resulting mixture was added in a dropwise manner to the dendrimer solution. The reaction was carried out in a glass flask, under nitrogen, at room temperature for 24 hours. Methanol was evaporated from the resulting solution and the product was purified using 10,000 MWCO centrifugal filtration devices. Purification consisted of six cycles (10 minutes at 5,000 rpm) using 1×PBS (without magnesium and calcium) and six cycles using deionized water. The purified dendrimer was lyophilized for three days to yield a white solid (124.5 mg). ¹H NMR integration determined the degree of acetylation to be 71.5%.

### 3. Synthesis of Dendrimer-Ligand Samples

All reaction steps were carried out in glass scintillation vials at room temperature under nitrogen. All samples were purified using 10,000 MWCO centrifugal filtration devices. Purification consisted of one cycle (10 minutes at 5,000 rpm) using 1×PBS (without magnesium or calcium) and five cycles using deionized water.

### Samples A-D: G5-NH₂-Alkyne_{(1.1, 3.8, 5.7, 12.9)}

Three stock solutions were generated to synthesize Samples A-D. A solution of G5 PAMAM dendrimer 1 (37.6 mg, 1.38 μmole) was prepared with anhydrous DMSO (7.000 mL). The Alkyne Ligand (5.7 mg, 28 μmole) was dissolved in DMSO (2.85 mL). Benzotriazol-1-yl-oxytripyrrolidinophosphonium hexafluorophosphate (PyBOP) (5.5 mg, 10.6 μmole) was dissolved in DMSO (1.10 mL).

### Sample A

The Alkyne Ligand (0.1 mg, 0.49 μmole) solution in anhydrous DMSO (43.9 μL), was added to a solution of G5-NH₂ 1 (8.0 mg, 0.293 μmole) in anhydrous DMSO (1.489 mL). N,N-diisopropylethylamine (0.3 mg, 0.40 μL, 2.3 μmole) was added to the reaction mixture together with 1.091 mL additional DMSO and the resulting solution was stirred for 30 minutes. A solution of PyBOP (0.20 mg, 0.38 μmole) in anhydrous DMSO (44.8 μL) was added in a dropwise manner (0.1 mL/min) to the dendrimer solution. The resulting reaction mixture was stirred for 24 hrs under nitrogen and then purified using 10,000 MWCO centrifugal filtration devices. Purification consisted of one cycle (10 minutes at 5,000 rpm) using 1×PBS (without magnesium or calcium) and five cycles using deionized water. The purified product, Sample A, was lyophilized for three days to yield a white solid (5.9 mg). ¹H NMR integration determined the mean number of Alkyne Ligands per dendrimer to be

### Sample B

Sample B was synthesized in the same manner as Sample A, using G5-NH₂ 1 (8.0 mg, 0.293 μmole) in anhydrous DMSO (1.489 mL), the Alkyne Ligand (0.3 mg, 1.29 μmole) in DMSO (131.8 μL), N,N-diisopropylethylamine (1.0 mg, 1.3 μL, 7.5 μmole), 0.913 mL additional DMSO and PyBOP (0.70 mg, 1.29 μmole) in anhydrous DMSO (134.4 μL). Sample B was purified and lyophilized in the same manner as Sample A. The purified product, Sample B, was a white solid (7.8 mg). ¹H NMR integration determined the mean number of Alkyne Ligands per dendrimer to be 3.8.

### Sample C

Sample C was synthesized in the same manner as Sample A, using G5-NH₂ 1 (8.0 mg, 0.293 μmole) in anhydrous DMSO (1.489 mL), the Alkyne Ligand (0.4 mg, 2.15 μmole) in DMSO (219.7 μL), N,N-diisopropylethylamine (1.7 mg, 2.2 μL, 13.2 μmole), 0.734 mL additional DMSO and PyBOP (1.1 mg, 2.15 μmole) in anhydrous DMSO (224.0 μL). Sample C was purified and lyophilized in the same manner as Sample A. The purified product, Sample C, was a white solid (8.4 mg). ¹H NMR integration determined the mean number of Alkyne Ligands per dendrimer to be 5.7.

### Sample D

Sample D was synthesized in the same manner as Sample A, using G5-NH₂ 1 (8.0 mg, 0.293 μmole) in anhydrous DMSO (1.489 mL), the Alkyne Ligand (0.9 mg, 4.30 μmole) in DMSO (439.5 μL), N,N-diisopropylethylamine (3.3 mg, 4.5 μL, 25.5 μmole), 0.288 mL additional DMSO and PyBOP (2.2 mg, 4.30 μmole) in anhydrous DMSO (447.9 μL). Sample D was purified and lyophilized in the same manner as Sample A. The purified product, Sample D, was a white solid (10.7 mg). ¹H NMR integration determined the mean number of Alkyne Ligands per dendrimer to be 12.9.

Samples E-I: G5-Ac₈₀-Alkyne_{(0.4, 0.7, 2.7, 6.8, 10.2)}

Three stock solutions were generated to synthesize Samples E-I. A solution of the partially acetylated dendrimer 2 (22.4 mg, 0.728 μmole) was prepared with anhydrous DMSO (4.9778 mL). The Alkyne Ligand (9.9 mg, 49 μmole) was dissolved in DMSO (4.9500 mL). Benzotriazol-1-yl-oxytripyrrolidinophosphonium hexafluorophosphate (PyBOP) (5.4 mg, 10 μmole) was dissolved in DMSO (1.000 mL).

### Sample E

The Alkyne Ligand (29.0 μg, 0.146 μmole) in anhydrous DMSO (14.6 μL), was added to a solution of partially acetylated dendrimer (4.4 mg, 0.14 μmole) in anhydrous DMSO (0.978 mL). N,N-diisopropylethylamine (1.1 mg, 1.5 μL, 8.58 μmole) was added to the reaction mixture and the resulting solution was stirred for 30 minutes. A solution of PyBOP (74.0 μg, 0.143 μmole) in anhydrous DMSO (13.8 μL) was added in a dropwise manner (0.1 mL/min) to the dendrimer solution. The resulting reaction mixture was stirred for 24 hrs under nitrogen and then purified using 10,000 MWCO centrifugal filtration devices. Purification consisted of three cycles (10 minutes at 5,000 rpm) using 1×PBS (without magnesium or calcium) and four cycles using DI water. The purified product, Sample E, was lyophilized for three days to yield a white solid (3.7 mg). ¹H NMR integration determined the mean number of Alkyne Ligands per dendrimer to be 0.4.

### Sample F

Sample F was synthesized in the same manner as Sample E, using partially acetylated dendrimer (4.4 mg, 0.14 μmole) in anhydrous DMSO (0.978 mL), the Alkyne Ligand (58.0 μg, 0.286 μmole) in DMSO (29.2 μL), N,N-diisopropylethylamine (0.2 mg, 0.3 μL, 2 μmole), and PyBOP (0.15 mg, 0.29 μmole) in anhydrous DMSO (28 μL). Sample F was purified and lyophilized in the same manner as Sample E. The purified product, Sample F, was a white solid (3.1 mg). ¹H NMR integration determined the mean number of Alkyne Ligands per dendrimer to be 0.7.

### Sample G

Sample G was synthesized in the same manner as Sample E, using partially acetylated dendrimer (4.4 mg, 0.14 μmole) in anhydrous DMSO (0.978 mL), the Alkyne Ligand (0.15 mg, 0.72 μmole) in DMSO (73.0 μL), N,N-diisopropylethylamine (0.6 mg, 0.7 μL, 4 μmole), and PyBOP (0.37 mg, 0.72 μmole) in anhydrous DMSO (69 μL). Sample G was purified and lyophilized in the same manner as Sample E. The purified product, Sample G, was a white solid (3.6 mg). ¹H NMR integration determined the mean number of Alkyne Ligands per dendrimer to be 2.7.

### Sample H

Sample H was synthesized in the same manner as Sample E, using partially acetylated dendrimer (4.4 mg, 0.14 μmole) in anhydrous DMSO (0.978 mL), the Alkyne Ligand (0.29 mg, 1.4 μmole) in DMSO (146 μL), N,N-diisopropylethylamine (1.1 mg, 1.5 μL, 8.6 μmole), and PyBOP (0.74 mg, 1.4 μmole) in anhydrous DMSO (138 μL). Sample H was purified and lyophilized in the same manner as Sample E. The purified product, Sample H, was a white solid (3.5 mg). ¹H NMR integration determined the mean number of Alkyne Ligands per dendrimer to be 6.8.

### Sample I

Sample I was synthesized in the same manner as Sample E, using partially acetylated dendrimer (4.4 mg, 0.14 μmole) in anhydrous DMSO (0.978 mL), the Alkyne Ligand (0.44 mg, 0.14 μmole) in DMSO (978 μL), N,N-diisopropylethylamine (1.7 mg, 2.2 μL, 13 μmole), and PyBOP (1.1 mg, 2.1 μmole) in anhydrous DMSO (207 μL). Sample I was purified and lyophilized in the same manner as Sample E. The purified product, Sample I, was a white solid (2.7 mg). ¹H NMR integration determined the mean number of Alkyne Ligands per dendrimer to be 10.2.

Characterization of the mean ligand-dendrimer ratio by ¹H NMR Spectroscopy

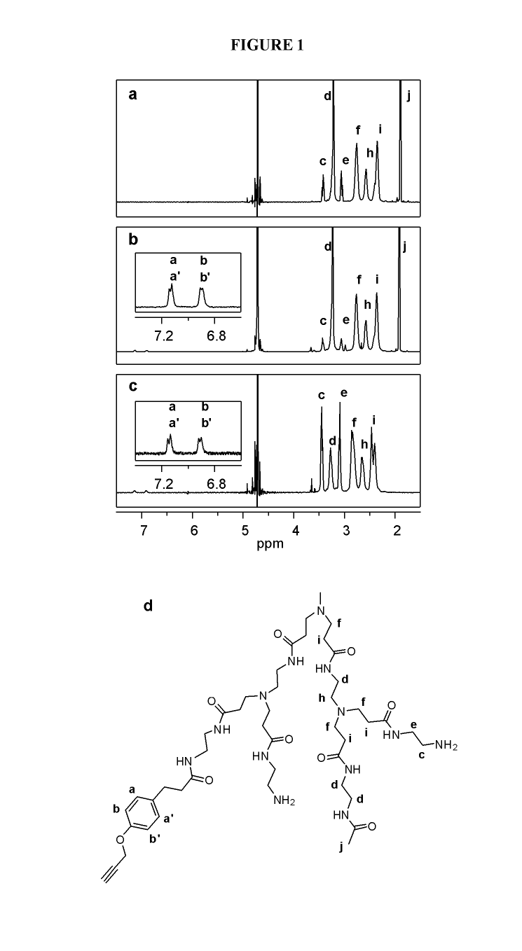

¹H NMR spectroscopy can directly measure the number and type of protons present in the sample. In order to obtain peak areas to compare the integrated ratios of the ligand to dendrimer, it is important to set an appropriate delay time, especially since methyne aromatic protons are being compared to methylene protons. A ten second delay gave quantitative integrations of the ligand/dendrimer ratio. When combined with GPC and potentiometic titration, this ratio was converted to the mean number of ligands per dendrimer in the following manner. The combination of potentiometric titration and number average molecular weight measurements from GPC were used to calculate the mean number of end groups (112) per 100% amine terminated dendrimer (G5-NH₂). Next, the ratio of methylene protons on the amine-terminated dendrimer arms (FIG. 1, panel a, peaks c and e) to the methyl protons in the acetyl terminated arms (FIG. 1, panel a, peak j) were combined with the total number of end groups per dendrimer to compute the mean number of methyl protons in the partially actylated dendrimer (240.0). For ligand-dendrimer conjugates with partially acetylated dendrimer (Sample E-I) the integrated methyl proton peak was used as the internal reference peak to quantify the mean number of ligands based on integration of the aromatic aa′ bb′ pattern proton peaks in the Alkyne Ligand (FIG. 1, panel b).

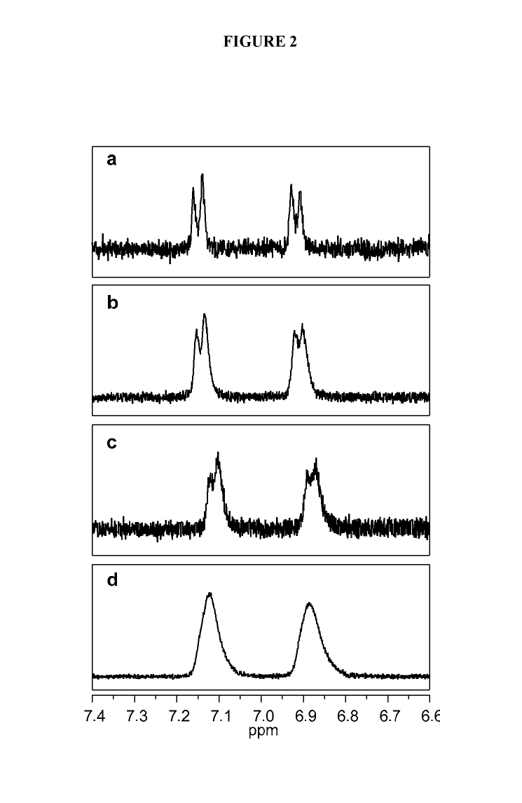

The number of methyl protons per partially acetylated dendrimer also provided the basis to quantify the mean number of protons in the dendrimer interior. Because the partially acetylated dendrimer was synthesized from the same lot of parent dendrimer (G5-NH₂) as was used in this study for the G5-NH₂ based conjugates, it was assumed that the number of interior protons was constant for both dendrimer forms (partially acetylated and un-acetylated). Thus, the interior proton peaks f, h, and i were used as an internal reference to quantify the mean number of conjugated ligands in the G5-NH₂ samples (A-D) (FIG. 1, panel c). Table 1 contains the mean number of ligands per dendrimer computed based on the ¹H NMR spectroscopic characterization. A comparison of the aa′ bb′ proton peaks for Samples A-D can be found in FIG. 2. As the mean number of ligand per dendrimer increases, the full-width at half max (FWHM) was observed to increase. This trend was also found for the aa′ bb′ proton peaks for Samples E-I.

TABLE 3
Comparison of the average number of ligands per dendrimer computed
by two independent techniques (NMR spectroscopy and HPLC).

| | NMR | HPLC | | | |
|---|---|---|---|---|---|
| | Weighted | Weighted | | | |
| | Arithmetic | Arithmetic | Weighted | | # Dendrimer |
| | Mean | Mean | Median | Mode | Species |
| | G5-NH₂-Alkyne | | | | |
| Sample A | 1.1 ± 0.1 | 0.9 ± 0.04 | 1 | 0 | 6 |
| Sample B | 3.8 ± 0.4 | 3.7 ± 0.15 | 3 | 3 | 14 |
| Sample C | 5.7 ± 0.6 | 5.8 ± 0.23 | 5 | 4 | 18 |
| Sample D | 12.9 ± 1.3 | 13.9 ± 0.56 | 14 | 16 | 27 |
| | G5-Ac₈₀-Alkyne | | | | |
| Sample E | 0.43 ± 0.04 | 0.4 ± 0.01 | 0 | 0 | 4 |
| Sample F | 0.7 ± 0.07 | 0.6 ± 0.02 | 0 | 0 | 5 |
| Sample G | 2.7 ± 0.3 | 2.8 ± 0.11 | 2 | 1 | 12 |
| Sample H | 6.8 ± 0.7 | 7.2 ± 0.29 | 7 | 7 | 18 |
| Sample I | 10.2 ± 1.0 | 11.2 ± 0.45 | 11 | 11 | 24 |

### HPLC Characterization of Dendrimer-Ligand Samples Resolves Product Distributions and Provides the Mean, Median, and Mode

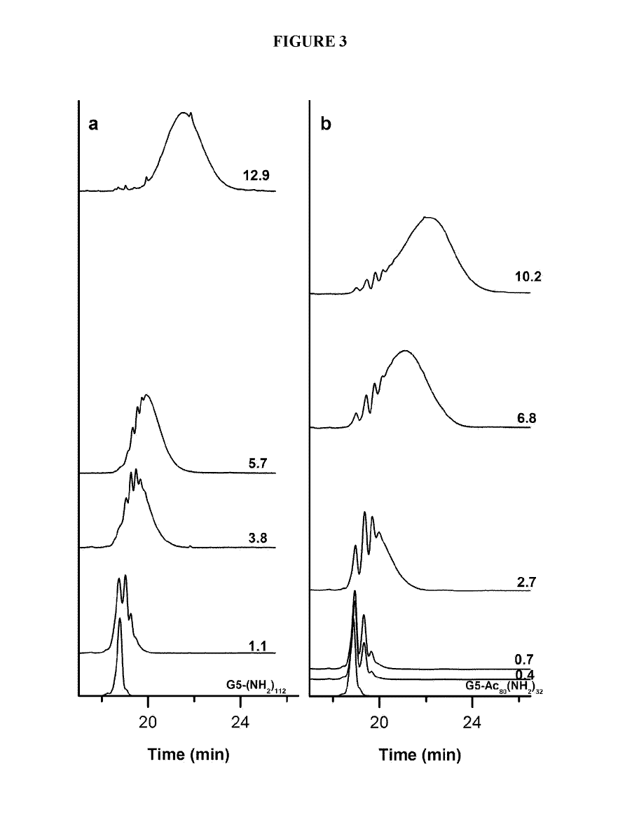

HPLC separates samples based upon their interaction with stationary phase. In experiments conducted during the course of developing some embodiments of the present invention, it was discovered that the alkyne and azide ligands used for click chemistry also provide excellent tags for separation of the ligand distribution using reverse phase HPLC. Elution traces of the dendrimer-ligand conjugates were obtained at 210 nm using a C14 reverse phase column under a gradient elution condition. 210 nm is a convenient wavelength to monitor PAMAM dendrimers because absorbance is not significantly affected by varying amounts of conjugated ligand and Beer's Law is followed (Mullen et al. (2008) Bioconj. Chem. 19:1748-1752; herein incorporated by reference in its entirety). The traces are grouped in FIG. 3 by conjugate type (G5-NH₂-Alkyne, and G5-Ac₅₀-Alkyne). Traces were normalized and plotted on the vertical axis based on each sample's mean number of conjugated ligands. The trace of un-modified dendrimer for each conjugate set (G5-(NH₂)₁₁₂ and G5-Ac₈₀—(NH₂)₃₂) is also included.

A notable feature shown in FIG. 3, found in both conjugate sets, is the trend of increasing trace width as the sample mean increases. This trend is rather dramatic when the width of the unmodified dendrimer profile is considered. The second feature is the resolution of distinct peaks within each trace that have the same peak shape as the un-modified dendrimer. These resolved peaks begin at the same elution time as the unmodified dendrimer and also occur at later elution times.

A comparison between the elution profiles of the G5-NH₂ set and the G5-Ac₈₀ set in FIG. 3, columns a and b respectively, reveals several additional observations. Both the trace width and the relative amount of the initially resolved peaks within the sample trace are greater in the G5-Ac₅₀ based samples than in the G5-NH₂ based samples with comparable means. The G5-NH₂ based conjugates exhibit a slightly skewed Poissonian profile whereas the G5-Ac₈₀ conjugates show an enhanced skewing. Finally, the resolution is increased for the initial peaks in each of the HPLC traces for the G5-Ac₈₀ set compared to the G5-NH₂ set.

### Deconvolution of HPLC Traces Using Peak Fitting

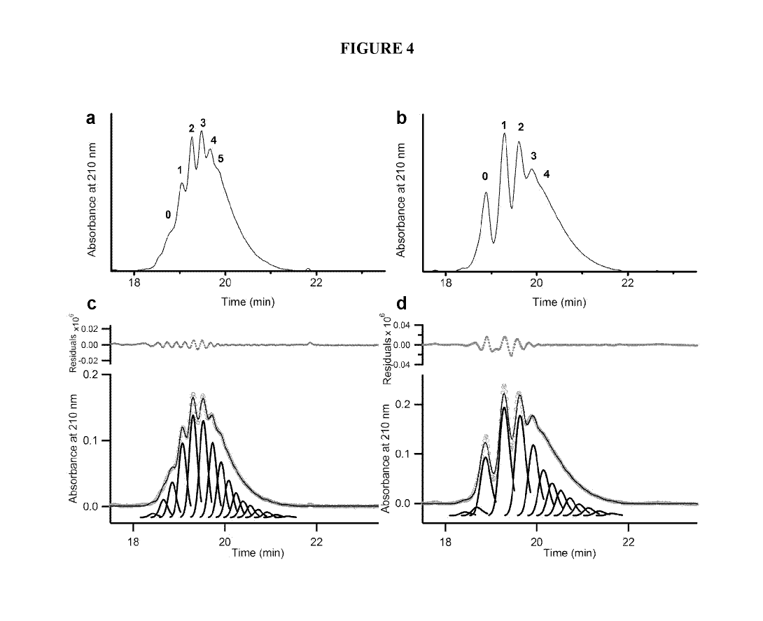

Peak fitting analysis allowed both identification of additional dendrimer-ligand species in the “tailing” region of the HPLC traces and quantification of the relative concentration of each dendrimer-ligand species in a given sample. The functional form of the peaks for each of the samples was developed by fitting the elution profile of each sample type's unmodified dendrimer (G5-(NH₂)₁₁₂ and G5-Ac₈₀—(NH₂)₃₂) using Igor Pro 6.01 (Mullen et al. (2008) Bioconj. Chem. 19:1748-1752; herein incorporated by reference in its entirety). The functional form employed was a Gaussian with an exponential decay tail to the right side of the elution peak. Each of the elution profiles for all of the samples in this study was fit with multiple copies of this functional form. In FIG. 4, panel c and d, the fits for Sample B and G are shown with the HPLC trace in gray circles, the multiple copies of the fitting peak in thick black, and the summation of the fitting peak copies in thin black. The position and area of each fitting peak copy were not constrained. Two copies of the fitting peaks were added to the left of peak 0 and constrained in position. These two small peaks were present in the un-modified dendrimer profile and are likely a result of a small amount of lower generation dendrimer (Shi et al. (2006) Analyst 131:842-848; herein incorporated by reference in its entirety). With the fits for each sample, the relative concentration of each dendrimer-ligand conjugate was determined.

FIG. 4, panel a and b show the HPLC elution profiles for two samples with mean ratios of 3.8 and 2.7 ligands per dendrimer (Sample B and G, respectively). In both HPLC traces, the first large peak (0) has the same elution time as the un-modified dendrimer: G5-(NH₂)₁₁₂ for panel a and G5-Ac₈₀—(NH₂)₃₂ for panel b. The second peak in both panels was preliminarily assigned as being composed of the dendrimer species with exactly 1 ligand (G5-(NH₂)₁₁₁-Alkyne₁ and G5-Ac₈₀—(NH₂)₃₀-Alkyne₁). Notably, in the naming of these species, the number of ligands is an exact number while the number of —Ac groups and —NH₂ groups is actually the mean number. The four remaining partially resolved peaks in panel a and three in panel b were assigned to be dendrimer species with sequentially increasing numbers of ligands based on elution order. Analogous peak assignments were made for all of the dendrimer ligand samples in this study.

### Mean, Median, and Mode of Ligand-Dendrimer Populations Obtained Using HPLC

The relative concentrations of dendrimer species, resolved by HPLC and quantified through the peak fitting analysis, were used to calculate the weighted arithmetic mean of ligands per dendrimer for each sample. This value can be directly compared to the value obtained using ¹H NMR spectroscopy (Table 1, supra). For all samples the HPLC mean is identical within error to the mean determined independently by the combined NMR/GPC/titration analysis. The weighted median and the mode were also determined for each sample.

### Distribution Features

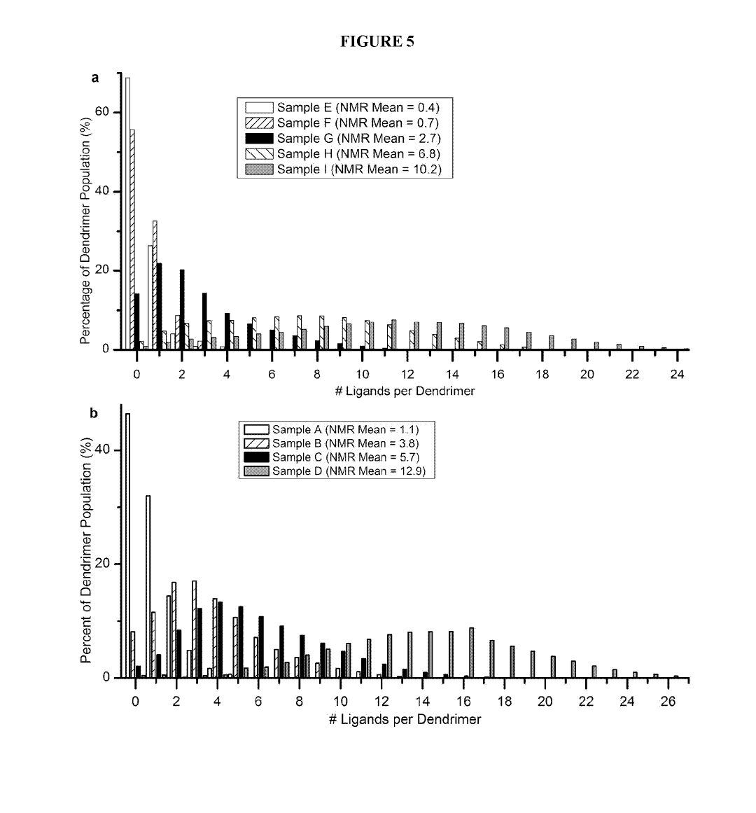

Relative concentrations of dendrimer-ligand species for all samples are plotted in FIG. 5. These distributions are grouped by sample set (panel a for G5-NH₂-Alkyne, and panel b for G5-Ac₈₀-Alkyne). Three common trends exist across the panels. First, the number of dendrimer-ligand species present in a sample increased as the mean ligand number increases. Second, with the exception of Sample D, H and I, between 8% and 44% of each sample was composed of un-modified dendrimer. In many cases, the un-modified dendrimer was in fact the most abundant species present. The third trend, again with the exception of Samples D, H and I, was that the mean dendrimer-ligand species was not identical to the median or mode dendrimer-ligand species.

Additional observations can be made within each of the two sample sets in FIG. 5. The G5-NH₂-Alkyne samples (FIG. 5, panel a) had skewed-Poissonian distribution profiles. A close comparison between each of these distributions and a Poisson distribution with the matching mean revealed that the sample distributions had an over-abundance of dendrimer-ligand species at both low and high extremes of the distribution and an under-abundance of the dendrimer-ligand species with similar numbers of ligands to the sample's mean. The quantified ligand distributions on partially acetylated dendrimer (FIG. 5, panel b) exhibited a much more pronounced version of this feature.

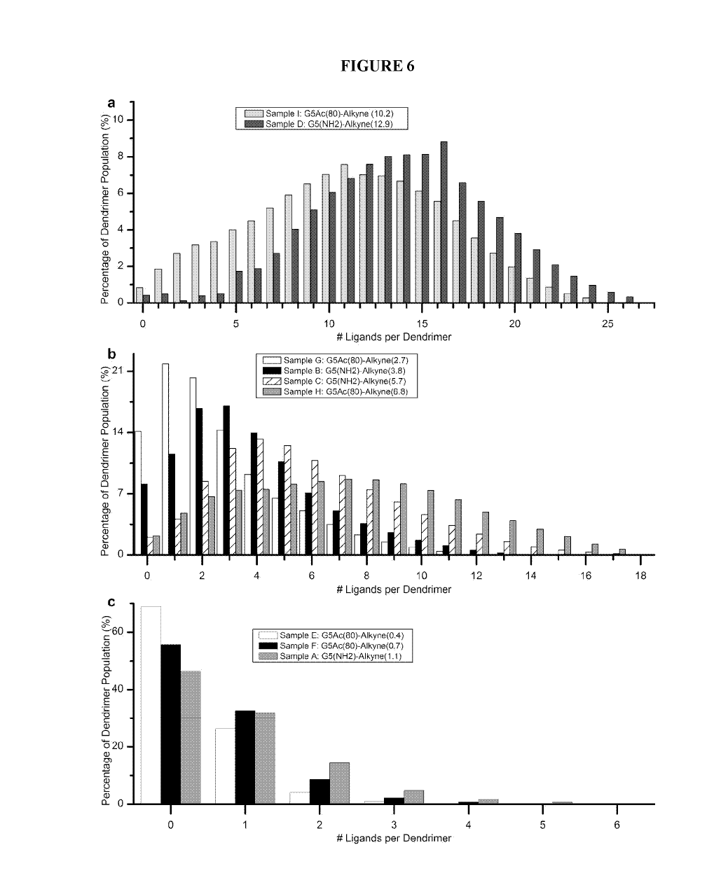

FIG. 6 shows an additional perspective by grouping the samples based on the sample ligand mean rather than sample set. Panel a contains the two samples with the highest ligand means (10.2 and 12.9). Panel b contains the four samples with medium level ligand means (2.7-6.8). Finally, panel c contains the three samples with the lowest ligand means (0.4-1.1). While the present invention is not limited to any particular mechanism, and an understanding of the mechanism is not necessary to practice the present invention, it is contemplated that

the initial acylation had a significant effect on the ligand distribution resulting in a significant departure from a pure Poissonian distribution, far greater than was observed for the G5-NH₂ based samples. Also evident in FIG. 6 is the greater number of dendrimer-ligand species for the samples that were produced with the partially acetylated dendrimer compared to the G5-NH₂-based sample set.

### Estimation of Folic Acid and Methotrexate Distributions on Dendrimer

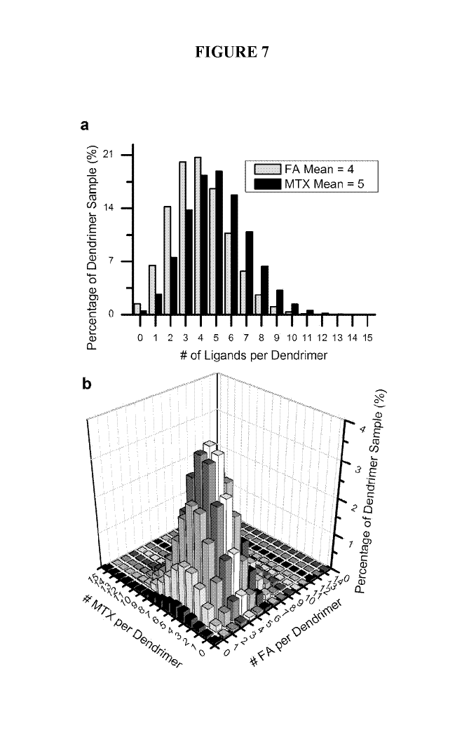

Based on the quantified dendrimer-alkyne ligand distributions described above, the ligand distributions for the FA- and MTX-conjugated dendrimer were explored. This particular dendrimer conjugate was determined to have a mean of 4 FA and 5 MTX molecules per dendrimer. While the present invention is not limited to any particular mechanism, and an understanding of the mechanism is not necessary to practice the present invention, it is contemplated that whereas the experimentally determined distributions in this study follow skewed-Poissonian functional forms, the mathematical model used for this investigation is a true Poisson model with a prescribed mean and number of available attachment points. Ligand distributions resulting from this model with means of 4 and 5 representing the FA and MTX distributions are shown in FIG. 7, panel a. Both distributions are combined in a two-dimensional matrix in order to describe all of the different G5-FA-MTX species. The bar plot in FIG. 7, panel b contains the sample concentrations for all of the different dendrimer species based on the Poisson distributions for the individual ligands. Approximately 182 (13×14) different G5-FA-MTX species are found in this plot. Only 3.9% of the total sample consisted of a dendrimer with exactly 4 folic acid and 5 methotrexate molecules. It should be noted that these concentrations assume that the distribution of methotrexate, for example, is not influenced by the pre-existing distributions of acetyl groups, folic acid molecules and dye molecules that were present during the methotrexate conjugation.

The number of different species in FIG. 7, panel b also does not take into account the different regioismers of folic acid and methotrexate conjugates that have significantly different biological activities. Both compounds have two carboxylic acid groups (α and γ). Several studies have found that folic acid and methotrexate maintain their biological activity when conjugated through the γ-carboxylic acid and either completely lose or experience a substantial reduction in biological activity when conjugated via the α-carboxylic acid (Wang et al. (1996) Bioconj. Chem. 7:56-62; Ke et al. (2004) Adv. Drug Delivery Rev. 56:1143-1160; Kralovec et al. (1989) J. Med. Chem. 32:2426-2431; Rosowsky et al. (1985) 27:141-147; each herein incorporated by reference in its entirety). The EDC coupling method that is used to conjugate both folic acid and methotrexate to the dendrimer is not regiospecific and results in three different derivatives of both folic acid and methotrexate: amide bond at the γ-position, amide bond at the α-position, and amide bonds at both α- and γ-positions. While the present invention is not limited to any particular mechanism, and an understanding of the mechanism is not necessary to practice the present invention, it is contemplated that when taking the 3 different versions of methotrexate and folic acid into account, this particular dendrimer system was composed of ˜1638 different dendrimer species. Taking into account folic acid and methotrexate regiochemistry into the consideration of the percentage of sample containing 4 fully active folic acid and 5 fully active methotrexate significantly reduces the estimate from the 3.9% given above. Experimentally determined ratios of γ- vs. α-modified forms of folic acid and methotrexate vary from roughly 80% to 30% of the active γ-form (Wang et al. (1996) Bioconj. Chem. 7:56-62; Wei et al. (2005) Organ. Biomol. Chem. 3:3290-3296; Mezo et al. (2006) J. Peptide Sci. 12:328-336; each herein incorporated by reference in its entirety). The amount of fully active material, when also including the effects of proper regiochemistry, ranged from 0.3% to less than 0.01%.

Prior to development of some embodiments of the present invention, methods employed in an attempt to characterize nanoparticle-ligand distributions including gel electrophoresis (Sperling et al. (2006) Adv. Funct. Materials 16:943-948; herein incorporated by reference in its entirety), anion-exchange HPLC(Claridge et al. (2008) Nano Lett. 8:1202-1206; herein incorporated by reference in its entirety), ultra performance liquid chromatography (Cason et al (2008) J. Nanomater., Article ID 456082 doi:10.1155/2008/456082; herein incorporated by reference in its entirety), fluorescence resonance energy transfer (Pons et al. (J. Am. Chem. Soc. 128:15324-15331; herein incorporated by reference in its entirety), mass spectrometry (Tracy et al. (2007) J. Am. Chem. Soc. 129:6706-6707; herein incorporated by reference in its entirety), and fluorescence quenching (Casanova et al (2007) J. Am. Chem. Soc. 129:12592-12593; herein incorporated by reference in its entirety). One study investigated the specific case of dendrimer-ligand conjugates with mean ratios close to 1:1 (Mullen et al. (2008) 19:1748-1752; herein incorporated by reference in its entirety). HPLC was used to resolve the dendrimer-ligand distributions and the peak fitting method was utilized to quantify the different dendrimer-ligand distributions. The observed distributions were found to be consistent with theoretical expectations.

The nature of the dendrimer-ligand distributions quantified herein confirm that investigations of nanoparticle-ligand distributions should be incorporated in all research studies pertaining to nanoparticle-ligand conjugates, as well as in the design of new generation nanoparticle-based systems. To fully understand the functionality of a nanoparticle-ligand system, knowledge of only the mean ligand/nanoparticle ratio is inadequate. Results of experiments conducted during the course of developing some embodiments of the present invention provide new information about the relationship between the typically measured average and the actual material composition.

### Relationship Between Mean, Median, and Mode

The average values for all nanoparticle-ligand systems reported prior to the present invention have been weighted arithmetic means. Values for the median and mode have never before been reported. This is a consequence of a reliance on mean-producing characterization techniques and a lack of emphasis on determining the number and relative amount of the different species that gives rise to the mean. Differences between these three forms of the average can be indicative of distribution features. As seen in Table 1 supra, in samples with means of ˜6 or below, the mean, median, and mode can differ substantially. For sample A, E, and F, which all have arithmetic means of 1 or less, the mode of the samples is actually 0. For sample C, which has an arithmetic mean of 6, the mode is actually 4. Also note that for all samples except D, the mean is always the same or greater than the median and the mode. The significance of considering the various ways of expressing average values is most apparent when considering samples A and G. In case A, although the mean is ˜1, the mode is zero. If this ligand was a targeting agent, drug, or dye, the most common species in the dendrimer distribution would have no activity. In case G, although the mean is ˜3, the mode is 1. If one was designing materials for multivalent targeting, the most common species would exhibit no multivalent binding. For such systems, drawings showing the mean numbers of ligands are particularly misleading regarding the biological activity that can be expected.

### Dendrimer-Ligand Samples are Heterogeneous

The dendrimer-ligand distributions that have been quantified herein contradict the misconception that such samples are functionally homogeneous, composed of a relatively small number of constituent species. Certainly dendrimers are, with PDIs as low as 1.01, unique to the polymer field in their structural uniformity, surpassed only by biological polymers such as DNA and proteins. This polymeric mono-dispersity, however, is derived from a synthetic process that exposes a vast molar excess of the monomer unit to the number of attachment points available on the dendrimer. The ligand conjugation reactions to the dendrimer are distinctly different from the dendrimer synthesis because there is instead an excess of attachment points on the dendrimer relative to the molar amount of ligand added. The consequence of this stochastic condition is seen in the number of different dendrimer species for each sample, listed in Table 1 supra. Sample E, with a ligand mean of 0.4 is composed of 4 different dendrimer-ligand species ranging from un-modified dendrimer to dendrimer with 3 ligands. Sample D with the highest mean in this study (12.9) has 27 different species present ranging from dendrimer with no ligands up to dendrimer with 26 ligands.

The mathematical form that the distributions follow in dendrimer-ligand samples is a skewed-Poisson distribution. A comparison of experimentally quantified distributions with Poisson and Gaussian distribution models can be found in FIG. 8 for three of the G5Ac-based samples. The Gaussian comparisons are provided only because many skilled in the art of dendrimer synthesis are used to thinking about a distribution of this form, so it provides a comparison point to the Poisson distribution. In addition, previous work quantifying biotin-dendrimer distributions compared to a Gaussian distribution (Lee et al. (2005) Nature Biotechnol. 23:1517-1526; herein incorporated by reference in its entirety). Panel a displays the distribution for Sample H with a mean of 6.8. Three distribution models are included: a Poisson distribution with a mean of 6.8 and 32 available attachment sites, and two Gaussian distributions with means of 6.8 and standard deviations of 1 and 4. The Gaussian with a standard deviation of 1 resembles what one might expect to see in a “homogeneous” sample. This Gaussian distribution does not, however, agree with the heterogeneity observed in the experimental data. In fact, the standard deviation has to be increased to 4 in order to obtain a distribution that resembles Sample H. The distribution for Sample H is skewed from both the Gaussian w/ SD=4 and the Poisson distribution in that there is a systematic over-abundance of species with low and high ligand numbers and an under representation of species with numbers close to the mean. In addition, the skewed-Poisson distributions is consistent with our previous results for samples with ligand means 0.5-1.47 (Mullen et al. (2008) Bioconj. Chem. 19:1748-1725).

The heterogeneity observed in these dendrimer-ligand conjugates raises substantial doubt that the mean alone is an adequate measurement to understand nanoparticle-ligand composition and function. As a single value, the mean does not capture the true diversity of species present in the material. Certainly, it is incorrect to infer that the majority of the population is within ±1 ligands of the mean. The only exceptions, in this study, are samples A, E, and F. Note that all of these samples have low mean values (1.1 and lower), below the means typically used for functional dendrimer conjugates. In fact, for samples with ligand means of 6.8 and higher, the majority of dendrimer species present is not even within ±2 ligands of the mean. In addition to this, in many cases, the mean is not the largest species in relative concentration (the mode). The final problem with relying exclusively on the mean to describe the material composition is that it is completely unable to detect changes in heterogeneity that are caused by differences in the dendrimers' synthetic history (for example, pre-existing distributions).

### Pre-Existing Distributions Increase Sample Heterogeneity

Many dendrimer-ligand systems employ a partial acylation step before conjugating additional ligands such as FA or MTX. Furthermore, when attaching different ligands it is common to utilize a sequential reaction strategy. In both of these situations, ligands are conjugated in the presence of a pre-existing distribution making ligand distributions highly sensitive to the nanoparticles' synthetic history.

It is clear from the distribution data that the partially acetylated dendrimer causes an enhanced departure from the slightly skewed Poisson distribution observed in G5-NH₂ based samples. Given that the acetylation reaction takes place with an excess of amine groups on the dendrimer relative to the amount of acetic anhydride added, the acetylation reaction itself should result in a distribution composed of dendrimer with different numbers of acetyl groups and consequently a distribution of primary amines for future reactions. The key implication is that the ligand conjugation with the partially acetylated dendrimer takes place in the presence of a pre-existing distribution of primary amines in the dendrimer material. This pre-existing distribution creates a situation wherein dendrimer species with high degrees of acylation have a lower likelihood of reacting with a ligand than the dendrimer species in the same sample that have lower degrees of acylation. The consequence of this effect is that when conjugating multiple different functional groups to the dendrimer using conjugation reactions conducted in series, each additional conjugation will experience an increased skewing of the distribution and sample heterogeneity.

### Implications of Ligand Distributions for Understanding Nanoparticle-Ligand Function

Data presented herein provide valuable insight into the functional ligand distributions that exist in nanoparticle-based systems particularly those highlighted in the introduction. For many of these systems, the ligand distribution has not been incorporated into the interpretation of material's biological activity. One particularly relevant example is the multivalent targeting that has been observed for FA-conjugated dendrimer. Previously, Hong and colleagues studied the relationship between multivalent targeting and the mean number of FA per dendrimer using surface plasmon resonance (SPR) and flow cytometry (Hong et al. (2007) Chem. & Biol. 14:107-115; herein incorporated by reference in its entirety). Five dendrimer samples were generated with means between 2.6 to 13.7. Based on the distributions reported herein, the dendrimer-folic acid samples were likely composed of between 12 and 27 different species.

In the context of multivalent targeting, consider Sample G and H. In Sample G, which has a mean of 2.7, approximately 36% of the total dendrimer are not capable of multivalent targeting because they have either 0 or 1 ligand. Approximately 50% of the sample has between 2 and 5 conjugated ligands which one might reasonably expect to be multivalent capable. The 14% of the sample composed of dendrimer with 6 or more ligands may actually be less effective at multivalent targeting both because of a decreased water solubility from the high number of hydrophobic ligand molecules and/or due to ligand-ligand self-aggregation problems (Reddy et al. (2002) Gene Therapy 9:1542-1550; herein incorporated by reference in its entirety). Sample H, with a mean of 6.8, actually has about 65% of its dendrimer material in this high ligand range. Approximately 29% of the dendrimer system is in the predicted optimal range to achieve multivalencey and about 6% is not capable of multivalent targeting. This type of analysis can also be applied to multi-ligand systems such as the G5-FA-MTX dendrimer. With over 1600 different species, it appears evident that not all species have equal functionalities. In fact, it is very likely that only a small portion of the total material is actually capable of the desired activity. Given the diversity of species in these materials, interpreting biological results based solely on the mean number of functional groups ignores the varying contributions of individual dendrimer species and their concentration relative to the other species present. Incorporating this reality into future studies leads to significant improvements in nanoparticle-ligand systems design, particularly if specific dendrimer species are identified as having significantly enhanced biological activity.

### Example 4

### Isolation of PAMAM Dendrimer System With Precise Numbers of Ligands

Synthetic methods commonly used to conjugate ligands to poly(amidoamine) (PAMAM) dendrimers result in skewed Poisson product distributions. The distribution for a dendrimer ligand conjugate composed of a generation 5 (G5) PAMAM dendrimer and an average of 0.45 ligands were resolved and quantified using reverse phase HPLC (FIG. 9). Semi-preparative reverse phase HPLC enabled the isolation dendrimers with exact numbers of conjugated ligands. ¹H NMR spectroscopy was used as independent technique to determine the number of ligands per dendrimer for each of the isolated peaks.

### Example 5

### Isolation and Characterization of Dendrimer with Precise Number of Functional Groups

### Reagents and Materials

Biomedical grade Generation 5 PAMAM (poly(amidoamine)) dendrimer was purchased from Dendritech Inc. and purified as described in the synthesis section. MeOH (99.8%), acetic anhydride (99.5%), triethylamine (99.5%), dimethylformamide (99.8%), acetone (ACS reagent grade≧99.5%), methyl 3-(4-hydroxyphenyl)propanoate (97%), sodium azide (99.99%), 1-bromo-2-chloroethane (98%), ethyl acetate (EtOAc) 99.5%), 18-crown-6, K₂CO₃, NaCl, 1N HCl, 2 M KOH, N-(3-dimethylaminopropyl)N′-ethylcarbodiimide (≧97.0%) (EDC), N-hydroxysuccinimide (98%) (NHS), D₂O, and volumetric solutions (0.1 M HCl and 0.1 M NaOH) for potentiometric titration were purchased from Sigma Aldrich Co. and used as received. 10,000 molecular weight cut-off centrifugal filters (Amicon Ultra) and Hexanes (HPLC grade) were obtained from Fisher Scientific. 1× and 10× phosphate buffer saline (PBS) (Ph=7.4) without calcium or magnesium was purchased from Invitrogen.

### Nuclear Magnetic Resonance Spectroscopy

All ¹H NMR experiments were conducted using a Varian Inova 400 MHz instrument. 10 s delay time and 64 scans were set for each dendrimer sample. Temperature was controlled at 25° C. For experiments conducted in D₂O, the internal reference peak was set to 4.717 ppm. Based upon measuring T₂* values and empirical studies to ensure that the chosen delay was long enough to avoid any decreased peak intensity associated with spin saturation, the delay for all integration studies was set to 10 s.

### Gel Permeation Chromatography

GPC experiments were performed on an Alliance Waters 2695 separation module equipped with a 2487 dual wavelength UV absorbance detector (Waters Corporation), a Wyatt HELEOS Multi Angle Laser Light Scattering (MALLS) detector, and an Optilab rEX differential refractometer (Wyatt Technology Corporation). Columns employed were TosoHaas TSK-Gel Guard PHW 06762 (75 mm×7.5 mm, 12 μm), G 2000 PW 05761 (300 mm×7.5 mm, 10 μm), G 3000 PW 05762 (300 mm×7.5 mm, 10 μm), and G 4000 PW (300 mm×7.5 mm, 17 μm). Column temperature was maintained at 25±0.1° C. with a Waters temperature control module. The isocratic mobile phase was 0.1 M citric acid and 0.025 wt % sodium azide, pH 2.74, at a flow rate of 1 mL/min. The sample concentration was 10 mg/5 mL with an injection volume of 100 μL. The weight average molecular weight, M_{w}, has been determined by GPC, and the number average molecular weight, Mₙ, was calculated with Astra 5.3.14 software (Wyatt Technology Corporation) based on the molecular weight distribution.

### Potentiometric Titration

Potentiometric titration was carried out using a Mettler Toledo MP220 pH meter and a Mettler Toledo InLab 430 pH electrode at room temperature, 23° C. A 10 mL solution of 0.1 N NaCl was added to purified G5 PAMAM dendrimer 1 (127.5 mg) to shield amine group interactions. The pH of the dendrimer solution was lowered to pH=2.01 using 0.1034 N HCl. A 25 mL Brand Digital Burette™ III was used for the titration with 0.0987 N NaOH. The numbers of primary and tertiary amines were determined by from the titration curve with NaOH (see, e.g., I. J. Majoros, et al., Journal of Medicinal Chemistry 2005, 48, 5892; herein incorporated by reference in its entirety).

### Analytical Reverse Phase High Performance Liquid Chromatography

HPLC analysis was carried out on a Waters Delta 600 HPLC system equipped with a Waters 2996 photodiode array detector, a Waters 717 Plus auto sampler, and Waters Fraction collector III. The instrument was controlled by Empower 2 software. For analysis of the conjugates, a C5 silica-based RP-HPLC column (250×4.6 mm, 300 Å) connected to a C5 guard column (4×3 mm) was used. The mobile phase for elution of the conjugates was a linear gradient beginning with 100:0 (v/v) water/acetonitrile and ending with 20:80 (v/v) water/acetonitrile over 30 min at a flow rate of 1 mL/min. Trifluoroacetic acid (TFA) at 0.14 wt % concentration in water as well as in acetonitrile was used as a counter ion to make the dendrimer surfaces hydrophobic. Elution traces of the dendrimer-ligand conjugate were obtained at 210 nm. It has previously shown that 210 nm is a convenient wavelength to monitor PAMAM dendrimers because absorbance is not significantly affected by varying amounts of conjugated ligand and Beer's Law was followed (see, e.g., D. G. Mullen, et al., Bioconjugate Chemistry 2008, 19, 1748; herein incorporated by reference in its entirety). Run-to-run reproducibility of retention time was 0.016 min which is ˜4% of the magnitude of the peak-to-peak separation.

### Semi-Preparative Reverse Phase High Performance Liquid Chromatography

HPLC isolation was carried out on a Waters Delta 600 HPLC system equipped with a Waters 2996 photodiode array detector, a Waters 2707 auto sampler, and Waters Fraction collector III. The instrument was controlled by Empower 2 software. For analysis of the conjugates, a C5 silica-based RP-HPLC column (250×21.20 mm, 10μ 300 Å) connected to a C5 guard column (50×21.20 mm) was used. The mobile phase for elution of the conjugates was a linear gradient beginning with 100:0 (v/v) water/isopropanol and ending with 60:40 (v/v) water/isopropanol over 25 min at a flow rate of 10 mL/min. Trifluoroacetic acid (TFA) at 0.14 wt % concentration in water as well as in isopropanol was used as a counter ion to make the dendrimer surfaces hydrophobic. Elution traces of the dendrimer-ligand conjugate were obtained at 210 nm.

### Synthesis

The G5-(NH₂)₁₁₂ dendrimer was conjugated to Azide and Ac groups. Ac refers to the acetyl termination, and Azide to the Azide Ligand.

### Compound I

### Azide Ligand (3-(4-(2-azidoethoxy)phenyl)propanoic acid)

1a. To a solution of methyl 3-(4-hydroxyphenyl)propanoate (1.699 g, 9.43 mmole) in dry acetone (47.5 mL) was added anhydrous K₂CO₃ (3.909 g, 0.0283 mole) followed by 1-bromo-2-chloroethane (1.563 mL, 0.01886 mole). The resulting suspension was refluxed for 43 h with vigorous stirring. The reaction mixture was cooled to room temperature and the salt was removed by filtration followed by washing with portions of EtOAc (3×70 mL). The crude material was purified by silica chromatography (25:75 EtOAc:Hexane) and the solvent was removed under vacuum to give the desired product, methyl 3-(4-(2-chloroethoxy)phenyl)propanoate 1a, as an oil (0.75 g, 33%). ¹H NMR (500 MHz, CDCl₃, 25° C.) δ=7.121 (d, J=8.7, 2H), 6.843 (d, J=8.7, 2H), 4.206 (t, J=5.9, 2H), 3.798 (t, J=5.9, 2H), 3.664 (s, 3H), 2.895 (t, J=7.8, 2H), 2.598 (t, J=7.8, 2H).

1b. To a solution of methyl 3-(4-(2-chloroethoxy)phenyl)propanoate 1a (0.75 g 3.1 mmole) in anhydrous DMF (6.1 mL) was added 18-crown-6 (3.4 mg, 0.013 mmole) and sodium azide (0.44 g, 6.8 mmole). The resulting solution was heated at 78° C. for 11 h. The reaction mixture was cooled to room temperature, diluted with ethyl acetate (50 mL), washed with a saturated NaHCO₃ solution (4×70 mL), and then dried over MgSO₄. The solvent was removed under vacuum to give methyl 3-(4-(2-azidoethoxy)phenyl)propanoate 1b as a yellow oil (0.58 g, 75%) ¹H NMR (500 MHz, CDCl₃, 25° C.) δ=7.125 (d, J=8.6, 2H), 6.849 (d, J=8.6, 2H), 4.129 (t, J=5.0 2H), 3.666 (s, 3H), 3.581 (t, J=5.0, 2H), 2.899 (t, J=7.8, 2H), 2.600 (t, J=7.8, 2H).

1c. To a solution of methyl 3-(4-(2-azidoethoxy)phenyl)propanoate 1b (3.88 g, 0.0156 mole) in methanol (102 mL) was added potassium hydroxide (2 M, 28.3 mL, 0.0566 mole). The resulting solution was refluxed at 70° C. for 3 h. The solution was cooled to room temperature and condensed under reduced pressure. The residue was dissolved in water (30 mL) and was acidified by addition of 1N HCl to pH 1. The white cloudy solution was diluted with EtOAc. Layers were separated and the aqueous layer was extracted with EtOAc (2×70 mL). The combined organic extracts were washed with a saturated NaCl solution and dried over MgSO₄. Solvent was evaporated under vacuum to give the (3-(4-(2-azidoethoxy)phenyl)propanoic acid) 1c as a white solid (3.44 g, 93.9%). ¹H NMR (500 MHz, CDCl₃, 25° C.) δ=7.139 (d, J=8.5, 2H), 6.859 (d, J=8.5, 2H), 4.132 (t, J=5.0 2H), 3.584 (t, J=5.0, 2H), 2.909 (t, J=7.7, 2H), 2.653 (t, J=7.7, 2H).

### Dendrimer 1: Purification of Generation 5 PAMAM Dendrimer G5-(NH₂)₁₁₂

The purchased G5 PAMAM dendrimer was purified by dialysis, as previously described (see, e.g., D. G. Mullen, et al., Bioconjugate Chemistry 2008, 19, 1748; herein incorporated by reference in its entirety), to remove lower molecular weight impurities including trailing generation dendrimer defect structures. The number average molecular weight (27,100 g/mol±1,000) and PDI (1.018+/−0.014) was determined by GPC. Potentiometric titration was conducted to determine the mean number of primary amines (112±5).

### Dendrimer 2: G5-(NH₂)₁₀₈-Azide_{4.3}

The Azide Ligand (19.4 mg, 82.7 μmole), EDC (31.7 mg, 0.165 mmole), and NHS (21.9 mg, 0.190 mmole) were dissolved in anhydrous acetonitrile (4.861 mL). The resulting solution was stirred under nitrogen for 1 hr. The resulting solution was added by syringe pump to a solution of G5 PAMAM dendrimer 1 (451.9 mg, 16.53 μmole) in DI water (100 mL). The resulting reaction mixture was stirred for 12 hrs under nitrogen at room temperature. The product was purified using 10,000 MWCO centrifugal filtration devices. Purification consisted of 2 cycles to concentrate the solution, 1 cycle using 1×PBS (without magnesium and calcium) and four cycles using DI water. Each cycle was 10 minutes at 5,000 rpm. The purified dendrimer was lyophilized for three days to yield a white solid (368.9 mg, 79%). ¹H NMR integration determined the mean number of Azide Ligands per dendrimer to be 4.3.

### Dendrimer 3: G5-Ac₁₀₈-Azide_{4.3}

Dendrimer 2 (365.2 mg, 12.89 μmole) was dissolved in anhydrous methanol (30.0 mL). Triethylamine (297 μL, 2.12 mmole) was added to this mixture and stirred for 30 minutes. Acetic anhydride (174 μL, 1.8 mmole) was added in a dropwise manner to the dendrimer solution. The reaction was carried out in a glass flask, under nitrogen, at room temperature for 24 hours. Methanol was evaporated from the resulting solution and the product was purified using 10,000 MWCO centrifugal filtration devices. Purification consisted of 1 cycles to concentrate the solution, 2 cycle using 1×PBS (without magnesium and calcium) and four cycles using DI water. The purified dendrimer was lyophilized for three days to yield a white solid (258.4 mg, 61%). ¹H NMR integration determined that the dendrimer was fully acetylated.

### Dendrimer 4: G5-Ac₁₁₂

Dendrimer 1 (126.2 mg, 4.620 μmole) was dissolved in anhydrous methanol (24.0 mL). Triethylamine (144 μL, 1.03 mmole) was added to this mixture and stirred for 30 minutes. Acetic anhydride (78.1 μL, 0.827 mmole) was added in a dropwise manner to the dendrimer solution. The reaction was carried out in a glass flask, under nitrogen, at room temperature for 24 hours. Methanol was evaporated from the resulting solution and the product was purified using 10,000 MWCO centrifugal filtration devices. Purification consisted of 1 cycles to concentrate the solution, 2 cycle using 1×PBS (without magnesium and calcium) and four cycles using DI water. The purified dendrimer was lyophilized for three days to yield a white solid (105.5 mg, 71%). ¹H NMR integration determined that the dendrimer was fully acetylated. Integral values for the interior dendrimer protons f, g, and e (see FIG. 3 for assignments) were found to be 487, 260 and 487, respectively.

### Isolation Procedure

Dendrimer 3 was injected into the HPLC system for 12 consecutive runs. Each injection used 18.2 mg of material in 910 μL of water w/0.14% TFA. A 30 minute run time and a 10 minute delay between runs were used. Beginning at 20 min 0 s in each run, 120 fractions were collected using the Waters Fraction Collector at 4 s intervals. Fractions for all 12 runs were collected in the same set of test tubes.

Fractions were combined based on the peak fitting analysis to obtain the 9 isolated dendrimer-ligand samples (Samples 0-8). 50 μL from each sample was removed and used for analytical HPLC characterization. Purification of each sample was necessary due to the low pH (˜1.9) of the HPLC solvent system. This process is described in detail for Sample 0 and was repeated for Samples 1-8.

Sample 0: Fractions 11-18 (20 m 40 s-21 m 12 s) were combined, diluted with an equal volume of 1×PBS (w/o Mg or Ca) and aspirated with nitrogen to evaporate isopropanol. The concentrated sample was lyophilized for 1 day to yield a white powder. The dried sample was then re-dissolved in 2.5 mL of 10×PBS (w/o Mg or Ca) and purified using PD-10 desalting columns. DI water was used as the mobile phase for the column purification step. The sample was then lyophilized for 2 days to yield a white solid (10.4 mg).

Sample 1: Fractions 34-38 (22 m 12 s-22 m 32 s) 10.1 mg. The purification process was repeated twice for Sample 1.
Sample 2: Fractions 52-55 (23 m 24 s-23 m 40 s) 8.5 mg.
Sample 3: Fractions 66-69 (24 m 20 s-24 m 36 s) 9.5 mg.
Sample 4: Fractions 78-81 (25 m 8 s-25 m 24 s) 8.7 mg.
Sample 5: Fractions 87-89 (25 m 44 s-25 m 56 s) 5.4 mg.
Sample 6: Fractions 96-98 (26 m 20 s-26 m 32 s) 6.7 mg.
Sample 7: Fractions 105-107 (26 m 56 s-27 m 8 s) 1.5 mg.
Sample 8: Fractions 115-117 (27 m 36 s-27 m 48 s) 1.8 mg.

Semi-preparative HPLC was employed to successfully isolate 9 different dendrimer components with precise numbers of ligands. Generation 5 (G5) PAMAM dendrimer was conjugated with (3-(4-(2-azidoethoxy)phenyl)propanoic acid) (Azide Ligand) to produce dendrimer with a mean of 4.3 ligands (Scheme 1).

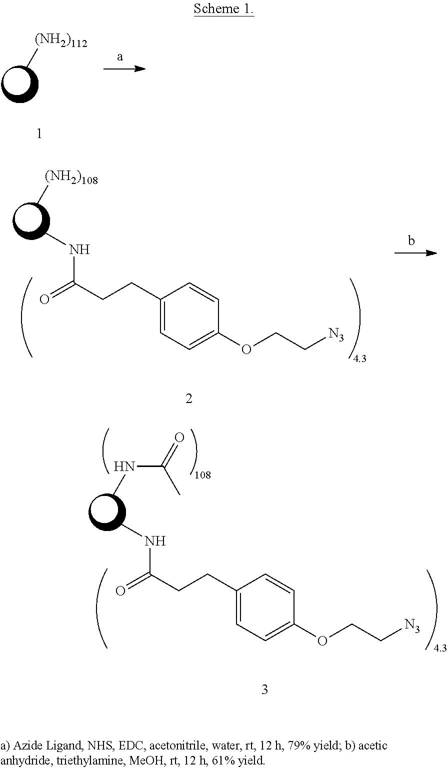

Dendrimer samples with 0, 1, 2, 3, 4, 5, 6, 7 and 8 Azide Ligands were isolated from the dendrimer conjugate 3 and characterized by ¹H NMR and analytical HPLC. Levels of purity for these samples were found to be greater than 80%.

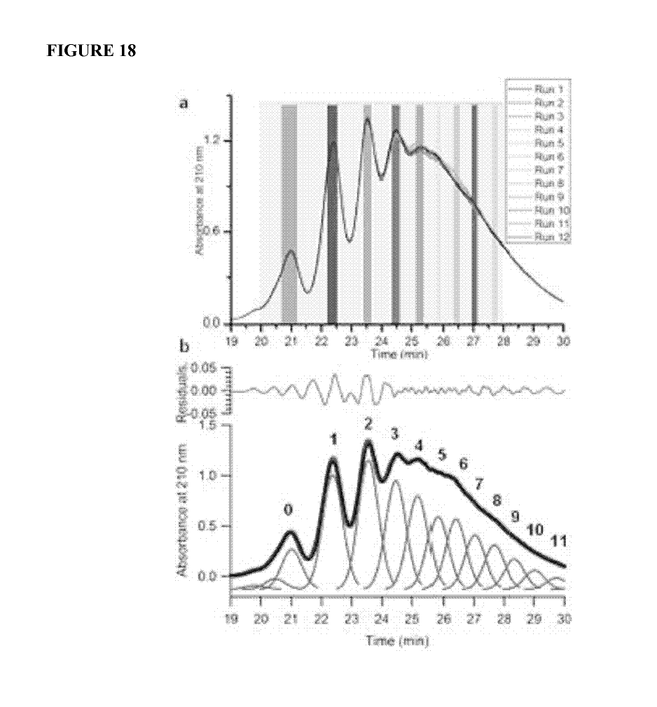

Isolation of practical quantities of material was achieved by carrying out the HPLC process for 12 runs. FIG. 18a shows the semi-preparative HPLC traces for the 12 identical runs. The 120 fractions starting at 20 minutes are shown in grey. The selected fractions for each of the different dendrimer-ligand components (0-8) are highlighted in solid grey bars. A peak fitting analysis determined the retention time of each component (FIG. 18b), thereby identifying the fractions in FIG. 18a to combine for dendrimer samples with 0-8 ligands. The mass isolated by this process is listed in Table 4.

TABLE 4
Characterization of isolated dendrimer with precise numbers of ligands

| HPLC Analysis | | | | | NMR Analysis | | | |
|---|---|---|---|---|---|---|---|---|
| | | | | | Method 1 | | | |
| Nominal # | Mass | # Ligands | | Increase | # Ligands | | # Ligands | |
| of Ligands | Recovered | per | | in | per | | per | Method 2 |
| per Dendrimer | (mg) | Dendrimer | Purity^{[a]} | Purity^{[b]} | Dendrimer | Difference^{[c]} | Dendrimer | Difference^{[c]} |
| 0 | 10.4 | 0.0 | 100% | 14× | 0 | 0 | 0 | 0 |
| 1 | 10.1 | 1.0 | 97% | 6× | 1.2 | 20% | 1.1 | 10% |
| 2 | 8.5 | 1.9 | 93% | 6× | 2.4 | 26% | 2.2 | 14% |
| 3 | 9.5 | 2.7 | 88% | 7× | 3.4 | 26% | 3.2 | 17% |
| 4 | 8.7 | 3.8 | 86% | 9× | 4.3 | 13% | 3.9 | 3% |
| 5 | 5.4 | 4.8 | 84% | 10× | 4.9 | 2% | 4.5 | 7% |
| 6 | 6.7 | 5.8 | 84% | 12× | 5.7 | 2% | 5.2 | 10% |
| 7 | 1.5 | 6.7 | 82% | 14× | 6.8 | 3% | 5.8 | 13% |
| 8 | 1.8 | 7.7 | 79% | 16× | 7.8 | 1% | 6.9 | 10% |

^{[a]}Defined by the number of ligands per dendrimer.
^{[b]}Fold increase in purity is relative to the amount of the component in the distribution (Dendrimer 3).
^{[c]}Difference is calculated by the NMR ratio minus the HPLC ratio, divided by the HPLC ratio.

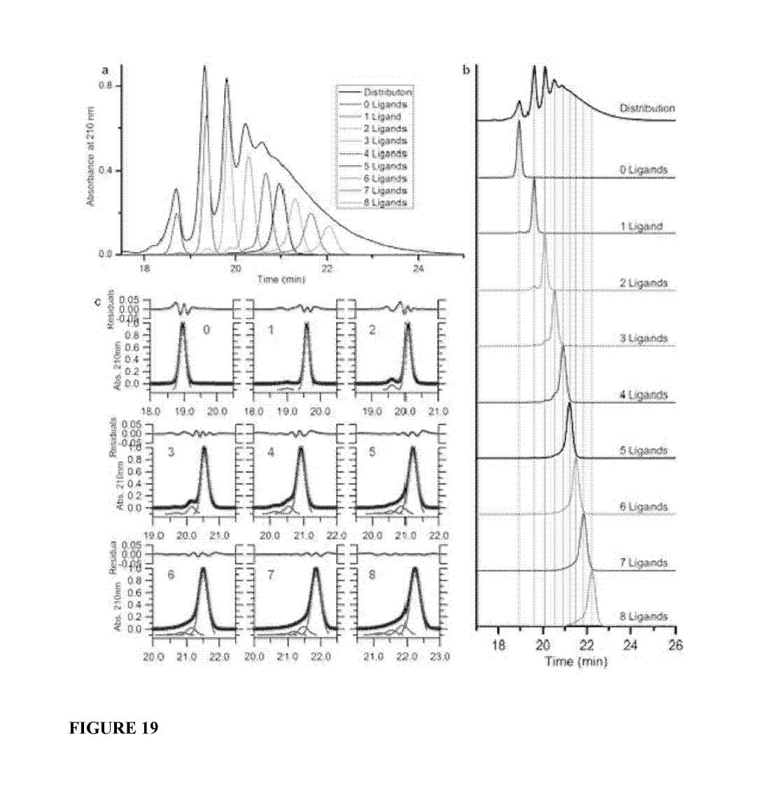

Analytical HPLC was used to characterize the samples both before and after purification. FIG. 19a displays the sample traces before purification. A normalized trace of 3 is included for reference. The peak area for each of the samples directly relates to the amount of material that was isolated because samples were characterized at the isolated concentration. Following purification, the samples were characterized again by analytical HPLC (FIG. 19b) and ¹H NMR.

FIG. 19 shows that each isolated component had the same retention time as its original position in the distribution. FIG. 19 shows that smaller peaks can be seen adjacent to the major peak in each sample. These smaller peaks have retention times consistent with other dendrimer-ligand components. The purity levels of the isolated samples (Table 4) were quantified by peak fitting (FIG. 19c). FIG. 19 also shows that no differences were observed in the HPLC traces before and after purification indicating that the samples did not degrade during the purification process.

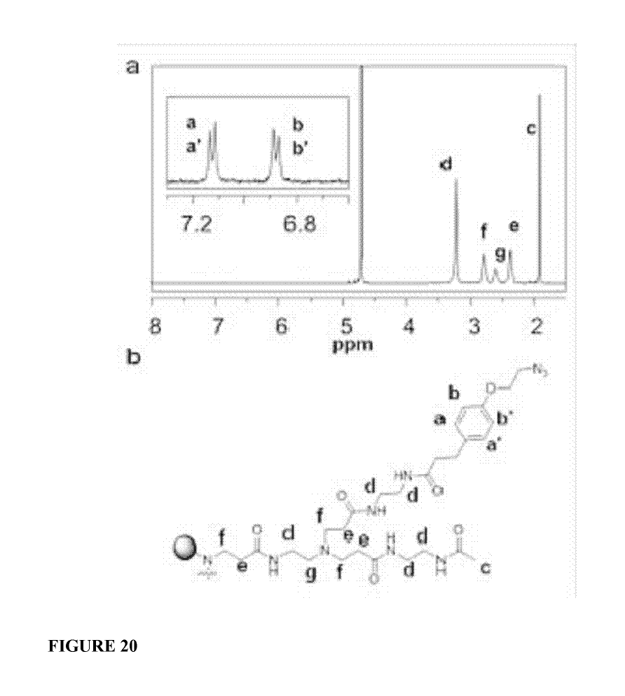

NMR is the second technique used to characterize the isolated samples. FIG. 20 shows the ¹H spectrum for the sample with 1 ligand. Two different methods were used to calculate the ligand/dendrimer ratio for each sample (Table 4).

The first method had two assumptions: 1) All dendrimer end groups were either acetyl groups or ligands. 2) The mean number of end groups per dendrimer after HPLC isolation was 112. Method 1 used the integrals for the aromatic ligand protons (aa′ and bb′), normalized by the number of these protons per ligand (4), divided by the numerator plus the integral for the methyl protons at 1.9 ppm normalized by the number of protons per acetyl group. The product (the ratio of ligands to the total number of end groups per dendrimer) is multiplied by 112 to yield the number of ligands per dendrimer.

There was agreement between the ratios determined by HPLC and by NMR method 1. For samples 5-8, the difference between these values is 3% or less.

A second method was used to calculate the NMR ratios. This method uses the protons from the interior of the dendrimer as a reference. The reference integral was determined using 4 which was also made from 1. In the ¹H NMR spectrum for this material, the integral of the methyl protons c was normalized to 336. This provided the number of interior protons, f, g, and e per dendrimer. These protons were then used as an internal reference to quantify the ligand/dendrimer ratio in the isolated samples.

The second method assumed that all of the amines in 4 were acetylated and that the number of interior protons is not sensitive to the isolation process. The ligand/dendrimer ratios, calculated by the second method, are reported in Table 4. Similar to Method 1, there was generally good agreement between the number of ligands by HPLC and the NMR calculation. For samples 1-4, the difference is between 3% and 17%. Samples 5-8 have differences between 7% and 13%.

The ability to generate dendrimer with precise numbers of ligands is significant for at least two reasons: First, this method produces material with precise numbers of functional ligands. Over 80% of the material in each sample was a single dendrimer-ligand component. This is an order of magnitude improvement in the purity of the desired component (Table 4). Since the ligand in this study had a terminal azide group, the samples could be modified with biologically active molecules using alkyne-azide ‘click’ chemistry. The end result was a system in which ≧80% of the dendrimer particles had a same number of biologically active molecules. Second, the method directly addressed the batch-to-batch reproducibility challenge facing nanoparticle conjugate production. This method achieved batch consistency because the resolution of dendrimer-ligand components by HPLC is highly reproducible. As a result of such consistent product, the process remained insensitive to variations in the dendrimer conjugate that usually results from bath to batch inconsistencies in the dendrimer synthesis and subsequent reaction kinetics.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in molecular biology, drug development, dendrimer technology, nanodevices, nanodevice synthesis, or related fields are intended to be within the scope of the following claims.

1-67. (canceled)

68. A composition comprising ten or more dendrimer molecules having one or more ligands, wherein 80% or more of said dendrimer molecules having one or more ligands are structurally uniform.

69-73. (canceled)

74. The composition of claim 68, wherein said dendrimer molecules are PAMAM dendrimers.

75. (canceled)

76. The composition of claim 68, wherein said one or more ligands is configured for attachment with a conjugate via click chemistry.

77. (canceled)

78. The composition of claim 76, wherein said conjugate is selected from the group consisting of therapeutic agents, targeting agents, trigger agents, and imaging agents.

79-85. (canceled)

86. The composition of claim 68, wherein terminal branches of said ten or more dendrimer molecules comprise a blocking agent.

87. The composition of claim 86, wherein said blocking agent comprises an acetyl group.

88. A method of preparing dendrimer molecules having one or more ligands, comprising
a) conjugating a plurality of dendrimer molecules with one or more ligand molecules so as to yield a population of dendrimer molecules conjugated with one or more ligand molecules; and
b) using reverse phase HPLC to separate said population of dendrimer molecules conjugated with one or more ligand molecules into subpopulations of dendrimer molecules conjugated with one or more ligand molecules, wherein 80% or more of said dendrimer molecules conjugated with one or more ligand molecules within each subpopulation are structurally uniform.

89-93. (canceled)

94. The method of claim 88, further comprising quantitatively determining the number of ligand conjugations per dendrimer molecule.

95. The method of claim 94, wherein said quantitative determination is performed by peak analysis.

96. The method of claim 88, wherein said dendrimer molecules are PAMAM dendrimers.

97. (canceled)

98. The method of claim 88, wherein said one or more ligands is configured for attachment with a conjugate via click chemistry.

99. (canceled)

100. The method of claim 98, wherein said conjugate is selected from the group consisting of therapeutic agents, targeting agents, trigger agents, and imaging agents.

101-107. (canceled)

108. The method of claim 88, wherein terminal branches of said dendrimer molecules comprise a blocking agent.

109. The method of claim 108, wherein said blocking agent comprises an acetyl group.

110-111. (canceled)

112. A product made by the process comprising:
a) conjugating a plurality of dendrimer molecules with one or more ligand molecules so as to yield a population of dendrimer molecules conjugated with one or more ligand molecules; and
b) using reverse phase HPLC to separate said population of dendrimer molecules conjugated with one or more ligand molecules into subpopulations of dendrimer molecules conjugated with one or more ligand molecules, wherein 80% or more of said dendrimer molecules conjugated with one or more ligand molecules within each subpopulation are structurally uniform.

113-117. (canceled)

118. The product of claim 112, wherein said plurality of dendrimer molecules comprise PAMAM dendrimers.

119. (canceled)

120. The product of claim 112, wherein said one or more ligand molecules is configured for attachment with a conjugate via click chemistry.

121. (canceled)

122. The product of claim 120, wherein said conjugate is selected from the group consisting of therapeutic agents, targeting agents, trigger agents, and imaging agents.

123-129. (canceled)

130. The product of claim 112, wherein said plurality of dendrimer molecules have terminal branches, wherein said terminal branches comprise a blocking agent.

131. The product of claim 130, wherein said blocking agent comprises an acetyl group.
